(19) United States
(12) Patent Application Publication
(10) Pub. No.: US 2023/0298017 A1
(43) Pub. Date: Sep. 21, 2023

(54) DISTRIBUTED LEDGER AND BLOCKCHAIN TECHNOLOGY-BASED APPARATUS AND METHODS FOR PROVIDING AN EXCHANGE AND/OR CLEARINGHOUSE FOR REAL ESTATE ASSETS, HIGH VALUE ASSETS, UNIQUE ASSETS, INTELLECTUAL PROPERTY ASSETS, DIGITAL ART AND/OR DIGITAL MEMORABILIA ASSETS, AND/OR NON-FUNGIBLE TOKENS, AND/OR SERVICES

(71) Applicant: RAYMOND ANTHONY JOAO, YONKERS, NY (US)

(72) Inventor: RAYMOND ANTHONY JOAO, YONKERS, NY (US)

(21) Appl. No.: 18/088,654

(22) Filed: Dec. 26, 2022

Related U.S. Application Data
(60) Provisional application No. 63/310,671, filed on Feb. 16, 2022.

(51) Int. Cl. G06Q 20/38; G06Q 30/0601; G06Q 30/0645; G06Q 20/02

(52) U.S. Cl. CPC G06Q 20/389; G06Q 20/023; G06Q 30/0625; G06Q 30/0645; G06Q 50/184

(57) ABSTRACT

An apparatus, including a central computer, including a processor, database, and transmitter, and a distributed ledger and blockchain system. The central computer receives a search request, processes information contained in the search request, generates a search report, and transmits the search report to a user device. The central computer processes information to allow a user or the user device to obtain information regarding the asset from an external computer, allows the user to communicate with a counterparty device via a chat room or video conference, creates a transaction matter record for with the asset, and records activity in the chat room or records the video conference. The apparatus stores information regarding the asset, information regarding a communication between the user and counterparty, or information regarding the information recorded in the chat room or information regarding the video recording, in the database and in the distributed ledger and blockchain system.

### RELATED APPLICATIONS

This application claims the benefit of the priority of U.S. Provisional Pat. Application Serial No. 63/310,671, filed Feb. 16, 2022, and entitled “DISTRIBUTED LEDGER AND BLOCKCHAIN TECHNOLOGY-BASED APPARATUS AND METHODS FOR PROVIDING AN EXCHANGE AND/OR CLEARINGHOUSE FOR REAL ESTATE ASSETS, HIGH VALUE ASSETS, UNIQUE ASSETS, INTELLECTUAL PROPERTY ASSETS, DIGITAL ART AND/OR DIGITAL MEMORABILIA ASSETS, AND/OR NON-FUNGIBLE TOKENS, AND/OR SERVICES”, the subject matter and teachings of which are hereby incorporated by reference herein in their entirety.

### FIELD OF THE INVENTION

The present invention pertains to a distributed ledger and blockchain technology-based apparatus and methods for providing an exchange and/or clearinghouse for real estate assets, high value assets, unique assets, intellectual property assets, digital art and/or digital memorabilia assets, and/or non-fungible tokens, and/or services, and/or and, in particular, the present invention pertains to a distributed ledger and blockchain technology-based apparatus and methods for providing an exchange and/or clearinghouse for real estate assets, high value assets, unique assets, intellectual property assets, digital art and/or digital memorabilia assets, and/or non-fungible tokens, and/or services, which can provide which can provide for enhanced transparency and/or security for, in, or regarding, the selling, the offering for selling, the purchasing, the offering for purchasing, the renting, the offering for renting, the leasing, the offering for licensing, the transferring, and/or the offering for transferring, of any type of kind of real estate assets, high value assets, unique assets, intellectual property assets, digital art and/or digital memorabilia assets, and/or non-fungible tokens, and/or services.

### BACKGROUND OF THE INVENTION

There can be no doubt that transactions and/or commerce regarding and/or involving real estate assets, high value assets, intellectual property assets, digital assets, and/or other unique assets, can be complicated and challenging. Further, business practices of or involving sellers, purchasers or buyers, and/or their respective brokers, agents, and attorneys, in or relating to such transactions and commerce can be inconsistent, subjective, prejudicial, illegal, and/or downright unfair, to counterparties. Oftentimes, these business practices are dictated by a respective individual, or by a broker, agent, or attorney, of the respective individual, and/or by the laws or customs of a geographical area or region, or by a political subdivision.

Oftentimes, these business practices can require that a party to a transaction must place himself or herself at risk or at a disadvantage, and/or could result in a loss of bargaining power, in a transaction from the outset. One such example can be found in certain real estate transactions, wherein a buyer may be required to present a signed or executed contract for the purchase of real property before his or her offer can even be presented to the seller of the real property. Any attorney would know that, without adequate conditions or protections provided for the buyer in the contract or offer, a seller can hold the buyer to that signed contract and offer if and when they choose, while the buyer will have no right to enforce the contract against the seller because the seller has not signed the contract.

So, in the above example, without legal representation, and without appropriate conditions and/or protections in the contract or offer, the buyer in a real property transaction may be required to take an unnecessary risk, and/or have to hire an attorney to review the contract or offer, simply to make an offer on the real property. Sellers also would then be well advised to hire an attorney to review the contract or offer as well. Such a practice, as described above, can prove to be costly and inefficient for buyers and sellers of real estate.

Simply put, these practices, which could be easily avoided by simply allowing a buyer to extend a verbal offer and having the parties agree on price first, and before a contract is signed, can deter or delay certain individuals from engaging in, or entering into, transactions.

Transactions or commerce involving other high value assets, intellectual property assets, digital assets, and/or other unique assets, can also be equally complicated and challenging, depending upon the particular asset(s) involved, the individuals involved, the brokers, agents, or attorneys, involved, or the geographical area or region, or the political subdivision, in which the transaction or commerce may take place or the geographical area or region, or the political subdivision, which governs the transaction or commerce.

In addition to the any of the herein above-noted complications which may be associated with real estate transactions, transactions involving high value assets, unique assets, intellectual property assets, digital art and/or digital memorabilia assets, and/or non-fungible tokens, and/or services, can also be susceptible to fraud. Oftentimes, respective high value assets, unique assets, intellectual property assets, digital art and/or digital memorabilia assets, and/or non-fungible tokens, are not genuine, are be fakes or counterfeits, are fraudulent, or they could have been procured by fraud, or could have been created or fabricated by fraudsters, con artists, and/or by internet robots (so called “bits”). In these situations, unsuspecting buyers can be defrauded. The same can hold true for services procured via online transactions with and between purchasers and service providers.

There can be no doubt that there is a strong need for a technological solution and an improvement to existing technologies which can solve the problems described herein as well as other problems associated with, and experienced by individuals in, conducting transactions and/or commerce involving or relating to real estate assets, high value assets, intellectual property assets, digital assets, and/or other unique assets.

### SUMMARY OF THE INVENTION

The present invention pertains to a distributed ledger and blockchain technology-based apparatus and methods for providing an exchange and/or clearinghouse for real estate assets, high value assets, unique assets, intellectual property assets, digital art and/or digital memorabilia assets, and/or non-fungible tokens, and/or services, and/or and, in particular, the present invention pertains to a distributed ledger and blockchain technology-based apparatus and methods for providing an exchange and/or clearinghouse for real estate assets, high value assets, unique assets, intellectual property assets, digital art and/or digital memorabilia assets, and/or non-fungible tokens, and/or services, which can provide which can provide for enhanced transparency and/or security for, in, or regarding, the selling, the offering for selling, the purchasing, the offering for purchasing, the renting, the offering for renting, the leasing, the offering for licensing, the transferring, and/or the offering for transferring, of any type of kind of real estate assets, high value assets, unique assets, intellectual property assets, digital art and/or digital memorabilia assets, and/or non-fungible tokens, and/or service, which overcomes the shortcomings of the prior art.

The present invention can be utilized in numerous types and/or kinds of transactions, and/or in commerce, regarding and/or involving any types or kinds of real estate assets, real property assets, high value assets, unique assets, intellectual property assets, digital art and/or digital memorabilia assets, and/or non-fungible tokens, and/or services.

The present invention can be utilized by individuals, or by their respective brokers, agents, or attorneys, in order to engage in any transactions or commerce, regarding or involving any real estate assets, real property assets, high value assets, unique assets, intellectual property assets, digital art and/or digital memorabilia assets, and/or non-fungible tokens, and/or services, with any counterparties or with the brokers, agents, or attorneys, of such counterparties.

The present invention can also be utilized by individuals, or by their respective brokers, agents, or attorneys, in order to obtain information regarding, and/or to authenticate, any type or kind of real estate assets, real property assets, high value assets, unique assets, intellectual property assets, digital art and/or digital memorabilia assets, and/or non-fungible tokens, and/or services.

The present invention can be utilized in connection with a distributed ledger and blockchain technology system in order to provide for a secured and immutable record keeping system of and for any of the transactions and/or commerce which can be facilitated by, or which can be performed with, using, or by means of, the apparatus and methods of the present invention.

The present invention can be utilized in numerous types and/or kinds of transactions, and/or in commerce, regarding and/or involving any types or kinds of real estate assets, real property assets, high value assets, unique assets, intellectual property assets, digital art and/or digital memorabilia assets, and/or non-fungible tokens, and/or services.

The present invention can be utilized by individuals, or by their respective brokers, agents, or attorneys, in order to engage in any transactions or commerce, regarding or involving any real estate assets, real property assets, high value assets, unique assets, intellectual property assets, digital art and/or digital memorabilia assets, and/or non-fungible tokens, and/or services, with any counterparties or with the brokers, agents, or attorneys, of such counterparties.

The present invention can also be utilized by individuals, or by their respective brokers, agents, or attorneys, in order to obtain information regarding, and/or to authenticate, any type or kind of real estate assets, real property assets, high value assets, unique assets, intellectual property assets, digital art and/or digital memorabilia assets, and/or non-fungible tokens, and/or services.

The present invention can be utilized in connection with a distributed ledger and blockchain technology system in order to provide for a secured and immutable record keeping system of and for any of the transactions and/or commerce which can be facilitated by, or which can be performed with, using, or by means of, the apparatus and methods of the present invention.

The apparatus of the present invention includes a central processing computer and distributed ledger and Blockchain technology system which can include a central processing computer or central processing computer system and a distributed ledger and Blockchain technology system. The central processing computer can provide control over the apparatus and can perform any of the various processing services and/or functions described herein as being performed by the present invention.

The distributed ledger/Blockchain technology system can be can any suitable or appropriate blockchain and can utilize any suitable or appropriate blockchain technology, blockchain platform, or blockchain system protocol.

The apparatus of the present invention includes a user communication device or computer which is associated with, or which can be used by, any one or more of any of the herein-described users, individuals, persons, or entities, who or which utilize the present invention, and a counterparty communication device or computer which is associated with, or which can be used by, any one or more of any of the herein-described counterparties who or which utilize the present invention.

The apparatus of the present invention can also include a broker/agent communication device which is associated with, or which can be used by, any one or more of any of the herein-described brokers, agents, attorneys, or representatives, of any of the herein-described users, who or which utilize the present invention, and a service provider communication device which is associated with, or which can be used by, any service provider who or which can utilize the present invention in order to provide services to any of the herein-described users, individuals, persons, or entities, who or which utilize the present invention.

The apparatus of the present invention can also include a digital assets/records storage computer which is associated with, or which can be used by, any one or more of any of the herein-described digital assets/records storage providers, who or which can utilize the present invention, and a governmental entity computer which can be used by, and/or which can be associated with, a governmental entity which can, for example, be a national government, federal government, regional government, state government, provincial government, local government, municipal government, or any other government of any political subdivision or geographical subdivision. The governmental entity computer can be utilized by any governmental entity which maintains records and/or information regarding real estate assets and/or any other high value assets, unique assets, intellectual property assets, digital art or digital memorabilia assets, and/or non-fungible tokens, or any services, in, within, or under, its jurisdiction.

The apparatus of the present invention can also include a financial institution computer which can be associated with any financial institution or group of financial institutions, and an official information source computer which can be associated with any one or any number of official information sources.

Any of the central processing computer(s), the user communication device(s), the counterparty communication device(s), the broker/agent communication device(s), the service provider communication device(s), the digital assets/records storage computer(s), the governmental entity computer(s), the financial institution computer(s), and/or the official information source computer(s), can be any computer or communication device, including, but not limited to, a personal computer, a home computer, a server computer, a computer capable of being utilized in a network, a hand-held computer, a palmtop computer, a laptop computer, a personal communication device, a cellular telephone, a wireless telephone, wireless communication device, a mobile telephone, a digital television, an interactive television, a digital television, a personal digital assistant, a telephone, a digital telephone, a television, an interactive television, a beeper, a pager, and/or a watch or a Smart watch, and/or any wearable device, computer or communication device.

Each of the user communication device(s), the counterparty communication device(s), the broker/agent communication device(s), the service provider communication device(s), the digital assets/records storage computer(s), the governmental entity computer(s), the financial institution computer(s), and/or the official information source computer(s), can be connected to, or linked with the central processing computer/distributed ledger/Blockchain technology system, the central processing computer, the distributed ledger and Blockchain technology system, and/or any other user communication device(s), counterparty communication device(s), broker/agent communication device(s), service provider communication device(s), digital assets/records storage computer(s), governmental entity computer(s), financial institution computer(s), and/or official information source computer(s), with or via a wired connection or with or via a wireless connection, and/or with or via any combination of a wired connection and a wireless connection.

Each of the central processing computer(s), the user communication device(s), the counterparty communication device(s), the broker/agent communication device(s), the service provider communication device(s), the digital assets/records storage computer(s), the governmental entity computer(s), the financial institution computer(s), and/or the official information source computer(s), can transmit information to, as well as receive information from, any of the computers or communication devices described herein.

Each of the central processing computer(s), the user communication device(s), the counterparty communication device(s), the broker/agent communication device(s), the service provider communication device(s), the digital assets/records storage computer(s), the governmental entity computer(s), the financial institution computer(s), and/or the official information source computer(s), can communicate with, receive data or information from, transmit data or information to, process information transmitted from or received from, and/or share data and/or information with, each other and/or any other central processing computer(s), user communication device(s), counterparty communication device(s), broker/agent communication device(s), service provider communication device(s), digital assets/records storage computer(s), governmental entity computer(s), financial institution computer(s), and/or official information source computer(s), described herein and/or utilized in conjunction with the apparatus of the present invention. In this manner, data and/or information transfer, between any of the computer(s) or communication device(s) can be facilitated so that each of the central processing computer(s), the user communication device(s), the counterparty communication device(s), the broker/agent communication device(s), the service provider communication device(s), the digital assets/records storage computer(s), the governmental entity computer(s), the financial institution computer(s), and/or the official information source computer(s), can communicate with any other computer(s) or communication device(s) in a bi-directional manner.

The apparatus of the present invention can be utilized on, and/or over, the Internet and/or the World Wide Web. The apparatus of the present invention can also utilize wireless Internet and/or World Wide Web services, equipment and/or devices. The central processing computer(s) can have a web site or web sites associated therewith. Each of the other computers or communication devices described herein can also have a web site or web sites associated with same.

Although the Internet and/or the World Wide Web is a preferred communication system and/or medium utilized, the present invention can also be utilized with any appropriate communication network or system including, but not limited to, a telecommunication network or system, a telephone communication network or system, a cellular communication network or system, a wireless communication network or system, a line or wired communication network or system, a wireless Internet network or system, a wireless World Wide Web network or system, a digital communication network or system, a personal communication network or system, a personal communication services (PCS) network or system, a satellite communication network or system, a broad band communication network or system, a low earth orbiting (LEO) satellite network or system, a public switched telephone network or system, a telephone communication network or system, a radio communication network or system, a cable television network or system, and/or any other communication network or system, and/or any combination of the above communication networks or systems.

Any of the central processing computer(s), the user communication device(s), the counterparty communication device(s), the broker/agent communication device(s), the service provider communication device(s), the digital assets/records storage computer(s), the governmental entity computer(s), the financial institution computer(s), and/or the official information source computer(s), can communicate with one another, and/or can be linked to one another, on, over, or via, any suitable communication network, telecommunication network, telephone network, a line-connected network, and/or a wireless communication network, and/or the Internet and/or the World Wide Web.

Any and/or all of the signals, messages, reports, notification messages, or any other communications, described herein as being transmitted from one device, computer, or communication device, to another, can be, or can be included in, or be attached to, an e-mail message, an instant messaging message, an electronic transmission, or an electronic data transmission or electronic data interchange, or can be transmitted via any other data or information transmission, and/or can be transmitted via or using any appropriate or necessary computer(s) or device(s).

The present invention can utilize electronic commerce technologies and security methods, techniques, and technologies, including any encryption or security technologies and/or techniques, in any and/or all of the instances of, or involving, data and/or information processing, and/or data and/or information transmission, described herein.

Each of the of the central processing computer(s), the user communication device(s), the counterparty communication device(s), the broker/agent communication device(s), the service provider communication device(s), the digital assets/records storage computer(s), the governmental entity computer(s), the financial institution computer(s), and/or the official information source computer(s), can include a central processing unit or CPU, a random access memory device(s) (RAM), a read only memory device(s), a user input device, a display device, a transmitter(s), a receiver, a database, an output device, a video and/or audio recording device(s), and/or a global positioning device.

The present invention can be utilized in a wide variety of preferred embodiments in order to provide a more technologically improved exchange and/or clearinghouse for prospective buyers or purchasers, as well as for prospective sellers, of any types or kinds of real estate assets, real property assets, high value assets, unique assets, intellectual property assets, digital art and/or digital memorabilia assets, and/or any non-fungible tokens of or for the same, and/or any non-fungible tokens associated with and/or related to the same, and/or any non-fungible tokens, and/or services.

The present invention also provides a more technologically improved exchange and/or clearinghouse for prospective buyers or purchasers, as well as for prospective sellers, of any types or kinds of real estate assets, real property assets, high value assets, unique assets, intellectual property assets, digital art and/or digital memorabilia assets, and/or any non-fungible tokens of or for the same, and/or any non-fungible tokens associated with and/or related to the same, and/or any non-fungible tokens, and/or services, which provides for greater transparency, accountability, and/or security, in and regarding transactions involving the same.

It is envisioned that any owner or other authorized individual can list or register an asset, which can be any asset described herein or otherwise which can be capable of being sold, transferred, leased, rented, licensed, or optioned in any way, with the central processing computer. The owner or other authorized individual can also create a non-fungible token (NFT) for and/or representing the asset. In this regard, the asset can also be sold, transferred, leased, rented, licensed, or optioned in any way, as a non-fungible token.

The owner or authorized individual can use a user communication device in order to access the central processing compute, access his, her, or its, account, or create an account and access the same, and list or register his, her, or its, asset, or the non-fungible token (NFT) for the same, for sale, for transfer, for lease or for leasing, for rent of for renting, for license or for licensing, or for selling an option or for optioning in any way.

The owner or other authorized individual can list or register the respective real estate asset(s), real property asset(s), high value asset(s), unique asset(s), intellectual property asset(s), digital art and/or digital memorabilia asset(s), and/or any non-fungible token(s) of or for the same, and/or any non-fungible token(s) associated with and/or related to the same, and/or any non-fungible token(s) (also herein referred to as “asset” or “assets”), and/or service(s), by providing a name or identifying information for the same, a description of the same, a price for the same, a history of or for the same or a history of a transaction(s) involving the same, historical information regarding the same, information regarding the creation or inception of the same, a picture(s), photograph(s), video recording(s), video presentation(s), commercial(s), infomercial(s), a certificate of title of or for the same, a certificate of authenticity of or for the same, and/or any other information regarding the same, contact information for the owner or authorized individual, or a broker, agent, attorney, or representative, of the owner or authorized individual, such as, not limited to, name, address, telephone number, cellular telephone number, email address, text number, and/or video conferencing information, and/or any scheduling and/or availability information for scheduling a call or video conference call with the owner or authorized individual or with his, her, or its, broker, agent, attorney, or representative.

The owner or other authorized individual can also provide information regarding, and/or links to information regarding, any digital assets/records storage computer(s), any governmental entity computer(s), any financial institution computer(s), and/or any official information source computer(s), which may contain and/or store any information related to or regarding the asset being listed or registered which might be of interest to, or which might be needed by, any prospective buyer, purchaser, or user, of the present invention.

Once the respective asset or assets, or service(s), has/have been listed or registered with the central processing computer, such will be available for sale, for transfer, for lease or for leasing, for rent of for renting, for license or for licensing, or for selling an option thereto or therefor or for optioning in any way, with the exchange or clearinghouse provided by the present invention.

The present invention can be utilized in the sale of real estate assets or real property assets and/or any assets relating thereto or derived therefrom. The apparatus present invention can also be utilized in the sale, rental, or leasing, of real estate assets or real property assets, and/or any assets relating thereto for derived therefrom, and/or any non-fungible token (NFT) of, corresponding to, or relating to, the same.

A prospective purchaser, renter, or lessee, can utilize the present invention in order to search for and to locate a real estate asset or a real property asset, that he or she is interested in purchasing, renting, or leasing. A prospective purchaser, renter, or lessee, can also utilize the present invention in order to search for and to locate a non-fungible token of, for, or representing, the real estate asset or a real property asset, that he or she is interested in purchasing, renting, or leasing.

The prospective purchaser, renter, or lessee, can identify or locate, via searching available listings, one or more real estate assets or real property assets, and obtain any information regarding any one or more of the same from any digital assets/records storage computer(s), any governmental entity computer(s), any financial institution computer(s), and/or any official information source computer(s), which may contain and/or store any information related to or regarding the same, and, if interested, can communicate an offer directly to an owner of an asset in which the prospective purchaser, renter, or lessee, is interested. Thereafter, a record regarding any transaction involving or relating to the asset can be stored in both the database of the central processing computer and in the distributed ledger/Blockchain technology system of the central processing computer and distributed ledger and Blockchain technology system.

Any information regarding any transaction involving the real estate asset or the real property asset can be stored in or at a centralized location, in the database of the central processing computer, and in the distributed ledger/Blockchain technology system, so as to secure information regarding the same and any transaction(s) involving the same.

The present invention provides for an improved technical solution in systems and practices involving and/or relating to the offering of real estate assets and/or real property assets for sale which provides for enhanced information transparency and which allows prospective buyers or purchasers to have direct access to sellers of real estate assets and/or real property assets so that information can be obtained and price offers can be conveyed directly and without delay.

The present invention can also be utilized to rent, lease, or purchase an option to purchase, rent, or lease, any real estate asset and/or real property asset. Any real estate asset and/or real property asset, or an option to purchase the same, or any specified rental or rental period of or for the same, or any specified lease or lease period of or for the same, or any option for the same, can also be represented by a non-fungible token (NFT).

An owner or other authorized individual can also list or register a high value asset(s), a unique asset(s), a digital art asset(s), and/or a digital memorabilia asset(s), and/or any non-fungible token(s) of or for the same, and/or any non-fungible token(s) associated with and/or related to the same, and/or any non-fungible token(s) (also herein referred to as “asset” or “assets”), by providing a name or identifying information for the same, a description of the same, a price for the same, a history of or for the same or a history of a transaction(s) involving the same, historical information regarding the same, information regarding the creation or inception of the same, a picture(s), photograph(s), video recording(s), video presentation(s), commercial(s), infomercial(s), a certificate of title of or for the same, a certificate of authenticity of or for the same, and/or any other information regarding the same, contact information for the owner or authorized individual, or a broker, agent, attorney, or representative, of the owner or authorized individual, such as, not limited to, name, address, telephone number, cellular telephone number, email address, text number, and/or video conferencing information, and/or any scheduling and/or availability information for scheduling a call or video conference call with the owner or authorized individual or with his, her, or its, broker, agent, attorney, or representative.

The owner or other authorized individual can also provide information regarding, and/or links to information regarding, any digital assets/records storage computer(s), any governmental entity computer(s), any financial institution computer(s), and/or any official information source computer(s), which may contain and/or store any information related to or regarding the asset being listed or registered which might be of interest to, or which might be needed by, any prospective buyer, purchaser, or user of the present invention.

Once the respective asset or assets, has/have been listed or registered with the central processing computer, such will be available for sale, for transfer, for leasing, for renting, for licensing, or for selling an option thereto or therefor or for optioning in any way, with the exchange or clearinghouse provided by the present invention.

The present invention can also be utilized in the sale of any high value asset(s), unique asset(s), digital art asset(s), and/or digital memorabilia asset(s), and/or any non-fungible token(s) of or for the same, or any assets relating thereto for derived therefrom. The present invention can also be utilized in the sale, rental, leasing, or licensing, or optioning, of any high value asset(s), unique asset(s), digital art asset(s), and/or digital memorabilia asset(s), and/or any non-fungible token(s) of or for the same, and/or any non-fungible token (NFT) of, corresponding to, or relating to, the same.

A prospective purchaser, renter, lessee, licenses, or optionee (defined herein a person who purchases or acquires an option), can utilize the present invention in order to search for and to locate an asset that he or she is interested in purchasing, renting, leasing, licensing, or optioning. A prospective purchaser, renter, lessee, licensee, or optionee, can utilize the present invention in order to search for and to locate a non-fungible token of, for, or representing, the high value asset(s), unique asset(s), digital art asset(s), and/or digital memorabilia asset(s), that he or she is interested in purchasing, renting, leasing, licensing, or optioning. The prospective purchaser, renter, lessee, licensee, or optionee, can identify or locate, via searching available listings, one or more high value asset(s), unique asset(s), digital art asset(s), and/or digital memorabilia asset(s), and obtain any information regarding any one or more of the same from any digital assets/records storage computer(s), any governmental entity computer(s), any financial institution computer(s), and/or any official information source computer(s), which may contain and/or store any information related to or regarding the same, and, if interested, can communicate an offer directly to an owner of an asset in which the prospective purchaser, renter, lessee, licensee, or optionee, is interested. Thereafter, a record regarding any transaction involving or relating to the asset can be stored in both the database of the central processing computer and in the distributed ledger/Blockchain technology system of the central processing computer and distributed ledger and Blockchain technology system.

Any information regarding any transaction involving the high value asset(s), unique asset(s), digital art asset(s), and/or digital memorabilia asset(s), can be stored in or at a centralized location, in the database of the central processing computer, and in the distributed ledger/Blockchain technology system, so as to secure information regarding the same and any transaction(s) involving the same.

The present invention can be utilized in connection with the sale of any high value asset(s), any unique asset(s), any digital art asset(s), and/or any digital memorabilia asset(s), and/or any non-fungible token(s) of or for the same, or any assets relating thereto for derived therefrom. The present invention can also be utilized in connection with the rental, leasing, or licensing, or optioning, of any high value asset(s), unique asset(s), digital art asset(s), and/or digital memorabilia asset(s), and/or any non-fungible token(s) of or for the same, and/or any non-fungible token (NFT) of, corresponding to, or relating to, the same.

The present invention also provides for an improved technical solution in systems and practices involving and/or relating to the offering of high value asset(s), unique asset(s), digital art asset(s), and/or digital memorabilia asset(s), and/or any non-fungible token(s) of or for the same, or any assets relating thereto for derived therefrom. Further, the present invention provides for enhanced information transparency and allows prospective buyers or purchasers to have direct access to sellers of high value asset(s), unique asset(s), digital art asset(s), and/or digital memorabilia asset(s), and/or any non-fungible token(s) of or for the same, or any assets relating thereto for derived therefrom, so that information can be obtained and price offers can be conveyed directly and without delay.

The present invention can also be utilized in order to rent, lease, license, or option, or purchase an option for any high value asset(s), unique asset(s), digital art asset(s), and/or digital memorabilia asset(s), and/or any non-fungible token(s) of or for the same. The high value asset(s), unique asset(s), digital art asset(s), and/or digital memorabilia asset(s), or an option to purchase the same, or any specified rental or rental period of or for the same, or any specified lease or lease period of or for the same, or any specified license for the same, or any option for the same, can also be represented by a non-fungible token (NFT).

The present invention can also be utilized in order sell non-fungible tokens (NFTs) for any high value asset(s), unique asset(s), digital art asset(s), and/or digital memorabilia asset(s), and/or any rental, lease, license, or option, relating thereto.

The present invention can also be utilized in the sale or licensing of intellectual property assets which be, and which can include, but which is not limited to, any types or kinds of patents, trademarks, trade secrets, copyrights, franchises, franchise rights, media rights, publicity rights, and/or any ownership interest(s) thereto or therein, any partial ownership interest(s) thereto or therein, and/or any licenses, exclusive licenses, non-exclusive licenses, defined field of use licenses, exclusive defined field of use licenses, non-exclusive defined field of use license, to or for the same, and/or any options to purchase any of the same, and/or any options to purchase any of the herein-described patents, trademarks, trade secrets, copyrights, franchises, franchise rights, media rights, publicity rights, any licenses for the same, and/or any ownership interest(s) thereto or therein, or any partial ownership interest(s) thereto or therein, and/or any non-fungible token(s) of or for the same, or any assets relating thereto for derived therefrom (hereinafter referred to as an “intellectual property asset” or as “intellectual property assets”).

A prospective purchaser, licensee, or optionee, can utilize the present invention in order to search for and to locate an asset he or she is interested in purchasing, licensing, or optioning. A prospective purchaser, licensee, or optionee, can also utilize the present invention in order to search for and to locate a non-fungible token of, for, or representing, the asset that he or she is interested in purchasing, licensing, or optioning. The prospective purchaser, licensee, or optionee, can identify or locate, via searching available listings, one or more intellectual property assets, and obtain any information regarding any one or more of the same from any digital assets/records storage computer(s), any governmental entity computer(s), any financial institution computer(s), and/or any official information source computer(s), which may contain and/or store any information related to or regarding the same, and, if interested, can communicate an offer directly to an owner of an intellectual property asset in which the prospective purchaser, licensee, or optionee, is interested. Thereafter, a record regarding any transaction involving or relating to the intellectual property asset can be stored in both the database of the central processing computer and in the distributed ledger/Blockchain technology system of the central processing computer and distributed ledger and Blockchain technology system.

In this regard, any information regarding any transaction involving the intellectual property asset can be stored in or at a centralized location, in the database of the central processing computer, and in the distributed ledger/Blockchain technology system, so as to secure information regarding the same and any transaction(s) involving the same.

The present invention can be utilized in connection with the sale of any types or kinds of patents, trademarks, trade secrets, copyrights, franchises, franchise rights, media rights, publicity rights, and/or any ownership interest(s) thereto or therein, any partial ownership interest(s) thereto or therein, and/or any licenses, exclusive licenses, non-exclusive licenses, defined field of use licenses, exclusive defined field of use licenses, non-exclusive defined field of use license, to or for the same, and/or any options to purchase any of the same, and/or any options to purchase any of the herein-described patents, trademarks, trade secrets, copyrights, franchises, franchise rights, media rights, publicity rights, any licenses for the same, and/or any ownership interest(s) thereto or therein, or any partial ownership interest(s) thereto or therein, and/or any non-fungible token(s) of or for the same.

The present invention can also be utilized in connection with the sale of any intellectual property asset or intellectual property assets, and/or any non-fungible token(s) of or for the same, or any assets relating thereto for derived therefrom. The present invention provides for an improved technical solution in systems and practices involving and/or relating to the offering of intellectual property assets and/or any non-fungible token(s) of or for the same, or any assets relating thereto for derived therefrom.

Further, present invention provides for enhanced information transparency and allows prospective buyers or purchasers to have direct access to sellers of intellectual property assets and/or any non-fungible token(s) of or for the same, or any assets relating thereto for derived therefrom, so that information can be obtained and price offers can be conveyed directly and without delay.

The present invention can be utilized in the sale of any non-fungible token (NFT). A non-fungible token (NFT) can be used to represent any of the real estate assets, high value assets, unique assets, intellectual property assets, digital art and/or digital memorabilia assets, and/or non-fungible tokens, and/or services, described herein, and/or a non-fungible token (NFT) can be used to represent any other asset, item, entity, or service. The present invention can also be utilized in the sale, rental, leasing, or licensing, or optioning, of any non-fungible token (NFT).

A prospective purchaser, renter, lessee, licenses, or optionee, can utilize the present invention in order to search for and to locate a non-fungible token (NFT) asset that he or she is interested in purchasing, renting, leasing, licensing, or optioning. The prospective purchaser, renter, lessee, licensee, or optionee, can identify or locate, via searching available listings, one or more non-fungible token (NFT) assets and obtain any information regarding any one or more of the same from any digital assets/records storage computer(s), any governmental entity computer(s), any financial institution computer(s), and/or any official information source computer(s), which may contain and/or store any information related to or regarding the same, and, if interested, can communicate an offer directly to an owner of a non-fungible token (NFT) asset in which the prospective purchaser, renter, lessee, licensee, or optionee, is interested. Thereafter, a record regarding any transaction involving or relating to the non-fungible token (NFT) asset can be stored in both the database of the central processing computer and in the distributed ledger/Blockchain technology system of the central processing computer and distributed ledger and Blockchain technology system.

In this regard, any information regarding any transaction involving the non-fungible token (NFT) asset can be stored in or at a centralized location, in the database of the central processing computer, and in the distributed ledger/Blockchain technology system, so as to secure information regarding the same and any transaction(s) involving the same.

The present invention provides for a number of technological solutions and for a number of improvements to existing technologies and solves numerous problems associated with, and experienced by individuals in, conducting transactions and/or commerce involving or relating to real estate assets, real property assets, high value assets, unique assets, intellectual property assets, digital art and/or digital memorabilia assets, and/or non-fungible tokens, and/or services.

The present invention provides for a number of technological solutions and for a number of improvements to existing technologies utilized in transactions and commerce involving or relating to real estate assets, real property assets, high value assets, unique assets, intellectual property assets, digital art and/or digital memorabilia assets, and/or non-fungible tokens, and/or services, by providing an apparatus and methods for allowing users or individuals to communicate with, and to obtain information from, owners seeking to sell the same, as well as from public records, and to record information regarding the transaction or activity in both a centralized location, in the central processing computer and/or in the database of the same, and in a distributed ledger and blockchain technology system, in the distributed ledger/Blockchain technology system.

The present invention can record and store, in a distributed ledger and blockchain technology system, immutable records of information which can be utilized to protect purchasers of any of the herein-described real estate assets, real property assets, high value assets, unique assets, intellectual property assets, digital art and/or digital memorabilia assets, and/or non-fungible tokens, and/or services, and/or any other assets, from and/or against fraud and/or misrepresentation.

The present invention can also provide purchasers of any of the herein-described real estate assets, real property assets, high value assets, unique assets, intellectual property assets, digital art and/or digital memorabilia assets, and/or non-fungible tokens, and/or services, and/or any other assets, with recourse against individuals who or which perpetrate, or attempt to perpetrate, fraud by selling, or by attempting to sell, assets and/or services which are fraudulent, counterfeit, or non-existent, and/or which are not genuine or not authentic.

The present invention also provides for a number of technological solutions and for a number of improvements to existing technologies and solves numerous problems associated with, and experienced by individuals in, conducting transactions and/or commerce on-line and/or on and/or over the Internet and/or the World Wide Web involving or relating to transactions and/or commerce in or involving any of the herein-described real estate assets, real property assets, high value assets, unique assets, intellectual property assets, digital art and/or digital memorabilia assets, and/or non-fungible tokens, and/or services.

### BRIEF DESCRIPTION OF THE DRAWINGS

In the Drawings:

FIG. 1 illustrates a preferred embodiment of the apparatus of the present invention, in block diagram form;

FIG. 2 illustrates the central processing computer component of the central processing computer and distributed ledger and Blockchain technology system of FIG. 1, in block diagram form;

FIG. 3 illustrates the user communication device of FIG. 1, in block diagram form;

FIG. 4 illustrates the counterparty communication device of FIG. 1, in block diagram form;

FIG. 5 illustrates the broker/agent communication device of FIG. 1, in block diagram form;

FIG. 6 illustrates the service provider communication device of FIG. 1, in block diagram form;

FIG. 7 illustrates the digital assets/records storage computer of FIG. 1, in block diagram form;

FIG. 8 illustrates the governmental entity computer of FIG. 1, in block diagram form;

FIG. 9 illustrates the financial institution computer of FIG. 1, in block diagram form;

FIG. 10 illustrates the official information source computer of FIG. 1, in block diagram form;

FIG. 12 illustrates a preferred embodiment method for utilizing the apparatus of the present invention, in flow diagram form;

FIG. 13 illustrates another preferred embodiment method for utilizing the apparatus of the present invention, in flow diagram form; and

FIG. 14 illustrates still another preferred embodiment method for utilizing the apparatus of the present invention, in flow diagram form.

### DESCRIPTION OF THE PREFERRED EMBODIMENTS

The present invention pertains to a distributed ledger and blockchain technology-based apparatus and methods for providing an exchange and/or clearinghouse for real estate assets, high value assets, unique assets, intellectual property assets, digital art and/or digital memorabilia assets, and/or non-fungible tokens, and/or services, and/or and, in particular, the present invention pertains to a distributed ledger and blockchain technology-based apparatus and methods for providing an exchange and/or clearinghouse for real estate assets, high value assets, unique assets, intellectual property assets, digital art and/or digital memorabilia assets, and/or non-fungible tokens, and/or services, which can provide which can provide for enhanced transparency and/or security for, in, or regarding, the selling, the offering for selling, the purchasing, the offering for purchasing, the renting, the offering for renting, the leasing, the offering for licensing, the transferring, and/or the offering for transferring, of any type of kind of real estate assets, high value assets, unique assets, intellectual property assets, digital art and/or digital memorabilia, and/or non-fungible tokens, and/or service.

Applicant hereby incorporates by reference herein the subject matter and teachings of U.S. Provisional Patent Application Serial No. 63/310,671, filed Feb. 16, 2022, and entitled “DISTRIBUTED LEDGER AND BLOCKCHAIN TECHNOLOGY-BASED APPARATUS AND METHODS FOR PROVIDING AN EXCHANGE AND/OR CLEARINGHOUSE FOR REAL ESTATE ASSETS, HIGH VALUE ASSETS, UNIQUE ASSETS, INTELLECTUAL PROPERTY ASSETS, DIGITAL ART AND/OR DIGITAL MEMORABILIA ASSETS, AND/OR NON-FUNGIBLE TOKENS, AND/OR SERVICES”, the subject matter and teachings of which are hereby incorporated by reference herein in their entirety.

The apparatus and methods of the present invention can be utilized in numerous types and/or kinds of transactions, and/or in commerce, regarding and/or involving any types or kinds of real estate assets, real property assets, high value assets, unique assets, intellectual property assets, digital art and/or digital memorabilia assets, and/or non-fungible tokens, and/or services.

The apparatus and methods of the present invention can be utilized by individuals, or by their respective brokers, agents, or attorneys, in order to engage in any transactions or commerce, regarding or involving any real estate assets, real property assets, high value assets, unique assets, intellectual property assets, digital art and/or digital memorabilia assets, and/or non-fungible tokens, and/or services, with any counterparties or with the brokers, agents, or attorneys, of such counterparties.

The apparatus and methods of the present invention can also be utilized by individuals, or by their respective brokers, agents, or attorneys, in order to obtain information regarding, and/or to authenticate, any type or kind of real estate assets, real property assets, high value assets, unique assets, intellectual property assets, digital art and/or digital memorabilia assets, and/or non-fungible tokens, and/or services.

The apparatus and methods of the present invention can be utilized in connection with a distributed ledger and blockchain technology system in order to provide for a secured and immutable record keeping system of and for any of the transactions and/or commerce which can be facilitated by, or which can be performed with, using, or by means of, the apparatus and methods of the present invention.

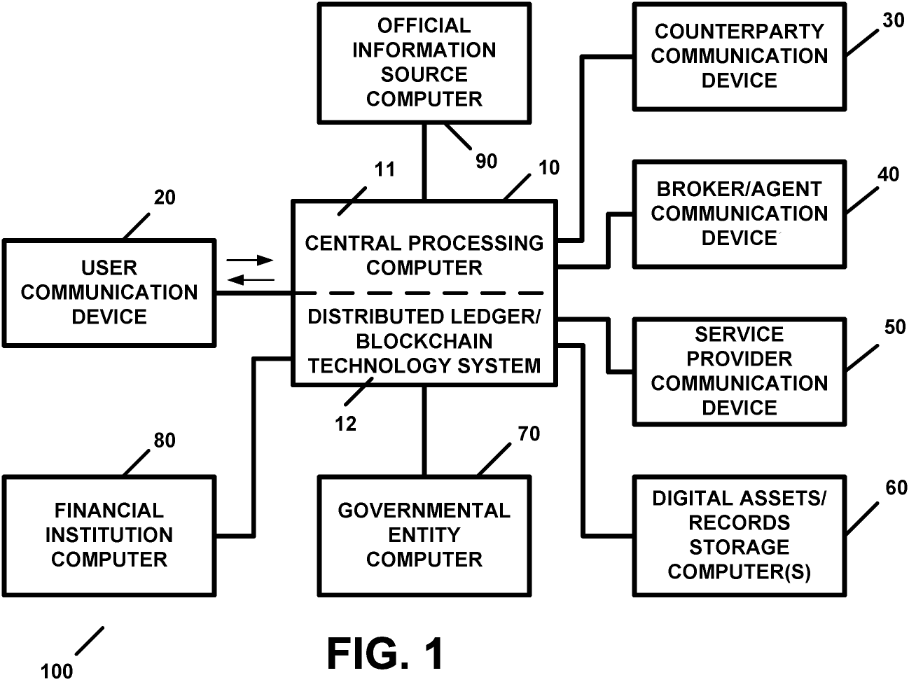

FIG. 1 illustrates the apparatus of the present invention, which is denoted generally by the reference numeral 100, in block diagram form. In the preferred embodiment, the apparatus 100 of the present invention includes a central processing computer and distributed ledger and Blockchain technology system 10 (hereinafter referred to as “central processing computer/distributed ledger/Blockchain technology system 10”). In a preferred embodiment, the central processing computer/distributed ledger/Blockchain technology system 10 includes a central processing computer or central processing computer system 11 (hereinafter referred to as “central processing computer 11” or “central processing computer 11 component”) and a distributed ledger and Blockchain technology system 12 (hereinafter referred to as “distributed ledger/Blockchain technology system 12” or “distributed ledger/Blockchain technology system 12 component”). In the preferred embodiment, the central processing computer 11 can be any computer or computer system or can be any server computer or any computer or computer system which can be used in a communication network. Any number of central processing computers 11 can be utilized in conjunction with, or in connection, with the apparatus 100 of the present invention.

In the preferred embodiment, the central processing computer 11 can provide control over the apparatus 100 and can perform any of the various processing services and/or functions described herein as being performed by the apparatus 100 of the present invention. In a preferred embodiment, the central processing computer 11 may be a single computer or system of computers and/or may include a plurality of computers or computer systems which are utilized in conjunction with one another. The central processing computer 11, in the preferred embodiment, can provide services for any of the other communications devices and/or computers and/or computer systems described herein as being associated with any of the users, individuals, persons, or entities, who or which utilize the apparatus 100 of the present invention.

In a preferred embodiment, the distributed ledger/Blockchain technology system 12 can be can any suitable or appropriate blockchain and can utilize any suitable or appropriate blockchain technology, blockchain platform, or blockchain system protocol. In another preferred embodiment, the distributed ledger/Blockchain technology system 12 can be a permissioned blockchain. In another preferred embodiment, the distributed ledger/Blockchain technology system 12 can be a permissionless blockchain. In another preferred embodiment, the distributed ledger/Blockchain technology system 12 can be a hybrid of a permissioned blockchain and a permissionless blockchain, wherein it can operate as a permissioned blockchain at certain times and as a permissionless blockchain at other times. In another preferred embodiment, the distributed ledger/Blockchain technology system 12 can be a proof of work blockchain. In another preferred embodiment, the distributed ledger/Blockchain technology system 12 can be a hybrid of a proof of stake blockchain and a proof of work blockchain, wherein it can operate as a proof of work blockchain at certain times and as a proof of stake blockchain at other times.

Applicant incorporates by reference herein the subject matter and teachings of “Blockchain Technology Explained” by Alan T. Norman, “Blockchain” by Abraham K. White, “Blockchain - A Practical Guide To Developing Business, Law, And Technology Solutions” by Joseph J. Bambara and Paul R. Allen, and “Blockchain - Ultimate Guide To Understanding Blockchain, Bitcoin, Cryptocurrencies, Smart Contracts And The Future of Money” by Mark Gates, in their entirety, for all of their respective subject matter and teachings regarding distributed ledger technology and/or technologies, Blockchain technology and/or technologies, Bitcoin technology and/or technologies, Bitcoin Blockchain technology and/or technologies, Ethereum technology and/or technologies, Ethereum Blockchain technology and/or technologies, cryptocurrencies, cryptocurrency technology and/or technologies, and/or smart contract technology and/or technologies, and/or decentralized autonomous organizations (DAOs) technologies, and/or peer-to-peer technology and/or technologies, and/or any other technology or technologies related thereto or which can be utilized in conjunction distributed ledgers, Blockchain technologies, Smart contracts, decentralized autonomous organizations (DAOs), and/or cryptocurrencies.

With reference once again to FIG. 1, the apparatus 100 also includes a user communication device or computer 20 (hereinafter referred to as “user communication device 20” or “user computer 20”) which is associated with, or which can be used by, any one or more of any of the herein-described users, individuals, persons, or entities, who or which utilize the apparatus 100 of the present invention.

Any number of user communication devices 20 can be utilized by, or can be associated with, each of the users, individuals, persons, or entities, who or which utilize the apparatus 100 of the present invention. The user communication device 20 can be any communication device, computer, personal computer, laptop computer, notebook computer, Smart phone or smartphone, smart telephone, cellular telephone, personal digital assistant, wireless telephone, wireless communication device, tablet, tablet computer, watch, smart watch, or wearable device or computer, or any combination of same, or any equivalent of same, which can be utilized by any user, individual, person, or entity, who or which utilizes the apparatus 100 and method of the present invention. The user communication device 20 can also be a server computer, a mainframe computer, a mini-computer, a microcomputer, or any other computer or device for suiting the needs of the particular user. The user communication device 20 can also be any device or computer, or a kiosk, that can be located at public places or locations or which can also be publicly available. Any number of user communication devices 20 can be utilized in conjunction with, or in connection with, the apparatus 100 of the present invention.

The user communication device(s) 20 can communicate with, and/or can operate in conjunction with, the central processing computer/distributed ledger/Blockchain technology system 10 and/or any of the other communication devices, computers, and/or computer systems, described herein as being associated with, or used by, any of the users, individuals, persons, or entities, who or which utilize the apparatus 100 and method of the present invention.

With reference once again to FIG. 1, the apparatus 100 also includes a counterparty communication device or computer 30 (hereinafter referred to as “counterparty communication device 30”) which is associated with, or which can be used by, any one or more of any of the herein-described counterparties who or which utilize the apparatus 100 of the present invention. Any counterparty can also utilize a user communication device 20 as well.

Any number of counterparty communication devices 30 can be utilized by, or can be associated with, each of the counterparties who or which utilize the apparatus 100 of the present invention in any transaction or activity. The counterparty communication device 30 can be any communication device, computer, personal computer, laptop computer, notebook computer, Smart phone or smartphone, smart telephone, cellular telephone, personal digital assistant, wireless telephone, wireless communication device, tablet, tablet computer, watch, smart watch, or wearable device or computer, or any combination of same, or any equivalent of same, which can be utilized by any counterparty who or which utilizes the apparatus 100 and method of the present invention. The counterparty communication device 30 can also be a server computer, a mainframe computer, a mini-computer, a microcomputer, or any other computer or device for suiting the needs of the particular user. The counterparty communication device 30 can also be any device or computer, or a kiosk, that can be located at public places or locations or which can also be publicly available. Any number of counterparty communication device 30 can be utilized in conjunction with, or in connection with, the apparatus 100 of the present invention.

The counterparty communication device(s) 30 can communicate with, and/or can operate in conjunction with, the central processing computer/distributed ledger/Blockchain technology system 10 and/or any of the other communication devices, computers, and/or computer systems, described herein as being associated with, or used by, any of the users, individuals, persons, or entities, who or which utilize the apparatus 100 and method of the present invention.

With reference once again to FIG. 1, the apparatus 100 also includes a broker/agent communication device or computer 40 (hereinafter referred to as “broker/agent communication device 40”) which is associated with, or which can be used by, any one or more of any of the herein-described brokers, agents, attorneys, or representatives, of any of the herein-described users, who or which utilize the apparatus 100 of the present invention.

Any number of broker/agent communication devices 40 can be utilized by, or can be associated with, each of the brokers, agents, attorneys, or representatives, of any of the herein-described users, who or which utilize the apparatus 100 of the present invention. The broker/agent communication device 40 can be any communication device, computer, personal computer, laptop computer, notebook computer, Smart phone or smartphone, smart telephone, cellular telephone, personal digital assistant, wireless telephone, wireless communication device, tablet, tablet computer, watch, smart watch, or wearable device or computer, or any combination of same, or any equivalent of same, which can be utilized by any broker, agent, attorney, or representative, who or which utilizes the apparatus 100 and method of the present invention. The broker/agent communication device 40 can also be a server computer, a mainframe computer, a mini-computer, a microcomputer, or any other computer or device for suiting the needs of the particular user. The broker/agent communication device 40 can also be any device or computer, or a kiosk, that can be located at public places or locations or which can also be publicly available. Any number of broker/agent communication device 40 can be utilized in conjunction with, or in connection with, the apparatus 100 of the present invention.

The broker/agent communication device(s) 40 can communicate with, and/or can operate in conjunction with, the central processing computer/distributed ledger/Blockchain technology system 10 and/or any of the other communication devices, computers, and/or computer systems, described herein as being associated with, or used by, any of the users, individuals, persons, or entities, who or which utilize the apparatus 100 and method of the present invention.

With reference once again to FIG. 1, the apparatus 100 also includes a service provider communication device or computer 50 (hereinafter referred to as “service provider communication device 50”) which is associated with, or which can be used by, any one or more of any of the herein-described service providers who or which can utilize the apparatus 100 of the present invention in order to provide services to any of the herein-described users, individuals, persons, or entities, who or which utilize the apparatus 100 and method of the present invention.

Any number of service provider communication devices 50 can be utilized by, or can be associated with, each of the respective service providers who or which utilize the apparatus 100 of the present invention. The service provider communication device 50 can be any communication device, computer, personal computer, laptop computer, notebook computer, Smart phone or smartphone, smart telephone, cellular telephone, personal digital assistant, wireless telephone, wireless communication device, tablet, tablet computer, watch, smart watch, or wearable device or computer, or any combination of same, or any equivalent of same, which can be utilized by any service provider who or which utilizes the apparatus 100 and method of the present invention. The service provider communication device 50 can also be a server computer, a mainframe computer, a mini-computer, a microcomputer, or any other computer or device for suiting the needs of the particular user. The service provider communication device 50 can also be any device or computer, or a kiosk, that can be located at public places or locations or which can also be publicly available. Any number of service provider communication devices 50 can be utilized in conjunction with, or in connection with, the apparatus 100 of the present invention.

The service provider communication device(s) 50 can communicate with, and/or can operate in conjunction with, the central processing computer/distributed ledger/Blockchain technology system 10 and/or any of the other communication devices, computers, and/or computer systems, described herein as being associated with, or used by, any of the users, individuals, persons, or entities, who or which utilize the apparatus 100 and method of the present invention.

With reference once again to FIG. 1, the apparatus 100 also includes a digital assets/records storage computer 60 which is associated with, or which can be used by, any one or more of any of the herein-described digital assets/records storage providers, which can provide services for or regarding the storage and/or the safeguarding of or for digital assets and/or information regarding same, and/or of or for records and/or information regarding the same, who or which can utilize the apparatus 100 of the present invention.

Any number of digital assets/records storage computers 60 can be utilized by, or can be associated with, each of the respective digital assets/records storage providers who or which utilize the apparatus 100 of the present invention. The digital assets/records storage computer 60 can be any communication device, computer, personal computer, laptop computer, notebook computer, Smart phone or smartphone, smart telephone, cellular telephone, personal digital assistant, wireless telephone, wireless communication device, tablet, tablet computer, watch, smart watch, or wearable device or computer, or any combination of same, or any equivalent of same, which can be utilized by any digital assets/records storage provider who or which utilizes the apparatus 100 and method of the present invention. The digital assets/records storage computer 60 can also be a server computer, a mainframe computer, a mini-computer, a microcomputer, or any other computer or device for suiting the needs of the particular user. The digital assets/records storage computer 60 can also be any device or computer, or a kiosk, that can be located at public places or locations or which can also be publicly available. Any number of digital assets/records storage computers 60 can be utilized in conjunction with, or in connection with, the apparatus 100 of the present invention.

The digital assets/records storage computer(s) 60 can communicate with, and/or can operate in conjunction with, the central processing computer/distributed ledger/Blockchain technology system 10 and/or any of the other communication devices, computers, and/or computer systems, described herein as being associated with, or used by, any of the users, individuals, persons, or entities, who or which utilize the apparatus 100 and method of the present invention.

With reference once again to FIG. 1, the apparatus 100 also includes a governmental entity computer 70 which can be used by, and/or which can be associated with, a governmental entity which can, for example, be a national government, federal government, regional government, state government, provincial government, local government, municipal government, or any other government of any political subdivision or geographical subdivision. The governmental entity computer 70 can be utilized by any governmental entity which maintains records and/or information regarding real estate assets and/or any other high value assets, unique assets, intellectual property assets, digital art or digital memorabilia assets, and/or non-fungible tokens, or any services, in, within, or under, its jurisdiction. The governmental entity computer 70 can be utilized by any governmental entity which maintains records, tax records, transaction records, real estate tax records, transfer records, and/or any information relating to, or regarding, real estate assets and/or any other high value assets, unique assets, intellectual property assets, digital art or digital memorabilia assets, and/or non-fungible tokens, or any services, in, within, or under, its jurisdiction.

The governmental entity computer 70 can also be utilized to allow the governmental entity, or an employee or agent of same, to communicate with and/or interact with the central processing computer(s) 11, the user communication devices 20, and/or with any of the other computers and communication devices described herein as being utilized in or with the apparatus 100 of the present invention. The governmental entity computer 70 can communicate with, and/or can be linked to or with, the central processing computer(s) 11 and/or any other computer or communication devices described herein, via a wired communication network, a wireless communication network, or via any combination of wired and/or wireless communication networks.

The governmental entity computer 70 can be used by its respective governmental entity for any purpose. The governmental entity computer 70 can also be utilized by any of the herein-described governmental entities in order to interface with, and/or interact with, the central processing computer 11 or with any other computers and communication devices described herein as being used in or with the apparatus 100 of the present invention. Each governmental entity computer 70 can include any number of computers, server computers, or computer systems. Each governmental entity computer can also have a website or websites associated therewith.

The apparatus 100 can also include a financial institution computer 80. The financial institution computer 80 can be linked with, and utilized in connection with, the apparatus 100 so as to allow and/or facilitate integrating the apparatus 100 of the present invention with a financial institution. In a preferred embodiment, for example, the financial institution computer 80 can be associated with any financial institution or group of financial institutions. The financial institution computer 80 can be associated with any one or any number of financial institutions. The financial institution computer 80 can also provide links to any computers associated with any one or any number of financial institutions. In the preferred embodiment, the financial institution computer 80 can perform any and all of the functions performed by any financial institution. In a preferred embodiment, any number of financial institution computers 80 can be utilized in connection with the apparatus 100 of the present invention. Any number of financial institution computers 80 can be utilized by or in conjunction with any financial institution who or which utilizes the apparatus 100 of the present invention.

The financial institution computer 80 can be a server computer, a personal computer, a mainframe computer, a mini-computer, a microcomputer, or any other computer or device for suiting the needs of the particular financial institution. The financial institution computer 80 can also be any communication device, computer, personal computer, laptop computer, notebook computer, Smart phone or smartphone, smart telephone, cellular telephone, personal digital assistant, wireless telephone, wireless communication device, tablet, tablet computer, watch, smart watch, or wearable device or computer, or any combination of same, or any equivalent of same, which can be utilized by any financial institution who or which utilizes the apparatus 100 and method of the present invention. The financial institution computer 80 can also be any device or computer, or a kiosk, that can be located at public places or locations or which can also be publicly available. Any number of financial institution computers 80 can be utilized in conjunction with, or in connection with, the apparatus 100 of the present invention.

The financial institution computer(s) 80 can communicate with, and/or can operate in conjunction with, the central processing computer/distributed ledger/Blockchain technology system 10, the central processing computer 11, and/or the distributed ledger/Blockchain technology system 12, and/or any of the other communication devices, computers, and/or computer systems, described herein as being associated with, or used by, any of the users, individuals, persons, or entities, who or which utilize the apparatus 100 and method of the present invention.

The apparatus 100 can also include an official information source computer 90. The official information source computer 90 can be linked with, and utilized in connection with, the apparatus 100 so as to allow and/or facilitate integrating the apparatus 100 of the present invention with an official information source which can provide information to any of the users of the apparatus 100 of the present invention and which can also be an official information source which can be utilized by the central processing computer/distributed ledger/Blockchain technology system 10, the central processing computer 11, and/or the distributed ledger/Blockchain technology system 12, in order to process transactions. In a preferred embodiment, the official information source computer 90 can be associated with any official information source or group of official information sources. The official information source computer 90 can be associated with any one or any number of official information sources. The official information source computer 90 can also provide links to any computers associated with any one or any number of official information sources.

In the preferred embodiment, the official information source computer 90 can perform any and all of the functions performed by any official information source. In a preferred embodiment, any number of official information source computers 90 can be utilized in connection with the apparatus 100 of the present invention. Any number of official information source computers 90 can be utilized by or in conjunction with any official information source who or which utilizes the apparatus 100 of the present invention.

The official information source computer 90 can be a server computer, a personal computer, a mainframe computer, a mini-computer, a microcomputer, or any other computer or device for suiting the needs of the particular financial institution. The official information source computer 90 can also be any communication device, computer, personal computer, laptop computer, notebook computer, Smart phone or smartphone, smart telephone, cellular telephone, personal digital assistant, wireless telephone, wireless communication device, tablet, tablet computer, watch, smart watch, or wearable device or computer, or any combination of same, or any equivalent of same, which can be utilized by any official information source who or which utilizes the apparatus 100 and method of the present invention. The official information source computer 90 can also be any device or computer, or a kiosk, that can be located at public places or locations or which can also be publicly available. Any number of official information source computers 90 can be utilized in conjunction with, or in connection with, the apparatus 100 of the present invention.

The official information source computer(s) 90 can communicate with, and/or can operate in conjunction with, the central processing computer/distributed ledger/Blockchain technology system 10 and/or any of the other communication devices, computers, and/or computer systems, described herein as being associated with, or used by, any of the users, individuals, persons, or entities, who or which utilize the apparatus 100 and method of the present invention.

In the preferred embodiment, any of the central processing computer(s) 11, the user communication device(s) 20, the counterparty communication device(s) 30, the broker/agent communication device(s) 40, the service provider communication device(s) 50, the digital assets/records storage computer(s) 60, the governmental entity computer(s) 70, the financial institution computer(s) 80, and/or the official information source computer(s) 90, can be any computer or communication device, including, but not limited to, a personal computer, a home computer, a server computer, a computer capable of being utilized in a network, a hand-held computer, a palmtop computer, a laptop computer, a personal communication device, a cellular telephone, a wireless telephone, wireless communication device, a mobile telephone, a digital television, an interactive television, a digital television, a personal digital assistant, a telephone, a digital telephone, a television, an interactive television, a beeper, a pager, and/or a watch or a Smart watch, and/or any wearable device, computer or communication device.

In the preferred embodiment, each of the user communication device(s) 20, the counterparty communication device(s) 30, the broker/agent communication device(s) 40, the service provider communication device(s) 50, the digital assets/records storage computer(s) 60, the governmental entity computer(s) 70, the financial institution computer(s) 80, and/or the official information source computer(s) 90, can be connected to, or linked with the central processing computer/distributed ledger/Blockchain technology system 10, the central processing computer 11, the distributed ledger/Blockchain technology system 12, and/or any other user communication device(s) 20, counterparty communication device(s) 30, broker/agent communication device(s) 40, service provider communication device(s) 50, digital assets/records storage computer(s) 60, governmental entity computer(s) 70, financial institution computer(s) 80, and/or official information source computer(s) 90, with or via a wired connection or with or via a wireless connection, and/or with or via any combination of a wired connection and a wireless connection.

In a preferred embodiment, each of the central processing computer(s) 11, the user communication device(s) 20, the counterparty communication device(s) 30, the broker/agent communication device(s) 40, the service provider communication device(s) 50, the digital assets/records storage computer(s) 60, the governmental entity computer(s) 70, the financial institution computer(s) 80, and/or the official information source computer(s) 90, can transmit information to, as well as receive information from, any of the computers or communication devices 11, 20, 30, 40, 50, 60, 70, 80, and/or 90 described herein. In this regard, each of the central processing computer(s) 11, the user communication device(s) 20, the counterparty communication device(s) 30, the broker/agent communication device(s) 40, the service provider communication device(s) 50, the digital assets/records storage computer(s) 60, the governmental entity computer(s) 70, the financial institution computer(s) 80, and/or the official information source computer(s) 90, can communicate with, receive data or information from, transmit data or information to, process information transmitted from or received from, and/or share data and/or information with, each other and/or any other central processing computer(s) 11, user communication device(s) 20, counterparty communication device(s) 30, broker/agent communication device(s) 40, service provider communication device(s) 50, digital assets/records storage computer(s) 60, governmental entity computer(s) 70, financial institution computer(s) 80, and/or official information source computer(s) 90, described herein and/or utilized in conjunction with the apparatus 100 of the present invention. In this manner, data and/or information transfer, between any of the computer(s) or communication device(s) 11, 20, 30, 40, 50, 60, 70, 80, and/or 90, can be facilitated so that each of the central processing computer(s) 11, the user communication device(s) 20, the counterparty communication device(s) 30, the broker/agent communication device(s) 40, the service provider communication device(s) 50, the digital assets/records storage computer(s) 60, the governmental entity computer(s) 70, the financial institution computer(s) 80, and/or the official information source computer(s) 90, can communicate with any other computer(s) or communication device(s) 11, 20, 30, 40, 50, 60, 70, and/or 80, in a bi-directional manner. In this manner, any of the computer(s) or communication device(s) 11, 20, 30, 40, 50, 60, 70, and/or 80, can communicate with any other computer(s) or communication device(s) 11, 20, 30, 40, 50, 60, 70, and/or 80, in a bi-directional manner.

In the preferred embodiment, the apparatus 100 of the present invention can be utilized on, and/or over, the Internet and/or the World Wide Web. The apparatus 100 of the present invention, in the preferred embodiment, can also utilize wireless Internet and/or World Wide Web services, equipment and/or devices. The central processing computer(s) 11, in the preferred embodiment, has a web site or web sites associated therewith. Each of the other computers or communication devices described herein can also have a web site or web sites associated with same.

Although the Internet and/or the World Wide Web is a preferred communication system and/or medium utilized, the present invention, in any and/or all of the embodiments described herein, can also be utilized with any appropriate communication network or system including, but not limited to, a telecommunication network or system, a telephone communication network or system, a cellular communication network or system, a wireless communication network or system, a line or wired communication network or system, a wireless Internet network or system, a wireless World Wide Web network or system, a digital communication network or system, a personal communication network or system, a personal communication services (PCS) network or system, a satellite communication network or system, a broad band communication network or system, a low earth orbiting (LEO) satellite network or system, a public switched telephone network or system, a telephone communication network or system, a radio communication network or system, a cable television network or system, and/or any other communication network or system, and/or any combination of the above communication networks or systems.

Any of the central processing computer(s) 11, the user communication device(s) 20, the counterparty communication device(s) 30, the broker/agent communication device(s) 40, the service provider communication device(s) 50, the digital assets/records storage computer(s) 60, the governmental entity computer(s) 70, the financial institution computer(s) 80, and/or the official information source computer(s) 90, can communicate with one another, and/or can be linked to one another, on, over, or via, any suitable communication network, telecommunication network, telephone network, a line-connected network, and/or a wireless communication network, and/or the Internet and/or the World Wide Web. Each of the computers or communication devices 11, 20, 30, 40, 50, 60, 70, 80, and/or 90, can be linked with any other computer or computers directly or indirectly with one another so as to facilitate a direct or indirect bi-directional communication between said respective computers or communication devices. Communications between each of the computers or communication devices 11, 20, 30, 40, 50, 60, 70, 80, and/or 90, can also involve an e-mail server or e-mail servers in those instances when e-mails are described as being used to transmit, or to send, any of the information, signals, messages, reports, notification messages, or any other communications, described herein, by or between any of the computers or communication devices 11, 20, 30, 40, 50, 60, 70, 80, and/or 90, or when any of the information, signals, messages, reports, notification messages, or any other computers or communications, described herein, are transmitted by and/or between any of the parties described herein and/or by or between any of the computers or communication devices 11, 20, 30, 40, 50, 60, 70, 80, and/or 90, or any other computers or communication devices, computer systems, communication network equipment, server computers, etc., or any other devices used or needed, in order to facilitate communications or the transmission of any of the herein-described information, signals, messages, reports, notification messages, or any other communications.

In a preferred embodiment, each of the central processing computer(s) 11, the user communication device(s) 20, the counterparty communication device(s) 30, the broker/agent communication device(s) 40, the service provider communication device(s) 50, the digital assets/records storage computer(s) 60, the governmental entity computer(s) 70, the financial institution computer(s) 80, and/or the official information source computer(s) 90, can communicate in a bi-directional manner with, and/or can send and/or receive signals, messages, reports, notification messages, alerts, or any other communications or electronic communication transmissions, to, from, and/or between, any other, or any number of, other central processing computer(s) 11, user communication device(s) 20, counterparty communication device(s) 30, broker/agent communication device(s) 40, service provider communication device(s) 50, digital assets/records storage computer(s) 60, governmental entity computer(s) 70, financial institution computer(s) 80, and/or official information source computer(s) 90.

In a preferred embodiment, each of the central processing computer(s) 11, the user communication device(s) 20, the counterparty communication device(s) 30, the broker/agent communication device(s) 40, the service provider communication device(s) 50, the digital assets/records storage computer(s) 60, the governmental entity computer(s) 70, the financial institution computer(s) 80, and/or the official information source computer(s) 90, can be linked to or with any other central processing computer(s) 11, user communication device(s) 20, counterparty communication device(s) 30, broker/agent communication device(s) 40, service provider communication device(s) 50, digital assets/records storage computer(s) 60, governmental entity computer(s) 70, financial institution computer(s) 80, and/or official information source computer(s) 90, via a wired link or line or a wireless link.

In a preferred embodiment, each of the user communication device(s) 20, the counterparty communication device(s) 30, the broker/agent communication device(s) 40, the service provider communication device(s) 50, the digital assets/records storage computer(s) 60, the governmental entity computer(s) 70, the financial institution computer(s) 80, and/or the official information source computer(s) 90, can be connected with, or linked with, the central processing computer(s) 11 as shown in FIG. 1. In a preferred embodiment, each of the user communication device(s) 20, the counterparty communication device(s) 30, the broker/agent communication device(s) 40, the service provider communication device(s) 50, the digital assets/records storage computer(s) 60, the governmental entity computer(s) 70, the financial institution computer(s) 80, and/or the official information source computer(s) 90, can be connected with, or linked with, the central processing computer(s) 11 via a wired line or wired link, via a wireless line, and/or via any combination of same.

In a preferred embodiment, any and/or all of the signals, messages, reports, notification messages, or any other communications, described herein as being transmitted from one device, computer, or communication device, to another, can be, or can be included in, or be attached to, an e-mail message, an instant messaging message, an electronic transmission, or an electronic data transmission or electronic data interchange, or can be transmitted via any other data or information transmission, and/or can be transmitted via or using any appropriate or necessary computer(s) or device(s).

In the preferred embodiment, each of the central processing computer(s) 11, the user communication device(s) 20, the counterparty communication device(s) 30, the broker/agent communication device(s) 40, the service provider communication device(s) 50, the digital assets/records storage computer(s) 60, the governmental entity computer(s) 70, the financial institution computer(s) 80, and/or the official information source computer(s) 90, can transmit data and/or information using TCP/IP, as well as any other Internet and/or World Wide Web, and/or communication, protocols.

The apparatus 100 of the present invention can utilize electronic commerce technologies and security methods, techniques, and technologies, including any encryption or security technologies and/or techniques, in any and/or all of the instances of, or involving, data and/or information processing, and/or data and/or information transmission, described herein.

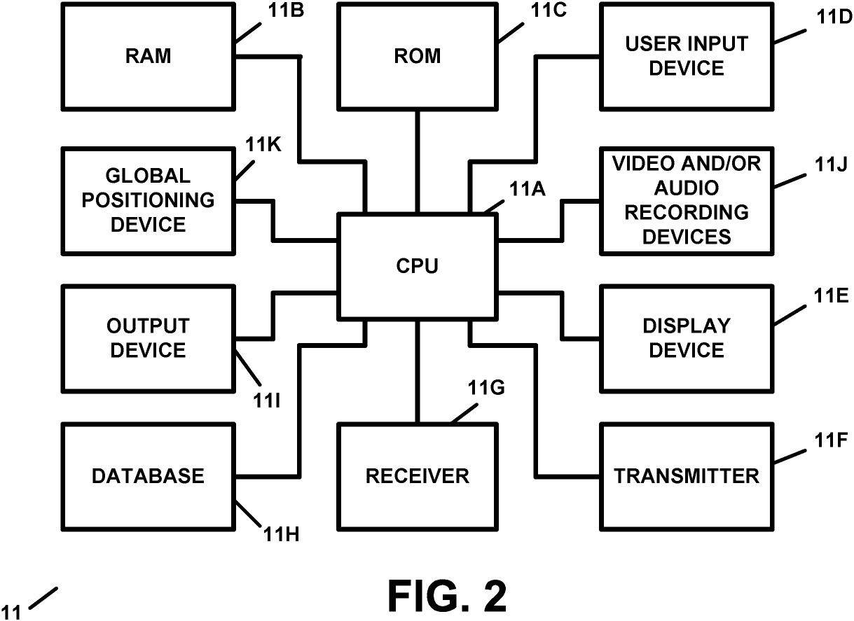

FIG. 2 illustrates the central processing computer 11, of the central processing computer/distributed ledger/Blockchain technology system 10 of the apparatus 100, in block diagram form. The central processing computer 11, in the preferred embodiment, can be a computer or computer system, a server computer, a network computer, or any other communication device, which can provide the functionality of, and which can be utilized as a central processing computer 11, such as an Internet server computer and/or a web site server computer. In the preferred embodiment, the central processing computer 11 includes a central processing unit or CPU 11A, which, in the preferred embodiment, is a microprocessor. The CPU 11A can also be a microcomputer, a minicomputer, a macro-computer, and/or a mainframe computer, depending upon the application.

The central processing computer 11 also includes a random access memory device(s) 11B (RAM) and a read only memory device(s) 11C (ROM), each of which is connected to, or linked with, the CPU 11A, and a user input device 11D, for entering data and/or information and/or commands into the central processing computer 11, which can include any one or more of a keyboard, a scanner, a user pointing device, such as, for example, a mouse, a touch pad, and/or an audio input device and/or a video input device, a microphone or audio recording device, a camera or a video recording device, and/or any device, electronic and/or otherwise, which can be utilized for inputting and/or entering data and/or information and/or commands into the central processing computer 11. The user input device(s) 11D is/are also connected to, or linked with, the CPU 11A. The central processing computer 11 also includes a display device 11E for displaying data and/or information to a user or operator. The display device 11E is also connected to, or linked with, the CPU 11A.

The central processing computer 11 also includes a transmitter(s) 11F, for transmitting signals and/or data and/or information to any one or more of the user communication device(s) 20, the counterparty communication device(s) 30, the broker/agent communication device(s) 40, the service provider communication device(s) 50, the digital assets/records storage computer(s) 60, the governmental entity computer(s) 70, the financial institution computer(s) 80, and/or the official information source computer(s) 90, and/or to any other central processing computer(s) 11 and/or to any other individual computer(s) or individual communication device(s) which may be utilized in conjunction with the apparatus 100 of the present invention. The transmitter 11F is also connected to, or linked with, the CPU 11A.

The central processing computer 11 also includes a receiver 11G, for receiving signals and/or data and/or information from any one or more of the user communication device(s) 20, the counterparty communication device(s) 30, the broker/agent communication device(s) 40, the service provider communication device(s) 50, the digital assets/records storage computer(s) 60, the governmental entity computer(s) 70, the financial institution computer(s) 80, and/or the official information source computer(s) 90, and/or from any other central processing computer(s) 11 and/or from any other individual computer(s) or individual communication device(s) which may be utilized in conjunction with the apparatus 100 of the present invention. The receiver 11G is also connected to, or linked with, the CPU 11A.

The central processing computer 11 also includes a database(s) 11H which contains and/or includes any data, information, and/or software programs or software applications (“apps”), any and/or all of the data and/or information required, needed, or desired, for allowing and/or for enabling the central processing computer 11 and/or the apparatus 100 to perform any and/or all of the functions and functionalities described herein as being performed, and/or as capable of being performed, by the central processing computer 11 and/or the apparatus 100 of the present invention, and/or for providing or performing and/or all of the functions and functionalities of an exchange or clearinghouse for any and/or all types or kinds of real estate assets, real property assets, high value assets, unique assets, intellectual property assets, digital art and/or digital memorabilia assets, and/or non-fungible tokens, and/or services, and/or any sales, rentals, leases, licenses, and/or sales of ownership shares, of or in the same.

In this regard, and notwithstanding any specific examples of data and/or information described herein as being stored in the database 11H, it is to be understood that the database 11H contains or includes any and/or all data and/or information required, needed, or desired, for allowing and/or enabling the central processing computer 11 and/or the apparatus 100 to perform any and/or all of the functions and functionalities described herein as being performed by the central processing computer 11 and/or the apparatus 100 of the present invention.

The database 11H can also contain and/or include data and/or information regarding any the herein-described users, individuals, counterparties, brokers, agents, attorneys, representatives, and/or service providers who or which utilize the apparatus 100 and methods of the present invention.

In a preferred embodiment, the database 11H can contain and/or can include any data and/or information regarding any assets, which include, but are not limited to, any real estate assets, real property assets, high value assets, unique assets, intellectual property assets, digital art and/or digital memorabilia assets, and/or non-fungible tokens, and/or services, which can be listed or registered for sale, for purchase, for sale of full ownership rights therein, for sale of partial ownership rights therein, for lease, for rental, for licensing, for sale of ownership shares, for purchase of ownership shares, and/or for hire, with or via the central processing computer 11 and/or the apparatus 100. In this regard, the assets which can be listed or registered with the apparatus 100 can include any and/or all types of real estate assets and/or real property assets, any rentals of or for the sale, any leases of or for the same, and/or any options of any purchase, rentals, or leases, of or for the same, and/or any other asset which can related thereto or which can be derived therefrom. The assets which can be listed or registered with the apparatus 100 can also include any high value assets or unique assets, such as, but not limited vehicles, boats, aircraft, jewelry, artwork, watches, or any other article or entity which has a high value or is a unique asset, as well as any rentals of or for the sale, any leases of or for the same, and/or any options of any purchase, rentals, or leases, of or for the same, and/or any other asset which can related thereto or which can be derived therefrom. In a preferred embodiment, real estate assets or real property assets include residential premises, residential buildings, home, houses, multi-family dwellings and any land associated therewith, commercial premises, commercial buildings, and/or commercial structures, and any land associated therewith, and/or vacant land or undeveloped land.

In a preferred embodiment, the database 11H can also contain and/or can include any data and/or information regarding any assets which also include any intellectual property assets which can be listed or registered with the apparatus 100, including, but not limited to, patents, trademarks, trade secrets, copyrights, franchises, franchise rights, media rights, publicity rights, and/or any ownership interest(s) thereto or therein, any partial ownership interest(s) thereto or therein, and/or any licenses, exclusive licenses, non-exclusive licenses, defined field of use licenses, exclusive defined field of use licenses, non-exclusive defined field of use license, to or for the same, and/or any options to purchase any of the same, and/or any options to purchase any of the herein-described patents, trademarks, trade secrets, copyrights, franchises, franchise rights, media rights, publicity rights, and/or any ownership interest(s) thereto or therein, or any partial ownership interest(s) thereto or therein.

In a preferred embodiment, the database 11H can also contain and/or can include any data and/or information regarding any assets which also include any digital art assets and/or digital memorabilia assets which can be listed or registered with the apparatus 100, which can be or can include any asset or entity which can be treated as, or considered to be, by any person or entity, a digital art asset or digital memorabilia asset, a digital sports memorabilia asset, a digital entertainment memorabilia asset, or any other digital assert, as well as any ownership interest(s) thereto or therein, any partial ownership interest(s) thereto or therein, and/or any licenses, exclusive licenses, non-exclusive licenses, defined field of use licenses, exclusive defined field of use licenses, non-exclusive defined field of use license, to or for the same, and/or any options to purchase any of the same, and/or any options to purchase any of the herein-described digital art and/or digital memorabilia and/or any ownership interest(s) thereto or therein, or any partial ownership interest(s) thereto or therein.

In a preferred embodiment, the database 11H can also contain and/or can include any data and/or information regarding any assets which also include any non-fungible tokens (NFTs) which can be listed or registered with the apparatus 100, which can be or can include any asset or entity which can be treated as, or considered to be, by any person or entity, to be unique or a non-fungible, or which can be considered to be the subject of a non-fungible token, as well as any ownership interest(s) thereto or therein, any partial ownership interest(s) thereto or therein, and/or any licenses, exclusive licenses, non-exclusive licenses, defined field of use licenses, exclusive defined field of use licenses, non-exclusive defined field of use license, to or for the same, and/or any options to purchase any of the same, and/or any options to purchase any of the herein-described digital art and/or digital memorabilia and/or any ownership interest(s) thereto or therein, or any partial ownership interest(s) thereto or therein.

In a preferred embodiment, the database 11H can also contain and/or include, for each asset or for any asset, information regarding the asset’s authenticity, certificate of authenticity, certificate of title, and/or any other information for verifying the authenticity of the asset or the seller’s ability to sell, license, or option, the same.

In a preferred embodiment, the database 11H can also contain and/or can include any data and/or information regarding any assets which also include services which can be listed or registered with the apparatus 100, which services can be or can include any type or kind of services, and/or any right to obtain the same, right to use the same, license to obtain the same, license to use the same, exclusive license to obtain the same, exclusive license to use the same, or any other type or kind of license to obtain or use the same, or any option to obtain or use the same.

In a preferred embodiment, for each of the above-described, or other, assets listed with the apparatus 100 or the central processing computer 11, the database 11H can also include, data and/or information regarding the asset, including, but not limited to, the name or identity of the asset, a description of the asset, the date the asset was listed of registered with the apparatus 100 or the central processing computer 11, information regarding the owner or seller of the asset, information regarding a broker, agent, attorney, or representative, of or for the owner or seller of the same, information regarding the listing person, information regarding the ownership history of or for the asset, and/or information regarding the asset or any assets listed for or derived from the asset. The database 11H can also, for each asset, contain or include data and/or information regarding any licenses or options relating to the asset, past transactions regarding the asset, and/or any other information which can be provided via an exchange or clearinghouse of or for the asset. The database 11H can also contain and/or include video and/or video and audio presentations, infomercials, commercials, or other information for, regarding, or for providing detailed information, for or regarding the asset.

In a preferred embodiment, the database 11H can also contain and/or include, for each user, individual, counterparty, broker, agent, attorney, representative, service provider, or listing person, any data and/or information including, but not limited to, the name, sex, age, birth date, address, telephone number, cellular telephone number, text messaging number, videoconferencing or video chat identification (ID) name or number, email address, website address or uniform resource locator (url), and/or any other contact information, agent or representative contact information, of the user, individual, counterparty, broker, agent, attorney, representative, service provider, or listing person.

In a preferred embodiment, the database 11H can also contain or include, for each user, individual, counterparty, broker, agent, attorney, representative, service provider, or listing person, any information regarding any transactions he or she may have been a party to, and/or data and/or information regarding any real estate assets, high value assets, unique assets, intellectual property assets, digital art and/or digital memorabilia assets, and/or non-fungible tokens, owned or held by the user, individual, counterparty, broker, agent, attorney, representative, service provider, or listing person, and/or any services used by the user, individual, counterparty, broker, agent, attorney, representative, service provider, or listing person,.

In a preferred embodiment, the database 11H can also contain and/or include information regarding any digital asset account(s), digital memorabilia account(s), a digital souvenir account(s), or any other digital account(s), of, for, or associated with, the user, individual, counterparty, broker, agent, attorney, representative, service provider, or listing person. In a preferred embodiment, the database 11H can also contain and/or include video recordings, video calls, video conference recordings, video chat recordings, audio recordings, telephone call recordings, video and audio recordings, photographs, pictures, and/or any records, regarding any transactions or activities, involving, regarding, or relating to any assets owned or held by the user, individual, counterparty, broker, agent, attorney, representative, service provider, or listing person.

In a preferred embodiment, the database 11H can also contain and/or include video recordings, video calls, video conference recordings, video chat recordings, audio recordings, telephone call recordings, video and audio recordings, photographs, pictures, and/or any records regarding any transactions or activities, involving, regarding, or relating to any interests of or regarding, the user, individual, counterparty, broker, agent, attorney, representative, service provider, or listing person.

In a preferred embodiment, the database 11H can also include work schedule(s) and/or work calendar(s), work scheduling information, and/or work schedule information, for or regarding the user, individual, counterparty, broker, agent, attorney, representative, service provider, or listing person, and/or any information needed for scheduling an appointment with the user, individual, counterparty, broker, agent, attorney, representative, service provider, or listing person.

In a preferred embodiment, the database 11H can also contain and/or include any data and/or information described herein as being stored in any of the databases 20H, 30H, 40H, 50H, 60H, 70H, 80H, and/or 90H, of the respective communication devices or computers 20, 30, 40, 50, 60, 70, 80, and/or 90, described herein, as well as any data and/or information which can be stored in the database(s) 11H of any other central processing computer(s) 11.

The database 11H can also include advertisements, advertisement materials and information, marketing materials or information, commercials, video clips, infomercials, and any other information, which can include text information, video information, audio information, or any combination of same, which can be used to provide an advertisement, or advertisement material or information, to or for any asset listed or registered with the apparatus 100 and/or the central processing computer 11.

The database 11H can also contain and/or include news information, news reports, published reports, theses, study reports, programs, television programs, video information, and/or audio information, or any other data or information regarding any information regarding any assets listed or registered with the apparatus 100 and/or the central processing computer 11.

The database 11H can also include language translation information or software so that any of the data or information described herein as being stored in the database 11H, and/or in any of the databases 20H, 30H, 40H, 50H, 60H, 70H, 80H, and/or 90H, or as being provided in any of the messages, reports, or other communications, described herein, can be translated into any language or any languages.

The database 11H can also contain any notes, comments, or messages, which can be provided in text, in audio recordings or audio clips, and/or in video recordings or video clips. The database 11H can also contain any data, information, and/or software programs for translating audio information into text information and for translating text information into audio information. The database 11H can also contain any data, information, and/or software programs for translating text information or audio information from one language to another so as to provide a multi-lingual communications platform and system. The database 11H can also contain any notes, comments, or messages, which can be provided by or for any user, individual, or entity, who or which utilizes the apparatus 100 of the present invention.

In a preferred embodiment, any text or audio information described herein can be translated into or from text to audio or from audio into text, and any text or audio information can be translated from one language to any other language or languages.

The database 11H can also contain any other data and/or information, including software, software programs, and/or software applications (“apps”) which are needed, required, or desired, for performing any and all of the operations, routines, processing routines, and other functions and/or functionality, described herein as being capable of being performed by the apparatus 100, and/or by the central processing computer(s) 11 and/or by any of the herein-described central processing computer(s) 11, user communication device(s) 20, counterparty communication device(s) 30, broker/agent communication device(s) 40, service provider communication device(s) 50, digital assets/records storage computer(s) 60, governmental entity computer(s) 70, financial institution computer(s) 80, and/or official information source computer(s) 90. In this regard, the database 11H can contain and/or include any software programs, software algorithms, and/or software applications (“apps”) deemed to be necessary, desirable, and/or useful, in utilizing the apparatus 100 and method of the present invention in the various embodiments described herein. In a preferred embodiment, the database 11H can also contain and/or include any other data and/or information deemed to be necessary, desirable, and/or useful, in utilizing the apparatus 100 and method of the present invention in the various embodiments described herein. The database 11H can also contain and/or include any other data and/or information which is or may be needed and/or desired in performing any and/or all of the features and/or functionality described herein as being provided by the apparatus 100 of the present invention and/or the central processing computer 11, and/or any of the herein-described user communication devices 20, counterparty communication devices 30, broker/agent communication devices 40, service provider communication devices 50, digital assets/records storage computers 60, governmental entity computers 70, financial institution computers 80, and/or official information source computers 90.

The database 11H can also contain and/or include any data and/or information which is described herein as be input into, received by, processed by, generated by, and/or transmitted to or from, the central procession computer(s) 11, and/or any of the herein-described user communication devices 20, counterparty communication devices 30, broker/agent communication devices 40, service provider communication devices 50, digital assets/records storage computers 60, governmental entity computers 70, financial institution computers 80, and/or official information source computers 90.

The database 11H can also contain and/or include any data, information, alerts, messages, notes, reports, or any other communications described herein as being stored in any of the databases 11H, 20H, 30H, 40H, 50H, 60H, 70H, 80H, and/or 90H.

The central processing computer 11 also includes an output device 11I for outputting any of the data, information, or reports, described herein or otherwise. In the preferred embodiment, the output device 11I can be a printer, a display, a transmitter, a modem, a speaker, and/or any other device which can be used to output data.

The central processing computer 11 can also include a video and/or audio recording device(s) 11J which can include a camera and/or a video recording device, for recording pictures or video and/or video clips, and/or a microphone or an audio recording device, for recording audio or audio clips, which can be recorded by, and/or transmitted live, by or from the central processing computer 11, or which can be recorded by, and stored at or in, the central processing computer 11 for transmission by or from the central processing computer 11 at a later time. The video and/or audio recording device(s) 11J can also be utilized to facilitate one-way broadcasts from the central processing computer 11, and/or can be utilized to facilitate video conferencing, video chatting, and/or audio conferencing, and/or video and audio conferencing, between users of the central processing computer 11 and any of the herein-described users, individuals, persons, or entities, who or which utilize the apparatus 100 of the present invention.

The central processing computer 11 can also include a global positioning device 11K. In a preferred embodiment, the global positioning device 11K determines or can determine a position or location of the central processing computer 11.

In a preferred embodiment, the central processing computer 11 can also be equipped, and/or can be programmed, for voice activation operation and/or voice control operation of and/or regarding any and/or all of the herein-described operations and functions which are capable of being performed by the central processing computer 11.

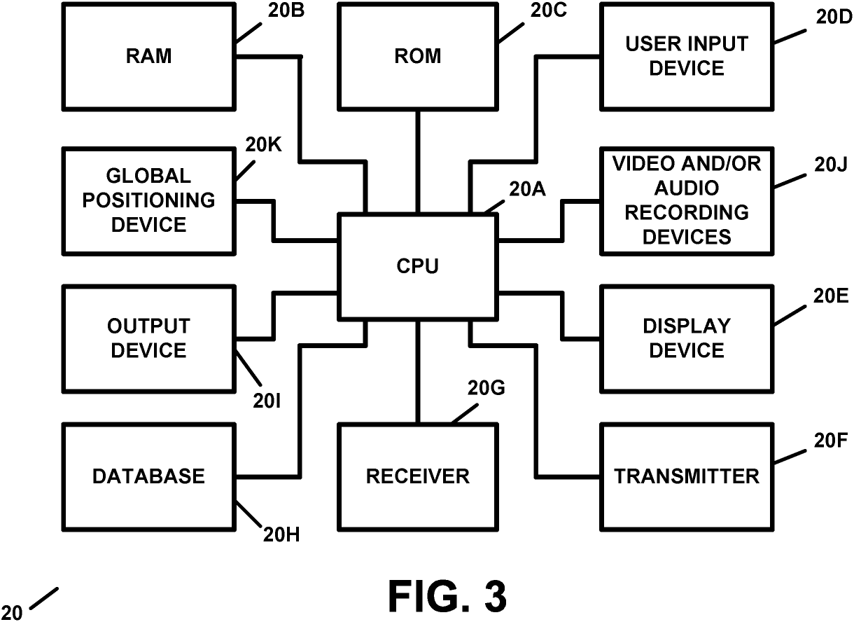

FIG. 3 illustrates the user communication device 20 of the apparatus 100, in block diagram form. The user communication device 20, in the preferred embodiment, can be any communication device, computer, personal computer, laptop computer, notebook computer, Smart phone or smartphone, smart telephone, cellular telephone, personal digital assistant, wireless telephone, wireless communication device, tablet, tablet computer, watch, smart watch, or wearable device or computer, or any combination of same, or any equivalent of same, or any other computer or communication device, which can provide the functionality of, and which can be utilized as a user communication device 20. In the preferred embodiment, the user communication device 20 includes a central processing unit or CPU 20A, which, in the preferred embodiment, is a microprocessor. The CPU 20A can also be a microcomputer, a minicomputer, a macro-computer, and/or a mainframe computer, depending upon the application.

The user communication device 20 also includes a random access memory device(s) 20B (RAM) and a read only memory device(s) 20C (ROM), each of which is connected to, or linked with, the CPU 20A, and a user input device 20D, for entering data and/or information and/or commands into the user communication device 20, which can include any one or more of a keyboard, a scanner, a user pointing device, such as, for example, a mouse, a touch pad, and/or an audio input device and/or a video input device, a microphone or audio recording device, a camera or a video recording device, and/or any device, electronic and/or otherwise, which can be utilized for inputting and/or entering data and/or information and/or commands into the user communication device 20. The user input device(s) 20D is/are also connected to, or linked with, the CPU 20A. The user communication device 20 also includes a display device 20E for displaying data and/or information to a user or individual. The display device 20E is also connected to, or linked with, the CPU 20A.

The user communication device 20 also includes a transmitter(s) 20F, for transmitting signals and/or data and/or information to any one or more of the central processing computer(s) 11, the counterparty communication device(s) 30, the broker/agent communication device(s) 40, the service provider communication device(s) 50, the digital assets/records storage computer(s) 60, the governmental entity computer(s) 70, the financial institution computer(s) 80, and/or the official information source computer(s) 90, and/or to any other user communication device(s) 20, and/or to any other individual computer(s) or individual communication device(s) which may be utilized in conjunction with the apparatus 100 of the present invention. The transmitter 20F is also connected to, or linked with, the CPU 20A.

The user communication device 20 also includes a receiver 20G, for receiving signals and/or data and/or information from any one or more of the central processing computer(s) 11, the counterparty communication device(s) 30, the broker/agent communication device(s) 40, the service provider communication device(s) 50, the digital assets/records storage computer(s) 60, the governmental entity computer(s) 70, the financial institution computer(s) 80, and/or the official information source computer(s) 90, and/or from any other user communication device(s) 20, and/or from any other individual computer(s) or individual communication device(s) which may be utilized in conjunction with the apparatus 100 of the present invention. The receiver 20G is also connected to, or linked with, the CPU 20A.

The user communication device 20 also includes a database(s) 20H which contains any and/or all of the data and/or information required, needed, or desired, for allowing and/or enabling the user communication device 20 and/or the apparatus 100 to perform any and/or all of the functions and functionalities described herein as being performed, and/or as capable of being performed, by the user communication device 20 and/or the apparatus 100. In this regard, and notwithstanding any specific examples of data and/or information described herein as being stored in the database 20H, it is to be understood that the database 20H contains and/or includes any and/or all data and/or information required, needed, or desired, for allowing and/or enabling the user communication device 20 and/or the apparatus 100 to perform any and/or all of the functions and functionalities described herein as being performed by the user communication device 20 and/or the apparatus 100 of the present invention.

In a preferred embodiment, the database 20H can contain and/or include any data and/or information regarding the user or individual, including, but not limited to, the name, sex, age, birth date, address, telephone number, cellular telephone number, text messaging number, videoconferencing or video chat identification (ID) name or number, email address, website address or uniform resource locator (url), and/or any other contact information, agent or representative contact information, of the user or individual.

In a preferred embodiment, the database 20H can also contain or include any information regarding any transactions the user or individual may have been a party to, and/or data and/or information regarding any real estate assets, high value assets, unique assets, intellectual property assets, digital art and/or digital memorabilia assets, and/or non-fungible tokens, owned or held by the user or individual, and/or any services used by the user or individual.

In a preferred embodiment, the database 20H can also contain and/or include information regarding any digital asset account(s), digital memorabilia account(s), a digital souvenir account(s), or any other digital account(s), of, for, or associated with, the user or individual. In a preferred embodiment, the database 20H can also contain and/or include video recordings, video calls, video conference recordings, video chat recordings, audio recordings, telephone call recordings, video and audio recordings, photographs, pictures, and/or any records, regarding any transactions or activities, involving, regarding, or relating to any assets owned or held by the user or individual.

In a preferred embodiment, the database 20H can also contain and/or include video recordings, video calls, video conference recordings, video chat recordings, audio recordings, telephone call recordings, video and audio recordings, photographs, pictures, and/or any records regarding any transactions or activities, involving, regarding, or relating to any interests of or regarding, the user or individual.

In a preferred embodiment, the database 20H can also include work schedule(s) and/or work calendar(s), work scheduling information, and/or work schedule information, for or regarding the user or individual, and/or any information needed for scheduling an appointment with the user or individual.

The database 20H can also contain and/or include, and/or can be linked to or with, any of the data and/or information described herein as being stored in any of the respective databases 11H, 20H, 30H, 40H, 50H, 60H, 70H, 80H, and/or 90H, of any of the herein-described computers or communication devices. The database 20H can also contain or include any software, software programs, and/or software applications (“app”), which is, or may be, needed and/or desired in performing any and/or all of the features and/or functionality described herein as being provided by the apparatus 100 of the present invention and/or the user communication device 20. The database 20H can also contain and/or include any other data and/or information which is, or may be, needed and/or desired in performing any and/or all of the features and/or functionality described herein as being provided by the apparatus 100 of the present invention and/or the user communication device 20. The database 20H can also be connected to the CPU 20A.

The user communication device 20 also includes an output device 20I for outputting any of the data, information, or reports, described herein or otherwise. In the preferred embodiment, the output device 20I can be a printer, a display, a transmitter, a modem, a speaker, and/or any other device which can be used to output data.

The user communication device 20 can also include a video and/or audio recording device(s) 20J which can include a camera and/or a video recording device, for recording pictures or video and/or video clips, and/or a microphone or an audio recording device, for recording audio or audio clips, which can be recorded by, and/or transmitted live, by or from the user communication device 20, or which can be recorded by, and stored at or in, the user communication device 20 for transmission by or from the user communication device 20 at a later time. The video and/or audio recording device(s) 20J can also be utilized to facilitate one-way broadcasts from the user communication device 20, and/or can be utilized to facilitate video conferencing, video chatting, and/or audio conferencing, and/or video and audio conferencing, between a user of the user communication device 20 and any of the herein-described users, individuals, persons, or entities, who or which utilize the apparatus 100 of the present invention.

The user communication device 20 can also include a global positioning device 20K. In a preferred embodiment, the global positioning device 20K determines or can determine a position or location of the user communication device 20.

In a preferred embodiment, the user communication device 20 can also be equipped, and/or can be programmed, for voice activation operation and/or voice control operation of and/or regarding any and/or all of the herein-described operations and functions which are described herein as capable of being performed by the user communication device 20.

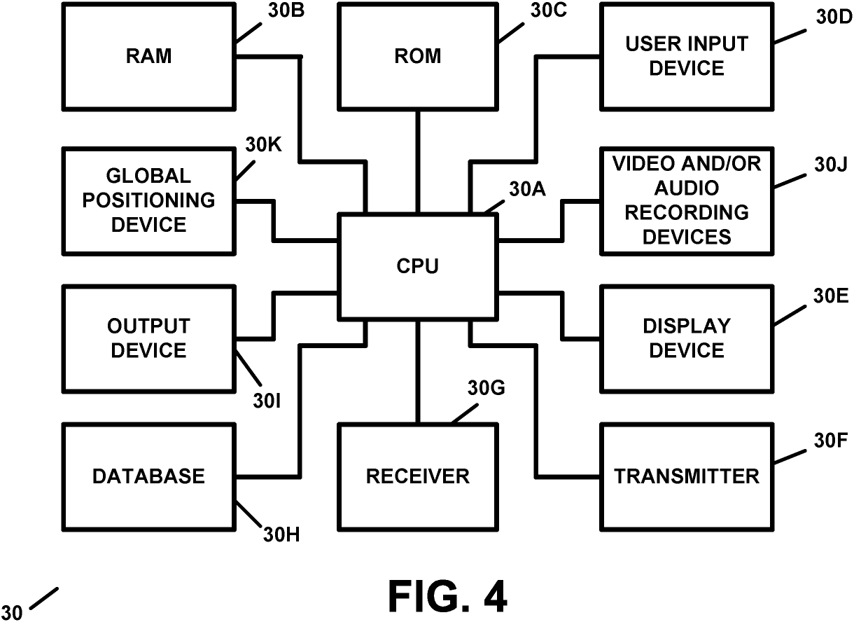

FIG. 4 illustrates the counterparty communication device 30 of the apparatus 100, in block diagram form. The counterparty communication device 30, in the preferred embodiment, can be any communication device, computer, personal computer, laptop computer, notebook computer, Smart phone or smartphone, smart telephone, cellular telephone, personal digital assistant, wireless telephone, wireless communication device, tablet, tablet computer, watch, smart watch, or wearable device or computer, or any combination of same, or any equivalent of same, or any other computer or communication device, which can provide the functionality of, and which can be utilized as an counterparty communication device 30. In the preferred embodiment, the counterparty communication device 30 includes a central processing unit or CPU 30A, which, in the preferred embodiment, is a microprocessor. The CPU 30A can also be a microcomputer, a minicomputer, a macro-computer, and/or a mainframe computer, depending upon the application.

The counterparty communication device 30 also includes a random access memory device(s) 30B (RAM) and a read only memory device(s) 30C (ROM), each of which is connected to, or linked with, the CPU 30A, and a user input device 30D, for entering data and/or information and/or commands into the counterparty communication device 30, which can include any one or more of a keyboard, a scanner, a user pointing device, such as, for example, a mouse, a touch pad, and/or an audio input device and/or a video input device, a microphone or audio recording device, a camera or a video recording device, and/or any device, electronic and/or otherwise, which can be utilized for inputting and/or entering data and/or information and/or commands into the counterparty communication device 30. The user input device(s) 30D is/are also connected to, or linked with, the CPU 30A. The counterparty communication device 30 also includes a display device 30E for displaying data and/or information to a user or individual. The display device 30E is also connected to, or linked with, the CPU 30A.

The counterparty communication device 30 also includes a transmitter(s) 30F, for transmitting signals and/or data and/or information to any one or more of the central processing computer(s) 11, the user communication device(s) 20, the broker/agent communication device(s) 40, the service provider communication device(s) 50, the digital assets/records storage computer(s) 60, the governmental entity computer(s) 70, the financial institution computer(s) 80, and/or the official information source computer(s) 90, and/or to any other counterparty communication device(s) 30, and/or to any other individual computer(s) or individual communication device(s) which may be utilized in conjunction with the apparatus 100 of the present invention. The transmitter 30F is also connected to, or linked with, the CPU 30A.

The counterparty communication device 30 also includes a receiver 30G, for receiving signals and/or data and/or information from any one or more of the central processing computer(s) 11, the user communication device(s) 20, the broker/agent communication device(s) 40, the service provider communication device(s) 50, the digital assets/records storage computer(s) 60, the governmental entity computer(s) 70, the financial institution computer(s) 80, and/or the official information source computer(s) 90, and/or from any other counterparty communication device(s) 30, and/or any other individual computer(s) or individual communication device(s) which may be utilized in conjunction with the apparatus 100 of the present invention. The receiver 30G is also connected to, or linked with, the CPU 30A.

The counterparty communication device 30 also includes a database(s) 30H which contains and/or includes any and/or all of the data and/or information required, needed, or desired, for allowing and/or enabling the counterparty communication device 30 and/or the apparatus 100 to perform any and/or all of the functions and functionalities described herein as being performed, and/or as capable of being performed, by the counterparty communication device 30 and/or the apparatus 100 of the present invention. In this regard, and notwithstanding any specific examples of data and/or information described herein as being stored in the database 30H, it is to be understood that the database 30H contains and/or includes any and/or all data and/or information required, needed, or desired, for allowing and/or enabling the counterparty communication device 30 and/or the apparatus 100 to perform any and/or all of the functions and functionalities described herein as being performed by the counterparty communication device 30 and/or the apparatus 100 of the present invention.

In a preferred embodiment, the database 30H can contain and/or include any data and/or information regarding the counterparty user or individual, including, but not limited to, the name, sex, age, birth date, address, telephone number, cellular telephone number, text messaging number, videoconferencing or video chat identification (ID) name or number, email address, website address or uniform resource locator (url), and/or any other contact information, agent or representative contact information, of the counterparty user or individual.

In a preferred embodiment, the database 30H can also contain or include any information regarding any transactions the counterparty user or individual may have been a party to, and/or data and/or information regarding any real estate assets, high value assets, unique assets, intellectual property assets, digital art and/or digital memorabilia assets, and/or non-fungible tokens, owned or held by the counterparty user or individual, and/or any services used by the counterparty user or individual.

In a preferred embodiment, the database 30H can also contain and/or include information regarding any digital asset account(s), digital memorabilia account(s), a digital souvenir account(s), or any other digital account(s), of, for, or associated with, the counterparty user or individual. In a preferred embodiment, the database 20H can also contain and/or include video recordings, video calls, video conference recordings, video chat recordings, audio recordings, telephone call recordings, video and audio recordings, photographs, pictures, and/or any records, regarding any transactions or activities, involving, regarding, or relating to any assets owned or held by the counterparty user or individual.

In a preferred embodiment, the database 30H can also contain and/or include video recordings, video calls, video conference recordings, video chat recordings, audio recordings, telephone call recordings, video and audio recordings, photographs, pictures, and/or any records regarding any transactions or activities, involving, regarding, or relating to any interests of or regarding, the counterparty.

The database 30H can also contain and/or include, and/or can be linked to or with, any of the data and/or information described herein as being stored in any of the respective databases 11H, 20H, 30H, 40H, 50H, 60H, 70H, 80H, and/or 90H, of any of the herein-described computers or communication devices. The database 30H can also contain or include any software, software programs, and/or software applications (“app”), which is, or may be, needed and/or desired in performing any and/or all of the features and/or functionality described herein as being provided by the apparatus 100 of the present invention and/or the counterparty communication device 30. The database 30H can also contain and/or include any other data and/or information which is, or may be, needed and/or desired in performing any and/or all of the features and/or functionality described herein as being provided by the apparatus 100 of the present invention and/or the counterparty communication device 30.

In a preferred embodiment, the database 30H can also include work schedule(s) and/or work calendar(s), work scheduling information, and/or work schedule information, for or regarding the counterparty, and/or any information needed for scheduling an appointment with the user or counterparty.

The database 30H can also contain and/or include, and/or can be linked to or with, any of the data and/or information described herein as being stored in any of the respective databases 11H, 20H, 30H, 40H, 50H, 60H, 70H, 80H, and/or 90H, of any of the herein-described computers or communication devices. The database 30H can also contain or include any software, software programs, and/or software applications (“app”), which is, or may be, needed and/or desired in performing any and/or all of the features and/or functionality described herein as being provided by the apparatus 100 of the present invention and/or the counterparty communication device 30. The database 30H can also contain and/or include any other data and/or information which is, or may be, needed and/or desired in performing any and/or all of the features and/or functionality described herein as being provided by the apparatus 100 of the present invention and/or the counterparty communication device 30. The database 30H can also be connected to the CPU 30A.

The counterparty communication device 30 also includes an output device 30I for outputting any of the data, information, or reports, described herein or otherwise. In the preferred embodiment, the output device 30I can be a printer, a display, a transmitter, a modem, a speaker, and/or any other device which can be used to output data.

The counterparty communication device 30 can also include a video and/or audio recording device(s) 30J which can include a camera and/or a video recording device, for recording pictures or video and/or video clips, and/or a microphone or an audio recording device, for recording audio or audio clips, which can be recorded by, and/or transmitted live, by or from the counterparty communication device 30, or which can be recorded by, and stored at or in, the counterparty communication device 30 for transmission by or from the counterparty communication device 30 at a later time. The video and/or audio recording device(s) 30J can also be utilized to facilitate one-way broadcasts from the counterparty communication device 30, and/or can be utilized to facilitate video conferencing, video chatting, and/or audio conferencing, and/or video and audio conferencing, between a user of the counterparty communication device 30 and any of the herein-described users, individuals, persons, or entities, who or which utilize the apparatus 100 of the present invention.

The counterparty communication device 30 can also include a global positioning device 30K. In a preferred embodiment, the global positioning device 30K determines or can determine a position or location of the counterparty communication device 30.

In a preferred embodiment, the counterparty communication device 30 can also be equipped, and/or can be programmed, for voice activation operation and/or voice control operation of and/or regarding any and/or all of the herein-described operations and functions which are capable of being performed by the counterparty communication device 30.

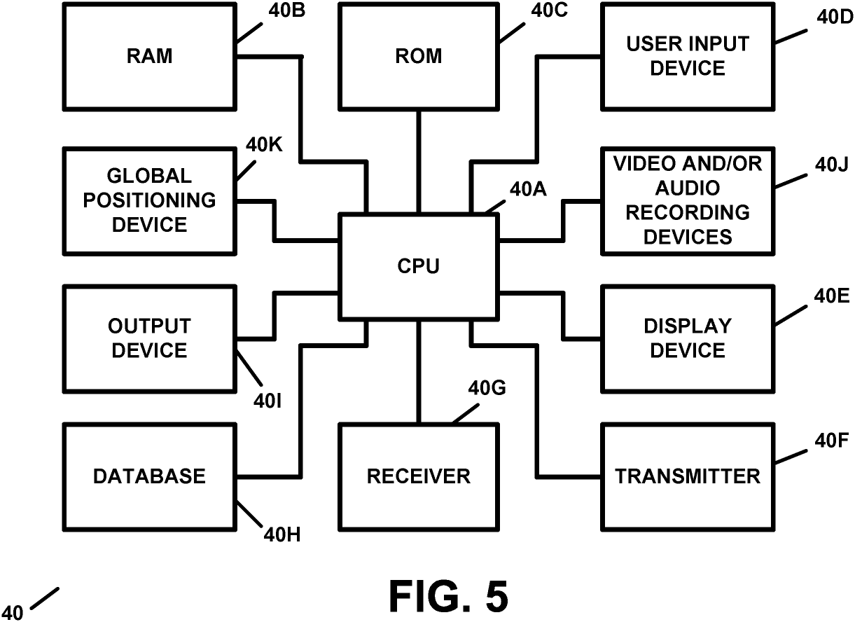

FIG. 5 illustrates the broker/agent communication device 40 of the apparatus 100, in block diagram form. The broker/agent communication device 40, in the preferred embodiment, can be any communication device, computer, personal computer, laptop computer, notebook computer, Smart phone or smartphone, smart telephone, cellular telephone, personal digital assistant, wireless telephone, wireless communication device, tablet, tablet computer, watch, smart watch, or wearable device or computer, or any combination of same, or any equivalent of same, or any other computer or communication device, which can provide the functionality of, and which can be utilized as a broker/agent communication device 40. In the preferred embodiment, the broker/agent communication device 40 includes a central processing unit or CPU 40A, which, in the preferred embodiment, is a microprocessor. The CPU 40A can also be a microcomputer, a minicomputer, a macro-computer, and/or a mainframe computer, depending upon the application.

The broker/agent communication device 40 also includes a random access memory device(s) 40B (RAM) and a read only memory device(s) 40C (ROM), each of which is connected to, or linked with, the CPU 40A, and a user input device 40D, for entering data and/or information and/or commands into the broker/agent communication device 40, which can include any one or more of a keyboard, a scanner, a user pointing device, such as, for example, a mouse, a touch pad, and/or an audio input device and/or a video input device, a microphone or audio recording device, a camera or a video recording device, and/or any device, electronic and/or otherwise, which can be utilized for inputting and/or entering data and/or information and/or commands into the broker/agent communication device 40. The user input device(s) 40D is/are also connected to, or linked with, the CPU 40A. The broker/agent communication device 40 also includes a display device 40E for displaying data and/or information to a user or individual. The display device 40E is also connected to, or linked with, the CPU 40A.

The broker/agent communication device 40 also includes a transmitter(s) 40F, for transmitting signals and/or data and/or information to any one or more of the central processing computer(s) 11, the user communication device(s) 20, the counterparty communication device(s) 30, the service provider communication device(s) 50, the digital assets/records storage computer(s) 60, the governmental entity computer(s) 70, the financial institution computer(s) 80, and/or the official information source computer(s) 90, and/or to any other broker/agent communication device(s) 40, and/or any other individual computer(s) or individual communication device(s) which may be utilized in conjunction with the apparatus 100 of the present invention. The transmitter 40F is also connected to, or linked with, the CPU 40A.

The broker/agent communication device 40 also includes a receiver 40G, for receiving signals and/or data and/or information from any one or more of the central processing computer(s) 11, the user communication device(s) 20, the counterparty communication device(s) 30, the service provider communication device(s) 50, the digital assets/records storage computer(s) 60, the governmental entity computer(s) 70, the financial institution computer(s) 80, and/or the official information source computer(s) 90, and/or to any other broker/agent communication device(s) 40, and/or any other individual computer(s) or individual communication device(s) which may be utilized in conjunction with the apparatus 100 of the present invention. The receiver 40G is also connected to, or linked with, the CPU 40A.

The broker/agent communication device 40 also includes a database(s) 40H which contains any and/or all of the data and/or information required, needed, or desired, for allowing and/or enabling the broker/agent communication device 40 and/or the apparatus 100 to perform any and/or all of the functions and functionalities described herein as being performed, and/or as capable of being performed, by the broker/agent communication device 40 and/or the apparatus 100 of the present invention. In this regard, and notwithstanding any specific examples of data and/or information described herein as being stored in the database 40H, it is to be understood that the database 40H contains and/or includes any and/or all data and/or information required, needed, or desired, for allowing and/or enabling the broker/agent communication device 40 and/or the apparatus 100 to perform any and/or all of the functions and functionalities described herein as being performed by the broker/agent communication device 40 and/or the apparatus 100 of the present invention.

In a preferred embodiment, the database 40H can contain and/or include any data and/or information regarding the broker, agent, attorney, or representative, including, but not limited to, the name, sex, age, birth date, address, telephone number, cellular telephone number, text messaging number, videoconferencing or video chat identification (ID) name or number, email address, website address or uniform resource locator (url), and/or any other contact information, agent or representative contact information, of the broker, agent, attorney, or representative. In a preferred embodiment, the database 40H can also contain and/or include information regarding any real estate assets, high value assets, unique assets, intellectual property assets, digital art and/or digital memorabilia assets, and/or non-fungible tokens, and/or services, in or with which the broker, agent, attorney, or representative, deals, has dealings, or has had dealings. In a preferred embodiment, the database 40H can also contain and/or include information regarding an digital asset account(s), digital memorabilia account(s), a digital souvenir account(s), or any other digital account(s), of, for, or associated with, the broker, agent, attorney, or representative. In a preferred embodiment, the database 40H can also contain and/or include video recordings, video calls, video conference recordings, video chat recordings, audio recordings, telephone call recordings, video and audio recordings, photographs, pictures, and/or any records regarding any transactions or activities, involving, regarding, or relating to any interests of or regarding, the broker, agent, attorney, or representative.

In a preferred embodiment, the database 30H can also include work schedule(s) and/or work calendar(s), work scheduling information, and/or work schedule information, for or regarding the broker, agent, attorney, or representative, and/or any information needed for scheduling an appointment with the broker, agent, attorney, or representative.

The database 40H can also contain and/or include, and/or can be linked to or with, any of the data and/or information described herein as being stored in any of the respective databases 11H, 20H, 30H, 40H, 50H, 60H, 70H, 80H, and/or 90H, of any of the herein-described computers or communication devices. The database 40H can also contain or include any software, software programs, and/or software applications (“app”), which is, or may be, needed and/or desired in performing any and/or all of the features and/or functionality described herein as being provided by the apparatus 100 of the present invention and/or the broker/agent communication device 40. The database 40H can also contain and/or include any other data and/or information which is, or may be, needed and/or desired in performing any and/or all of the features and/or functionality described herein as being provided by the apparatus 100 of the present invention and/or the broker/agent communication device 40. The database 40H can also be connected to the CPU 40A.

The broker/agent communication device 40 also includes an output device 40I for outputting any of the data, information, or reports, described herein or otherwise. In the preferred embodiment, the output device 40I can be a printer, a display, a transmitter, a modem, a speaker, and/or any other device which can be used to output data.

The broker/agent communication device 40 can also include a video and/or audio recording device(s) 40J which can include a camera and/or a video recording device, for recording pictures or video and/or video clips, and/or a microphone or an audio recording device, for recording audio or audio clips, which can be recorded by, and/or transmitted live, by or from the broker/agent communication device 40, or which can be recorded by, and stored at or in, the broker/agent communication device 40 for transmission by or from the broker/agent communication device 40 at a later time. The video and/or audio recording device(s) 40J can also be utilized to facilitate one-way broadcasts from the broker/agent communication device 40, and/or can be utilized to facilitate video conferencing, video chatting, and/or audio conferencing, and/or video and audio conferencing, between a user of the broker/agent communication device 40 and any of the herein-described users, individuals, persons, or entities, who or which utilize the apparatus 100 of the present invention.

The broker/agent communication device 40 can also include a global positioning device 40K. In a preferred embodiment, the global positioning device 40K determines or can determine a position or location of the broker/agent communication device 40.

In a preferred embodiment, the broker/agent communication device 40 can also be equipped, and/or can be programmed, for voice activation operation and/or voice control operation of and/or regarding any and/or all of the herein-described operations and functions which are capable of being performed by the broker/agent communication device 40.

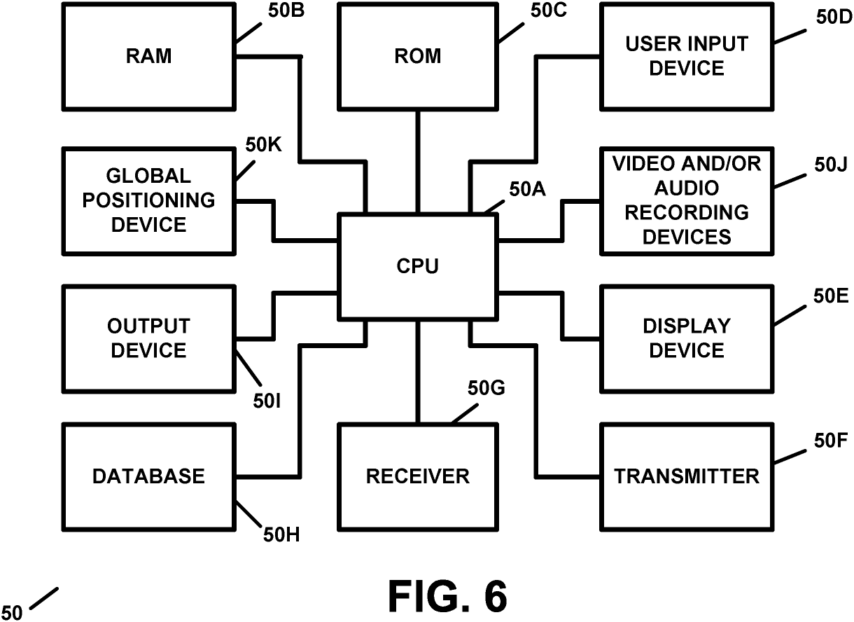

FIG. 6 illustrates the service provider communication device 50 of the apparatus 100, in block diagram form. The service provider communication device 50, in the preferred embodiment, also be any communication device, computer, personal computer, laptop computer, notebook computer, Smart phone or smartphone, smart telephone, cellular telephone, personal digital assistant, wireless telephone, wireless communication device, tablet, tablet computer, watch, smart watch, or wearable device or computer, or any combination of same, or any equivalent of same, or any other computer or communication device, which can provide the functionality of, and which can be utilized as a service provider communication device 50. The service provider communication device 50, in the preferred embodiment, can also be a computer or computer system, a server computer, a network computer, or any other communication device, which can provide the functionality of, and which can be utilized as a service provider communication device 50, such as an Internet server computer and/or a web site server computer.

In the preferred embodiment, the service provider communication device 50 includes a central processing unit or CPU 50A, which, in the preferred embodiment, is a microprocessor. The CPU 50A can also be a microcomputer, a minicomputer, a macro-computer, and/or a mainframe computer, depending upon the application.

The service provider communication device 50 also includes a random access memory device(s) 50B (RAM) and a read only memory device(s) 50C (ROM), each of which is connected to, or linked with, the CPU 50A, and a user input device 50D, for entering data and/or information and/or commands into the service provider communication device 50, which can include any one or more of a keyboard, a scanner, a user pointing device, such as, for example, a mouse, a touch pad, and/or an audio input device and/or a video input device, a microphone or audio recording device, a camera or a video recording device, and/or any device, electronic and/or otherwise, which can be utilized for inputting and/or entering data and/or information and/or commands into the service provider communication device 50. The user input device(s) 50D is/are also connected to, or linked with, the CPU 50A. The service provider communication device 50 also includes a display device 50E for displaying data and/or information to a user or individual. The display device 50E is also connected to, or linked with, the CPU 50A.

The service provider communication device 50 also includes a transmitter(s) 50F, for transmitting signals and/or data and/or information to any one or more of the central processing computer(s) 11, the user communication device(s) 20, the counterparty communication device(s) 30, the broker/agent communication device(s) 40, the digital assets/records storage computer(s) 60, the governmental entity computer(s) 70, the financial institution computer(s) 80, and/or the official information source computer(s) 90, and/or to any other service provider communication device(s) 50, and/or any other individual computer(s) or individual communication device(s) which may be utilized in conjunction with the apparatus 100 of the present invention. The transmitter 50F is also connected to, or linked with, the CPU 50A.

The service provider communication device 50 also includes a receiver 50G, for receiving signals and/or data and/or information from any one or more of central processing computer(s) 11, the user communication device(s) 20, the counterparty communication device(s) 30, the broker/agent communication device(s) 40, the digital assets/records storage computer(s) 60, the governmental entity computer(s) 70, the financial institution computer(s) 80, and/or the official information source computer(s) 90, and/or from any other service provider communication device(s) 50, and/or from any other individual computer(s) or individual communication device(s) which may be utilized in conjunction with the apparatus 100 of the present invention. The receiver 50G is also connected to, or linked with, the CPU 50A.

The service provider communication device 50 also includes a database(s) 50H which contains any and/or all of the data and/or information required, needed, or desired, for allowing and/or enabling the service provider communication device 50 and/or the apparatus 100 to perform any and/or all of the functions and functionalities described herein as being performed, and/or as capable of being performed, by the service provider communication device 50 and/or the apparatus 100 of the present invention. In this regard, and notwithstanding any specific examples of data and/or information described herein as being stored in the database 50H, it is to be understood that the database 50H contains and/or includes any and/or all data and/or information required, needed, or desired, for allowing and/or enabling the service provider communication device 50 and/or the apparatus 100 to perform any and/or all of the functions and functionalities described herein as being performed by the service provider communication device 50 and/or the apparatus 100 of the present invention.

In a preferred embodiment, the database 50H can contain and/or include any data and/or information regarding the service provider, including, but not limited to, the name, sex, age, birth date, address, telephone number, cellular telephone number, text messaging number, videoconferencing or video chat identification (ID) name or number, email address, website address or uniform resource locator (url), and/or any other contact information, agent or representative contact information, of the service provider. In a preferred embodiment, the database 50H can also contain and/or include information regarding any real estate assets, high value assets, unique assets, intellectual property assets, digital art and/or digital memorabilia assets, and/or non-fungible tokens, and/or services, in or with which the service provider, deals, has dealings, or has had dealings. In a preferred embodiment, the database 50H can also contain and/or include information regarding an digital asset account(s), digital memorabilia account(s), a digital souvenir account(s), or any other digital account(s), of, for, or associated with, the service provider. In a preferred embodiment, the database 50H can also contain and/or include video recordings, video calls, video conference recordings, video chat recordings, audio recordings, telephone call recordings, video and audio recordings, photographs, pictures, and/or any records regarding any transactions or activities, work samples, project samples, information, infomercials, commercials, or any other materials or information, of, involving, regarding, or relating to any interests of or regarding, the service provider.

In a preferred embodiment, the database 50H can also include work schedule(s) and/or work calendar(s), work scheduling information, and/or work schedule information, for or regarding the broker, agent, attorney, or representative, and/or any information needed for scheduling an appointment with the broker, agent, attorney, or representative.

The database 50H can also contain and/or include, and/or can be linked to or with, any of the data and/or information described herein as being stored in any of the respective databases 11H, 20H, 30H, 40H, 50H, 60H, 70H, 80H, and/or 90H, of any of the herein-described computers or communication devices. The database 50H can also contain or include any software, software programs, and/or software applications (“app”), which is, or may be, needed and/or desired in performing any and/or all of the features and/or functionality described herein as being provided by the apparatus 100 of the present invention and/or the service provider communication device 50. The database 50H can also contain and/or include any other data and/or information which is, or may be, needed and/or desired in performing any and/or all of the features and/or functionality described herein as being provided by the apparatus 100 of the present invention and/or the service provider communication device 50. The database 50H can also be connected to the CPU 50A.

The service provider communication device 50 also includes an output device 50I for outputting any of the data, information, or reports, described herein or otherwise. In the preferred embodiment, the output device 50I can be a printer, a display, a transmitter, a modem, a speaker, and/or any other device which can be used to output data.

The service provider communication device 50 can also include a video and/or audio recording device(s) 50J which can include a camera and/or a video recording device, for recording pictures or video and/or video clips, and/or a microphone or an audio recording device, for recording audio or audio clips, which can be recorded by, and/or transmitted live, by or from the service provider communication device 50, or which can be recorded by, and stored at or in, the service provider communication device 50 for transmission by or from the service provider communication device 50 at a later time. The video and/or audio recording device(s) 50J can also be utilized to facilitate one-way broadcasts from the service provider communication device 50, and/or can be utilized to facilitate video conferencing, video chatting, and/or audio conferencing, and/or video and audio conferencing, between a user of the service provider communication device 50 and any of the herein-described users, individuals, persons, or entities, who or which utilize the apparatus 100 of the present invention.

The service provider communication device 50 can also include a global positioning device 50K. In a preferred embodiment, the global positioning device 50K determines or can determine a position or location of the service provider communication device 50.

In a preferred embodiment, the service provider communication device 50 can also be equipped, and/or can be programmed, for voice activation operation and/or voice control operation of and/or regarding any and/or all of the herein-described operations and functions which are capable of being performed by the service provider communication device 50.

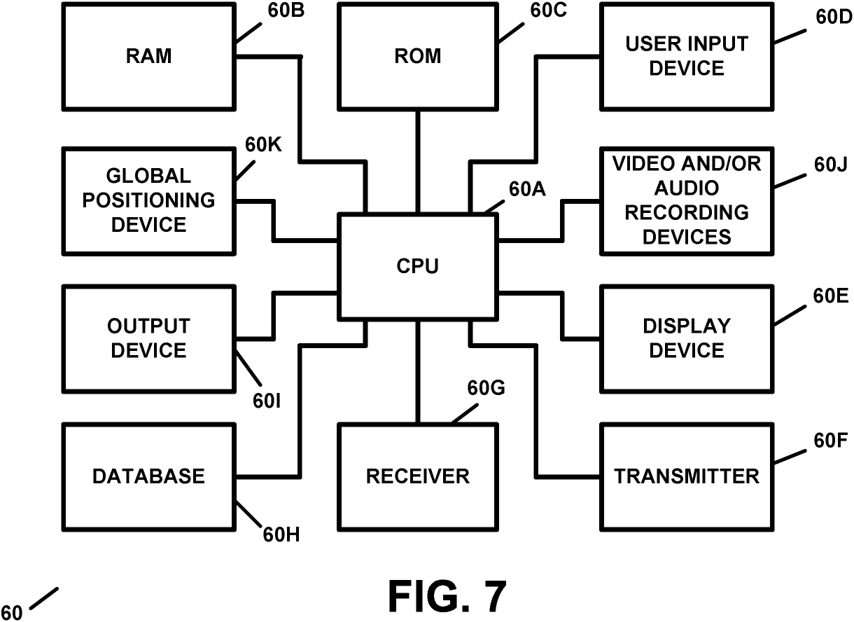

FIG. 7 illustrates the digital assets/records storage computer 60 of the apparatus 100, in block diagram form. The digital assets/records storage computer 60, in the preferred embodiment, can be a computer or computer system, a server computer, a network computer, or any other communication device, which can provide the functionality of, and which can be utilized as a digital assets/records storage computer 60, such as an Internet server computer and/or a web site server computer. The digital assets/records storage computer 60, in the preferred embodiment, can also be any communication device, computer, personal computer, laptop computer, notebook computer, Smart phone or smartphone, smart telephone, cellular telephone, personal digital assistant, wireless telephone, wireless communication device, tablet, tablet computer, watch, smart watch, or wearable device or computer, or any combination of same, or any equivalent of same, or any other computer or communication device, which can provide the functionality of, and which can be utilized as a digital assets/records storage computer 60. In the preferred embodiment, the digital assets/records storage computer 60 includes a central processing unit or CPU 60A, which, in the preferred embodiment, is a microprocessor. The CPU 60A can also be a microcomputer, a minicomputer, a macro-computer, and/or a mainframe computer, depending upon the application.

The digital assets/records storage computer 60 also includes a random access memory device(s) 60B (RAM) and a read only memory device(s) 60C (ROM), each of which is connected to, or linked with, the CPU 60A, and a user input device 60D, for entering data and/or information and/or commands into the digital assets/records storage computer 60, which can include any one or more of a keyboard, a scanner, a user pointing device, such as, for example, a mouse, a touch pad, and/or an audio input device and/or a video input device, a microphone or audio recording device, a camera or a video recording device, and/or any device, electronic and/or otherwise, which can be utilized for inputting and/or entering data and/or information and/or commands into the digital assets/records storage computer 60. The user input device(s) 60D is/are also connected to, or linked with, the CPU 60A. The digital assets/records storage computer 60 also includes a display device 60E for displaying data and/or information to a user or individual. The display device 60E is also connected to, or linked with, the CPU 60A.

The digital assets/records storage computer 60 also includes a transmitter(s) 60F, for transmitting signals and/or data and/or information to any one or more of the central processing computer(s) 11, the user communication device(s) 20, the counterparty communication device(s) 30, the broker/agent communication device(s) 40, the service provider communication device(s) 50, the governmental entity computer(s) 70, the financial institution computer(s) 80, and/or the official information source computer(s) 90, and/or to any other digital assets/records storage computer(s) 60, and/or any other individual computer(s) or individual communication device(s) which may be utilized in conjunction with the apparatus 100 of the present invention. The transmitter 60F is also connected to, or linked with, the CPU 60A.

The digital assets/records storage computer 60 also includes a receiver 60G, for receiving signals and/or data and/or information from any one or more of the central processing computer(s) 11, the user communication device(s) 20, the counterparty communication device(s) 30, the broker/agent communication device(s) 40, the service provider communication device(s) 50, the governmental entity computer(s) 70, the financial institution computer(s) 80, and/or the official information source computer(s) 90, and/or from any other digital assets/records storage computer(s) 60, and/or any other individual computer(s) or individual communication device(s) which may be utilized in conjunction with the apparatus 100 of the present invention. The receiver 60G is also connected to, or linked with, the CPU 60A.

The digital assets/records storage computer 60 also includes a database(s) 60H which contains any and/or all of the data and/or information required, needed, or desired, for allowing and/or enabling the digital assets/records storage computer 60 and/or the apparatus 100 to perform any and/or all of the functions and functionalities described herein as being performed, and/or as capable of being performed, by the digital assets/records storage computer 60 and/or the apparatus 100 of the present invention. In this regard, and notwithstanding any specific examples of data and/or information described herein as being stored in the database 60H, it is to be understood that the database 60H contains or includes any and/or all data and/or information required, needed, or desired, for allowing and/or enabling the digital assets/records storage computer 60 and/or the apparatus 100 to perform any and/or all of the functions and functionalities described herein as being performed by the digital assets/records storage computer 60 and/or the apparatus 100 of the present invention.

The digital assets/records storage computer 60 also includes a database 60H which can include, for each user, individual, counterparty, broker, agent, attorney, representative, and/or service provider, who or which utilizes the apparatus 100 and method of the present invention, information regarding the respective user’s, individual’s, counterparty’s, broker’s, agent’s, attorney’s, representative’s, and/or service provider’s, name, sex, age, birth date, address, telephone number, cellular telephone number, text messaging number, videoconferencing or video chat identification (ID) name or number, email address, website address or uniform resource locator (url), and/or any other contact information, agent or representative contact information, and/or digital asset account information.

In a preferred embodiment, a digital asset account can be utilized to digitally store and/or to safeguard, assets of any type or kind for a user, individual, counterparty, broker, agent, attorney, representative, or service provider. In a preferred embodiment, the digital asset account can store information regarding any real estate assets, real property assets, high value assets, unique assets, intellectual property assets, digital art and/or digital memorabilia assets, and/or non-fungible tokens, and/or services, and/or any information regarding any description of the same, any information regarding any respective and/or available sale(s), sales offering(s), lease(s), lease offering(s), license(s), licensing offering(s), rental(s), rental offering(s), or any other offerings regarding the same, any information regarding the value of the same, any information regarding parts sales, transactions, and/or commerce, involving or relating to the same, any information regarding past or current owners, lessees. licensees, or renters, of the same, and/o any other information needed, required, or desired, for providing an exchange or clearinghouse for any of the herein-described real estate assets, real property assets, high value assets, unique assets, intellectual property assets, digital art and/or digital memorabilia assets, and/or non-fungible tokens, and/or services.

In a preferred embodiment, the digital asset account can also include information regarding assets, which can include, among other things, monetary assets, currency assets, cryptocurrency assets, non-monetary assets, and/or any other assets which can be used to effectuate payment for any of the herein-described real estate assets, real property assets, high value assets, unique assets, intellectual property assets, digital art and/or digital memorabilia assets, and/or non-fungible tokens, and/or services.

In a preferred embodiment, the digital asset account can also include information regarding any of the herein-described real estate assets, real property assets, high value assets, unique assets, intellectual property assets, digital art and/or digital memorabilia assets, and/or non-fungible tokens, and/or services, and/or any information regarding any memorabilia, digital memorabilia, souvenirs, digital souvenirs, video recordings, video and audio recordings, pictures, photographs, autographs, digital autographs, of or relating thereto, and/or any other items or things that have, or that may have, a memorabilia, nostalgic, or sentimental, value to any user or individual, counterparty, broker, agent, attorney, representative, or service provider, who or which utilized the apparatus 100 of the present invention.

In a preferred embodiment, any of the herein-described memorabilia, digital memorabilia, souvenirs, digital souvenirs, video recordings, video and audio recordings, photographs, pictures, autographs, digital autographs, and/or any other items or things which have a memorabilia, nostalgic, or sentimental, value, can also be stored in a digital memorabilia account, a digital souvenir account, or any other digital account for storing things and/or items having nostalgic or sentimental value, each of which accounts can be stand alone accounts or can be stored in, or as a component account of, or sub-account of, a respective digital asset account of, for, or associated with, any user or individual, counterparty, broker, agent, attorney, representative, or service provider, who or which utilized the apparatus 100 of the present invention.

In a preferred embodiment, the database 60H can contain and/or include, for each digital asset account, and/or for each digital memorabilia account, digital souvenir account, or any other digital account, held by, owned by, or associated with, a respective user or individual, counterparty, broker, agent, attorney, representative, or service provider, data and/or information regarding each asset held by the respective user or individual, counterparty, broker, agent, attorney, representative, or service provider, and for each asset, data and/or information regarding the name of the asset the date the asset was acquired, a description of the asset, an assigned value for the asset, and/or any other information regarding the asset. In a preferred embodiment, the digital asset account can also include information regarding currencies or cryptocurrencies which can be used by a respective user or individual, counterparty, broker, agent, attorney, representative, or service provider, to make or receive a payment in, for, or regarding, any transaction or act of commerce which can transpire via, or as a result of use of, the apparatus 100 of the present invention.

In another preferred embodiment, the digital asset account can also include information regarding currencies or cryptocurrencies which can represent, or which can include, a payment or payments received by a respective user or individual, counterparty, broker, agent, attorney, representative, or service provider, from another respective user or individual, counterparty, broker, agent, attorney, representative, or service provider.

The database 60H can also contain and/or include, and/or can be linked to or with, any of the data and/or information described herein as being stored in any of the respective databases 11H, 20H, 30H, 40H, 50H, 60H, 70H, 80H and/or 90H, of any of the herein-described computers or communication devices. The database 60H can also contain or include any software, software programs, and/or software applications (“app”), which is, or may be, needed and/or desired in performing any and/or all of the features and/or functionality described herein as being provided by the apparatus 100 of the present invention and/or the digital assets/records storage computer 60. The database 60H can also contain and/or include any other data and/or information which is, or may be, needed and/or desired in performing any and/or all of the features and/or functionality described herein as being provided by the apparatus 100 of the present invention and/or the digital assets/records storage computer 60. The database 60H can also be connected to the CPU 60A.

The digital assets/records storage computer 60 also includes an output device 60I for outputting any of the data, information, or reports, described herein or otherwise. In the preferred embodiment, the output device 60I can be a printer, a display, a transmitter, a modem, a speaker, and/or any other device which can be used to output data.

The digital assets/records storage computer 60 can also include a video and/or audio recording device(s) 60J which can include a camera and/or a video recording device, for recording pictures or video and/or video clips, and/or a microphone or an audio recording device, for recording audio or audio clips, which can be recorded by, and/or transmitted live, by or from the digital assets/records storage computer 60, or which can be recorded by, and stored at or in, the digital assets/records storage computer 60 for transmission by or from the digital assets/records storage computer 60 at a later time. The video and/or audio recording device(s) 60J can also be utilized to facilitate one-way broadcasts from the digital assets/records storage computer 60, and/or can be utilized to facilitate video conferencing, video chatting, and/or audio conferencing, and/or video and audio conferencing, between a user of the digital assets/records storage computer 60 and any of the herein-described users, individuals, persons, or entities, who or which utilize the apparatus 100 of the present invention.

The digital assets/records storage computer 60 can also include a global positioning device 60K. In a preferred embodiment, the global positioning device 60K determines or can determine a position or location of the digital assets/records storage computer 60.

In a preferred embodiment, the digital assets/records storage computer 60 can also be equipped, and/or can be programmed, for voice activation operation and/or voice control operation of and/or regarding any and/or all of the herein-described operations and functions which are capable of being performed by the digital assets/records storage computer 60.

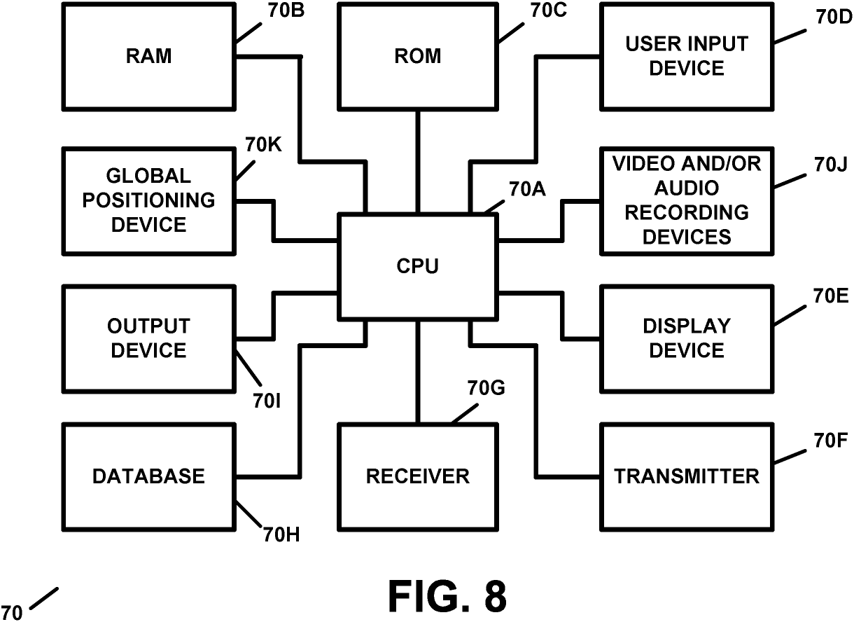

FIG. 8 illustrates the governmental entity computer 70 of the apparatus 100, in block diagram form. The governmental entity computer 70, in the preferred embodiment, can be a computer or computer system, a server computer, a network computer, or any other communication device, which can provide the functionality of, and which can be utilized as a governmental entity computer 70, such as an Internet server computer and/or a web site server computer. The governmental entity computer 70, in the preferred embodiment, can also be any communication device, computer, personal computer, laptop computer, notebook computer, Smart phone or smartphone, smart telephone, cellular telephone, personal digital assistant, wireless telephone, wireless communication device, tablet, tablet computer, watch, smart watch, or wearable device or computer, or any combination of same, or any equivalent of same, or any other computer or communication device, which can provide the functionality of, and which can be utilized as a governmental entity computer 70. In the preferred embodiment, the governmental entity computer 70 includes a central processing unit or CPU 70A, which, in the preferred embodiment, is a microprocessor. The CPU 70A can also be a microcomputer, a minicomputer, a macro-computer, and/or a mainframe computer, depending upon the application.

The governmental entity computer 70 also includes a random access memory device(s) 70B (RAM) and a read only memory device(s) 70C (ROM), each of which is connected to, or linked with, the CPU 70A, and a user input device 70D, for entering data and/or information and/or commands into the governmental entity computer 70, which can include any one or more of a keyboard, a scanner, a user pointing device, such as, for example, a mouse, a touch pad, and/or an audio input device and/or a video input device, a microphone or audio recording device, a camera or a video recording device, and/or any device, electronic and/or otherwise, which can be utilized for inputting and/or entering data and/or information and/or commands into the governmental entity computer 70. The user input device(s) 70D is/are also connected to, or linked with, the CPU 70A. The governmental entity computer 70 also includes a display device 70E for displaying data and/or information to a user or individual. The display device 70E is also connected to, or linked with, the CPU 70A.

The governmental entity computer 70 also includes a transmitter(s) 70F, for transmitting signals and/or data and/or information to any one or more of the central processing computer(s) 11, the user communication device(s) 20, the counterparty communication device(s) 30, the broker/agent communication device(s) 40, the service provider communication device(s) 50, the digital assets/records storage computer(s) 60, the governmental entity computer(s) 70, the financial institution computer(s) 80, and/or the official information source computer(s) 90, and/or to any other governmental entity computer(s) 70, and/or to any other individual computer(s) or individual communication device(s) which may be utilized in conjunction with the apparatus 100 of the present invention. The transmitter 70F is also connected to, or linked with, the CPU 70A.

The governmental entity computer 70 also includes a receiver 70G, for receiving signals and/or data and/or information from any one or more of the central processing computer(s) 11, the user communication device(s) 20, the counterparty communication device(s) 30, the broker/agent communication device(s) 40, the service provider communication device(s) 50, the digital assets/records storage computer(s) 60, the governmental entity computer(s) 70, the financial institution computer(s) 80, and/or the official information source computer(s) 90, and/or from any other governmental entity computer(s) 70, and/or from any other individual computer(s) or individual communication device(s) which may be utilized in conjunction with the apparatus 100 of the present invention. The receiver 70G is also connected to, or linked with, the CPU 70A.

The governmental entity computer 70 also includes a database(s) 70H which contains any and/or all of the data and/or information required, needed, or desired, for allowing and/or enabling the governmental entity computer 70 and/or the apparatus 100 to perform any and/or all of the functions and functionalities described herein as being performed, and/or as capable of being performed, by the governmental entity computer 70 and/or the apparatus 100 of the present invention. The database 70H can also contain and/or can be linked to any of the data and/or information described herein as being stored in the database 11H.

The database 70H can contain and/or include any data and/or information regarding any and/or all real estate assets, real property assets, high value assets, unique assets, intellectual property assets, digital art and/or digital memorabilia assets, and/or non-fungible tokens, and/or services, which can be made to be, or which may be registered to be, a matter of public record, or otherwise registered with the governmental entity, and/or can be those respective assets or services which are within or under the jurisdiction of the respective governmental entity which is using the governmental entity computer 70.

In a preferred embodiment, the database 70H can contain and/or include, for each respective real estate asset, real property asset, high value asset, unique asset, intellectual property asset, digital art and/or digital memorabilia asset, and/or non-fungible token, and/or service, which is either the subject of any public record or public records, and/or which is otherwise registered with the apparatus 100, the address of the respective asset or service, the name, if applicable, of the same, the registered owner or owners of the respective asset or service, current taxes for the real estate asset or other asset or any maintenance or other costs of or regarding the respective asset or service, a past purchase price or past purchase prices for the respective asset or service, any past taxes due, owed, or paid, for the respective asset or service, past owners of the respective asset or service, past dates of sale or transfer for the respective asset or service, type of deed involved in any transfer regarding the respective asset or service, information regarding the chain of title of the respective asset or service, and/or any specific details regarding and/or specific to the respective asset or service, such as, for example, but not limited to, for a real estate asset, a number of bedrooms, number of bathrooms, square footage, size of parcel of land on which the real estate asset is situated, number and size of apartments in the real estate asset, level of occupancy of the real estate asset, rent roll of the real estate asset, number and size of commercial or rental units in a commercial real estate asset, level of occupancy of the commercial real estate asset, rent roll of the commercial real estate asset, acreage of a vacant land asset, permits, building permits, certificates of occupancy, and/or any other description or descriptions of and/or for the respective real estate asset. With regards to any high value asset, unique asset, intellectual property asset, digital art and/or digital memorabilia asset, and/or non-fungible token, and/or service, similar or analogous information can also be stored for the respective asset or service.

The database 70H can also contain information regarding any other high value asset, unique asset, intellectual property asset, digital art and/or digital memorabilia asset, and/or non-fungible token, and/or service which is either the subject of any public record or public records, and/or which is otherwise registered with the governmental entity. In a preferred embodiment, the database 70H can contain and/or include, for each such respective high value asset, unique asset, intellectual property asset, digital art and/or digital memorabilia asset, and/or non-fungible token, and/or service, which is either the subject of any public record or public records, and/or which is otherwise registered with the governmental entity, a name and/or description of the respective asset or service, the name and address of the owner, the purchase price or past purchase prices, a value, and/or an appraised value, of or for the respective asset or service, and/or any other information which may be needed, required, or desired, regarding the respective asset or service for performing any and/or all of the functions or functionalities of the apparatus 100.

The database 70H can also contain and/or include, and/or can be linked to or with, any of the data and/or information described herein as being stored in any of the respective databases 11H, 20H, 30H, 40H, 50H, 60H, 70H, 80H and/or 90H, of any of the herein-described computers or communication devices. The database 70H can also contain or include any software, software programs, and/or software applications (“app”), which is, or may be, needed and/or desired in performing any and/or all of the features and/or functionality described herein as being provided by the apparatus 100 of the present invention and/or the governmental entity computer 70. The database 70H can also contain and/or include any other data and/or information which is, or may be, needed and/or desired in performing any and/or all of the features and/or functionality described herein as being provided by the apparatus 100 of the present invention and/or the governmental entity computer 70. The database 70H can also be connected to the CPU 70A.

The governmental entity computer 70 also includes an output device 70I for outputting any of the data, information, or reports, described herein or otherwise. In the preferred embodiment, the output device 70I can be a printer, a display, a transmitter, a modem, a speaker, and/or any other device which can be used to output data.

The governmental entity computer 70 can also include a video and/or audio recording device(s) 70J which can include a camera and/or a video recording device, for recording pictures or video and/or video clips, and/or a microphone or an audio recording device, for recording audio or audio clips, which can be recorded by, and/or transmitted live, by or from the governmental entity computer 70, or which can be recorded by, and stored at or in, the governmental entity computer 70 for transmission by or from the governmental entity computer 70 at a later time. The video and/or audio recording device(s) 70J can also be utilized to facilitate one-way broadcasts from the governmental entity computer 70, and/or can be utilized to facilitate video conferencing, video chatting, and/or audio conferencing, and/or video and audio conferencing, between a user of the governmental entity computer 70 and any of the herein-described users, individuals, persons, or entities, who or which utilize the apparatus 100 of the present invention.

The governmental entity computer 70 can also include a global positioning device 70K. In a preferred embodiment, the global positioning device 70K determines or can determine a position or location of the educational/instructional provider computer 70.

In a preferred embodiment, the governmental entity computer 70 can also be equipped, and/or can be programmed, for voice activation operation and/or voice control operation of and/or regarding any and/or all of the herein-described operations and functions which are capable of being performed by the governmental entity computer 70.

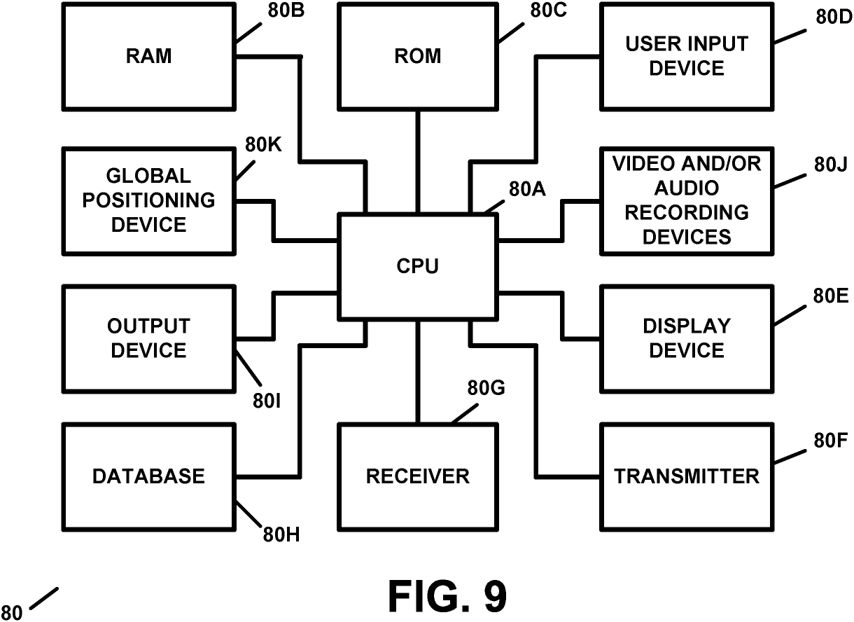

FIG. 9 illustrates the financial institution computer 80 of the apparatus 100, in block diagram form. The financial institution computer 80, in the preferred embodiment, can be a computer or computer system, a server computer, a network computer, or any other communication device, which can provide the functionality of, and which can be utilized as a financial institution computer 80, such as an Internet server computer and/or a web site server computer. The financial institution computer 80, in the preferred embodiment, can also be any communication device, computer, personal computer, laptop computer, notebook computer, Smart phone or smartphone, smart telephone, cellular telephone, personal digital assistant, wireless telephone, wireless communication device, tablet, tablet computer, watch, smart watch, or wearable device or computer, or any combination of same, or any equivalent of same, or any other computer or communication device, which can provide the functionality of, and which can be utilized as a financial institution computer 80. In the preferred embodiment, the financial institution computer 80 includes a central processing unit or CPU 80A, which, in the preferred embodiment, is a microprocessor. The CPU 80A can also be a microcomputer, a minicomputer, a macro-computer, and/or a mainframe computer, depending upon the application.

The financial institution computer 80 also includes a random access memory device(s) 80B (RAM) and a read only memory device(s) 80C (ROM), each of which is connected to, or linked with, the CPU 80A, and a user input device 80D, for entering data and/or information and/or commands into the financial institution computer 80, which can include any one or more of a keyboard, a scanner, a user pointing device, such as, for example, a mouse, a touch pad, and/or an audio input device and/or a video input device, a microphone or audio recording device, a camera or a video recording device, and/or any device, electronic and/or otherwise, which can be utilized for inputting and/or entering data and/or information and/or commands into the financial institution computer 80. The user input device(s) 80D is/are also connected to, or linked with, the CPU 80A. The financial institution computer 80 also includes a display device 80E for displaying data and/or information to a user or individual. The display device 80E is also connected to, or linked with, the CPU 80A.

The financial institution computer 80 also includes a transmitter(s) 80F, for transmitting signals and/or data and/or information to any one or more of the central processing computer(s) 11, the user communication device(s) 20, the counterparty communication device(s) 30, the broker/agent communication device(s) 40, the service provider communication device(s) 50, the digital assets/records storage computer(s) 60, the governmental entity computer(s) 70, and/or the official information source computer(s) 90, and/or to any other financial institution computer(s) 80, and/or to any other individual computer(s) or individual communication device(s) which may be utilized in conjunction with the apparatus 100 of the present invention. The transmitter 80F is also connected to, or linked with, the CPU 80A.

The financial institution computer 80 also includes a receiver 80G, for receiving signals and/or data and/or information from any one or more of the central processing computer(s) 11, the user communication device(s) 20, the counterparty communication device(s) 30, the broker/agent communication device(s) 40, the service provider communication device(s) 50, the digital assets/records storage computer(s) 60, the governmental entity computer(s) 70, and/or the official information source computer(s) 90, and/or from any other financial institution computer(s) 80, and/or from and/or any other individual computer(s) or individual communication device(s) which may be utilized in conjunction with the apparatus 100 of the present invention. The receiver 80G is also connected to, or linked with, the CPU 80A.

The financial institution computer 80 also includes a database(s) 80H which contains any and/or all of the data and/or information required, needed, or desired, for allowing and/or enabling the financial institution computer 80 and/or the apparatus 100 to perform any and/or all of the functions and functionalities described herein as being performed, and/or as capable of being performed, by the financial institution computer 80 and/or the apparatus 100 of the present invention. In this regard, and notwithstanding any specific examples of data and/or information described herein as being stored in the database 80H, it is to be understood that the database 80H contains or includes any and/or all data and/or information required, needed, or desired, for allowing and/or enabling the financial institution computer 80 and/or the apparatus 100 to perform any and/or all of the functions and functionalities described herein as being performed by the financial institution computer 80 and/or the apparatus 100 of the present invention.

The database 80H can contain and/or included, and/or can be linked to or with, any of the data and/or information typically found in, or utilized by, a financial institution or a group of financial institutions. The database 80H can also contain and/or include information regarding a financial account(s) or bank account(s) of, for, or regarding, any of the herein-described users, individuals, counterparties, brokers, agents, attorneys, representatives, and/or service providers, who or which utilizes the apparatus 100 and method of the present invention. The database 80H can also contain and/or include any data and/or information which may be needed or required, and/or which may be desired, for performing any of the functionality and/or processing routines described herein as being performed by the financial institution computer 80.

The database 80H can also contain and/or include, and/or can be linked to or with, any of the data and/or information described herein as being stored in any of the respective databases 11H, 20H, 30H, 40H, 50H, 60H, 70H, 80H and/or 90H, of any of the herein-described computers or communication devices. The database 80H can also contain or include any software, software programs, and/or software applications (“app”), which is, or may be, needed and/or desired in performing any and/or all of the features and/or functionality described herein as being provided by the apparatus 100 of the present invention and/or the financial institution computer 80. The database 80H can also contain and/or include any other data and/or information which is, or may be, needed and/or desired in performing any and/or all of the features and/or functionality described herein as being provided by the apparatus 100 of the present invention and/or the financial institution computer 80. The database 80H can also be connected to the CPU 80A.

The financial institution computer 80 also includes an output device 80I for outputting any of the data, information, or reports, described herein or otherwise. In the preferred embodiment, the output device 80I can be a printer, a display, a transmitter, a modem, a speaker, and/or any other device which can be used to output data.

The financial institution computer 80 can also include a video and/or audio recording device(s) 80J which can include a camera and/or a video recording device, for recording pictures or video and/or video clips, and/or a microphone or an audio recording device, for recording audio or audio clips, which can be recorded by, and/or transmitted live, by or from the financial institution computer 80, or which can be recorded by, and stored at or in, the financial institution computer 80 for transmission by or from the financial institution computer 80 at a later time. The video and/or audio recording device(s) 80J can also be utilized to facilitate one-way broadcasts from the financial institution computer 80, and/or can be utilized to facilitate video conferencing, video chatting, and/or audio conferencing, and/or video and audio conferencing, between a user of the financial institution computer 80 and any of the herein-described users, individuals, persons, or entities, who or which utilize the apparatus 100 of the present invention.

The financial institution computer 80 can also include a global positioning device 80K. In a preferred embodiment, the global positioning device 80K determines or can determine a position or location of the financial institution computer 80.

In a preferred embodiment, the financial institution computer 80 can also be equipped, and/or can be programmed, for voice activation operation and/or voice control operation of and/or regarding any and/or all of the herein-described operations and functions which are capable of being performed by the financial institution computer 80.

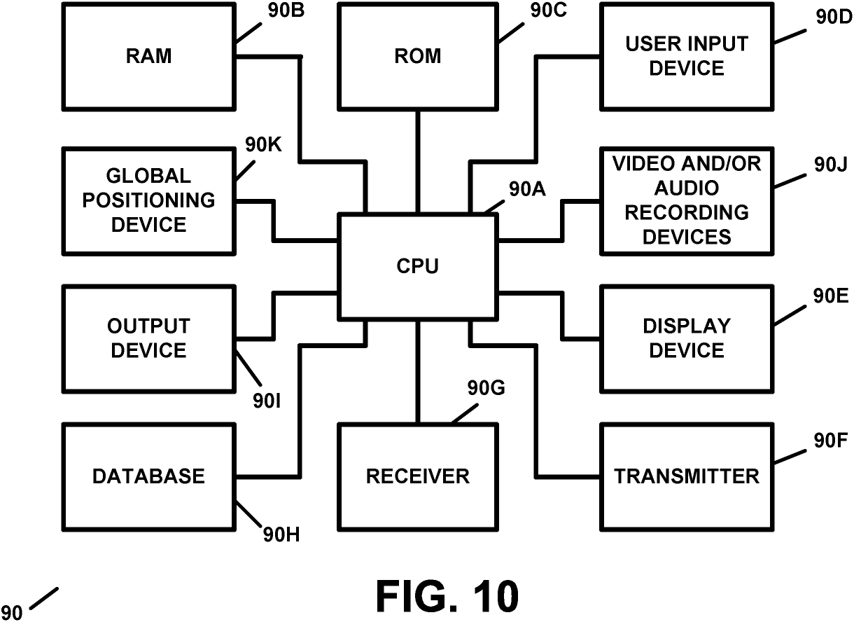

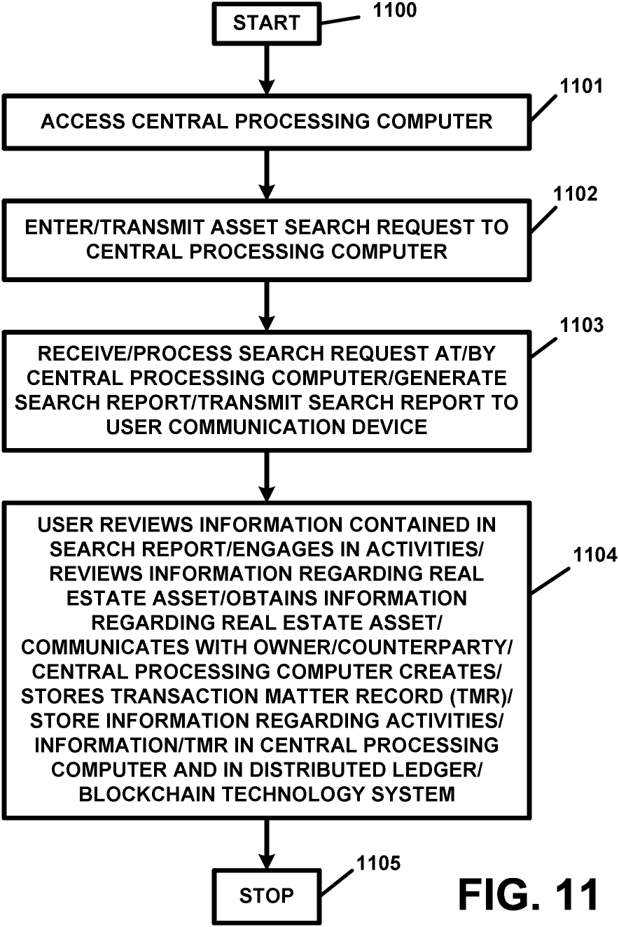

FIG. 10 illustrates the official information source computer 90 of the apparatus 100, in block diagram form. The official information source computer 90, in a preferred embodiment, is associated with one or more sources of official information, which source(s) of official information is/are trusted by those who use the apparatus 100 for governing the transaction in which they engage. For example, in a transaction involving a transfer of an asset on a particular date or time, or the payment of funds in a transaction on a particular date and time, the official information source computer can be the source or provider of calendar and time information. Any other information upon which transactions may be scheduled or conditioned can also be obtained from the official information source computer 90 or any computer or information source to which it is linked.

The official information source computer 90, in a preferred embodiment, can be a computer or computer system, a server computer, a network computer, or any other communication device, which can provide the functionality of, and which can be utilized as an official information source computer 90, such as an Internet server computer and/or a web site server computer. The official information source computer 90, in the preferred embodiment, can also be any communication device, computer, personal computer, laptop computer, notebook computer, Smart phone or smartphone, smart telephone, cellular telephone, personal digital assistant, wireless telephone, wireless communication device, tablet, tablet computer, watch, smart watch, or wearable device or computer, or any combination of same, or any equivalent of same, or any other computer or communication device, which can provide the functionality of, and which can be utilized as an official information source computer 90. In the preferred embodiment, the official information source computer 90 includes a central processing unit or CPU 90A, which, in the preferred embodiment, is a microprocessor. The CPU 90A can also be a microcomputer, a minicomputer, a macro-computer, and/or a mainframe computer, depending upon the application.

The official information source computer 90 also includes a random access memory device(s) 90B (RAM) and a read only memory device(s) 90C (ROM), each of which is connected to, or linked with, the CPU 90A, and a user input device 90D, for entering data and/or information and/or commands into the official information source computer 90, which can include any one or more of a keyboard, a scanner, a user pointing device, such as, for example, a mouse, a touch pad, and/or an audio input device and/or a video input device, a microphone or audio recording device, a camera or a video recording device, and/or any device, electronic and/or otherwise, which can be utilized for inputting and/or entering data and/or information and/or commands into the official information source computer 90. The user input device(s) 90D is/are also connected to, or linked with, the CPU 90A. The official information source computer 90 also includes a display device 90E for displaying data and/or information to a user or individual. The display device 90E is also connected to, or linked with, the CPU 90A.

The official information source computer 90 also includes a transmitter(s) 90F, for transmitting signals and/or data and/or information to any one or more of the central processing computer(s) 11, the user communication device(s) 20, the counterparty communication device(s) 30, the broker/agent communication device(s) 40, the service provider communication device(s) 50, the digital assets/records storage computer(s) 60, the governmental entity computer(s) 70, and/or financial institution computer(s) 80, and/or to any other official information source computer(s) 90, and/or to any other individual computer(s) or individual communication device(s) which may be utilized in conjunction with the apparatus 100 of the present invention. The transmitter 90F is also connected to, or linked with, the CPU 90A.

The official information source computer 90 also includes a receiver 90G, for receiving signals and/or data and/or information from any one or more of the central processing computer(s) 11, the user communication device(s) 20, the counterparty communication device(s) 30, the broker/agent communication device(s) 40, the service provider communication device(s) 50, the digital assets/records storage computer(s) 60, the governmental entity computer(s) 70, and/or the financial institution computer(s) 80, and/or from any other official information source computer(s) 90, and/or from any other financial institution computer(s) 80, and/or from any other individual computer(s) or individual communication device(s) which may be utilized in conjunction with the apparatus 100 of the present invention. The receiver 90G is also connected to, or linked with, the CPU 90A.

The official information source computer 90 also includes a database(s) 90H which contains any and/or all of the data and/or information required, needed, or desired, for allowing and/or enabling the official information source computer 90 and/or the apparatus 100 to perform any and/or all of the functions and functionalities described herein as being performed, and/or as capable of being performed, by the official information source computer 90 and/or the apparatus 100 of the present invention. In this regard, and notwithstanding any specific examples of data and/or information described herein as being stored in the database 90H, it is to be understood that the database 90H contains or includes any and/or all data and/or information required, needed, or desired, for allowing and/or enabling the official information source computer 90 and/or the apparatus 100 to perform any and/or all of the functions and functionalities described herein as being performed by the official information source computer 90 and/or the apparatus 100 of the present invention.

The database 90H can contain and/or included, and/or can be linked to or with, any of the data and/or information typically found in, or utilized by, an official information source or a group of official information sources. The database 90H can also contain and/or include any data and/or information which may be needed or required, and/or which may be desired, for performing any of the functionality and/or processing routines described herein as being performed by the official information source computer 90.

The database 90H can also contain and/or include, and/or can be linked to or with, any of the data and/or information described herein as being stored in any of the respective databases 11H, 20H, 30H, 40H, 50H, 60H, 70H, 80H and/or 90H, of any of the herein-described computers or communication devices. The database 90H can also contain or include any software, software programs, and/or software applications (“app”), which is, or may be, needed and/or desired in performing any and/or all of the features and/or functionality described herein as being provided by the apparatus 100 of the present invention and/or the official information source computer 90. The database 90H can also contain and/or include any other data and/or information which is, or may be, needed and/or desired in performing any and/or all of the features and/or functionality described herein as being provided by the apparatus 100 of the present invention and/or the official information source computer 90. The database 90H can also be connected to the CPU 90A.

The official information source computer 90 also includes an output device 90I for outputting any of the data, information, or reports, described herein or otherwise. In the preferred embodiment, the output device 90I can be a printer, a display, a transmitter, a modem, a speaker, and/or any other device which can be used to output data.

The official information source computer 90 can also include a video and/or audio recording device(s) 90J which can include a camera and/or a video recording device, for recording pictures or video and/or video clips, and/or a microphone or an audio recording device, for recording audio or audio clips, which can be recorded by, and/or transmitted live, by or from the official information source computer 90, or which can be recorded by, and stored at or in, the official information source computer 90 for transmission by or from the official information source computer 90 at a later time. The video and/or audio recording device(s) 90J can also be utilized to facilitate one-way broadcasts from the official information source computer 90, and/or can be utilized to facilitate video conferencing, video chatting, and/or audio conferencing, and/or video and audio conferencing, between a user of the official information source computer 90 and any of the herein-described users, individuals, persons, or entities, who or which utilize the apparatus 100 of the present invention.

The official information source computer 90 can also include a global positioning device 90K. In a preferred embodiment, the global positioning device 90K determines or can determine a position or location of the official information source computer 90.

In a preferred embodiment, the official information source computer 90 can also be equipped, and/or can be programmed, for voice activation operation and/or voice control operation of and/or regarding any and/or all of the herein-described operations and functions which are capable of being performed by the official information source computer 90.

The apparatus 100 and methods of the present invention can be utilized in a wide variety of preferred embodiments in order to provide a more technologically improved exchange and/or clearinghouse for prospective buyers or purchasers, as well as for prospective sellers, of any types or kinds of real estate assets, real property assets, high value assets, unique assets, intellectual property assets, digital art and/or digital memorabilia assets, and/or any non-fungible tokens of or for the same, and/or any non-fungible tokens associated with and/or related to the same, and/or any non-fungible tokens, and/or services.

The apparatus 100 and methods of the present invention provides a more technologically improved exchange and/or clearinghouse for prospective buyers or purchasers, as well as for prospective sellers, of any types or kinds of real estate assets, real property assets, high value assets, unique assets, intellectual property assets, digital art and/or digital memorabilia assets, and/or any non-fungible tokens of or for the same, and/or any non-fungible tokens associated with and/or related to the same, and/or any non-fungible tokens, and/or services, which provides for greater transparency, accountability, and/or security, in and regarding transactions involving the same.

It is envisioned that any owner or other authorized individual can list or register an asset, which can be any asset described herein or otherwise which can be capable of being sold, transferred, leased, rented, licensed, or optioned in any way, with the central processing computer 11. In a preferred embodiment, the owner or other authorized individual can also create a non-fungible token (NFT) for and/or representing the asset. In this regard, the asset can also be sold, transferred, leased, rented, licensed, or optioned in any way, as a non-fungible token. In a preferred embodiment, the owner or authorized individual can use a user communication device 20 in order to access the central processing computer 11, access his, her, or its, account, or create an account and access the same, and list or register his, her, or its, asset, or the non-fungible token (NFT) for the same, for sale, for transfer, for lease or for leasing, for rent of for renting, for license or for licensing, or for selling an option or for optioning in any way.

In a preferred embodiment, it is envisioned that the owner or other authorized individual can list or register the respective real estate asset(s), real property asset(s), high value asset(s), unique asset(s), intellectual property asset(s), digital art and/or digital memorabilia asset(s), and/or any non-fungible token(s) of or for the same, and/or any non-fungible token(s) associated with and/or related to the same, and/or any non-fungible token(s) (also herein referred to as “asset” or “assets”), and/or service(s), by providing a name or identifying information for the same, a description of the same, a price for the same, a history of or for the same or a history of a transaction(s) involving the same, historical information regarding the same, information regarding the creation or inception of the same, a picture(s), photograph(s), video recording(s), video presentation(s), commercial(s), infomercial(s), a certificate of title of or for the same, a certificate of authenticity of or for the same, and/or any other information regarding the same, contact information for the owner or authorized individual, or a broker, agent, attorney, or representative, of the owner or authorized individual, such as, not limited to, name, address, telephone number, cellular telephone number, email address, text number, and/or video conferencing information, and/or any scheduling and/or availability information for scheduling a call or video conference call with the owner or authorized individual or with his, her, or its, broker, agent, attorney, or representative.

In a preferred embodiment, the owner or other authorized individual can also provide information regarding, and/or links to information regarding, any digital assets/records storage computer(s) 60, any governmental entity computer(s) 70, any financial institution computer(s) 80, and/or any official information source computer(s) 90, which may contain and/or store any information related to or regarding the asset being listed or registered which might be of interest to, or which might be needed by, any prospective buyer, purchaser, or user of the apparatus 100.

In a preferred embodiment, once the respective asset or assets, or service(s), has/have been listed or registered with the central processing computer 11, such will be available for sale, for transfer, for lease or for leasing, for rent of for renting, for license or for licensing, or for selling an option thereto or therefor or for optioning in any way, with the exchange or clearinghouse provided by the apparatus 100 of the present invention.

In a preferred embodiment, the apparatus 100 and methods of the present invention can be utilized in the sale of real estate assets or real property assets and/or any assets relating thereto or derived therefrom. In another preferred embodiment, the apparatus 100 and methods of the present invention can also be utilized in the sale, rental, or leasing, of real estate assets or real property assets, and/or any assets relating thereto for derived therefrom, and/or any non-fungible token (NFT) of, corresponding to, or relating to, the same.

In a preferred embodiment, a prospective purchaser, renter, or lessee, can utilize the apparatus 100 of the present invention in order to search for and to locate a real estate asset or a real property asset, that he or she is interested in purchasing, renting, or leasing. In a preferred embodiment, a prospective purchaser, renter, or lessee, can also utilize the apparatus 100 of the present invention in order to search for and to locate a non-fungible token of, for, or representing, the real estate asset or a real property asset, that he or she is interested in purchasing, renting, or leasing. The prospective purchaser, renter, or lessee, can identify or locate, via searching available listings, one or more real estate assets or real property assets, and obtain any information regarding any one or more of the same from any digital assets/records storage computer(s) 60, any governmental entity computer(s) 70, any financial institution computer(s) 80, and/or any official information source computer(s) 90, which may contain and/or store any information related to or regarding the same, and, if interested, can communicate an offer directly to an owner of an asset in which the prospective purchaser, renter, or lessee, is interested. Thereafter, a record regarding any transaction involving or relating to the asset can be stored in both the database 11H of the central processing computer 11 and in the distributed ledger/Blockchain technology system 12 of the central processing computer and distributed ledger and Blockchain technology system 10.

In this regard, any information regarding any transaction involving the real estate asset or the real property asset can be stored in or at a centralized location, in the database 11H of the central processing computer 11, and in the distributed ledger/Blockchain technology system 12, so as to secure information regarding the same and any transaction(s) involving the same.

FIG. 11 illustrates a preferred embodiment method of utilizing the apparatus 100 of the present invention, in flow diagram form. For illustrative purposes, the embodiment of FIG. 11 will be described in connection with a user or individual seeking to purchase a real estate asset or a real property asset. It should be noted, however, that the embodiment of FIG. 11 can be utilized in a same, a similar, and/or an analogous, manner in connection with a renting, leasing, or obtaining an option for purchasing, renting, or leasing, a real estate asset or a real property asset.

With reference to FIG. 11, the operation of the apparatus 100 commences at step 1100. At step 1101, the user or individual can utilize his or her user communication device 20 in order to access the central processing computer 11. At step 1102, the user can enter, into the user communication device 20, a search request containing search information regarding a real estate asset or a real property asset in which he or she is interested. In a preferred embodiment, the search request or search information can include any information or criteria used by a prospective purchaser to locate or to identify any real estate asset or real property asset. At step 1102, the user communication device 20 will transmit the search request containing the search information to the central processing computer 11.

At step 1103, the central processing computer 11 will receive and process the search request and search information contained therein and will generate a search report containing information regarding and/or identifying one or more real estate assets or real property assets which meet any parameters of or contained in, or which are responsive to, the search request and/or any search information contained therein. At step 1103, the central processing computer 11 will transmit the search report to the user communication device 20. At step 1103, the user communication device 20 will receive the search report.

At step 1104, the user or individual can review the information contained in the search report. At step 1104, the user or individual can, for any real estate asset or real property asset (the “respective asset”) contained in or identified in the search report, access any information provided in the listing of the respective asset or access any information provided at the time of the registration of the respective asset with the central processing computer 11. At step 1104, the user or individual can also access any information regarding the respective asset which might be stored at and/or available at or from any of the herein-described digital assets/records storage computer(s) 60, any governmental entity computer(s) 70, any financial institution computer(s) 80, and/or any official information source computer(s) 90. In this regard, at step 1104, the user or individual can obtain as much available information as needed or desired regarding the respective asset.

At step 1104, the user or individual can also send messages with requests for information to the owner of the respective asset, with such messages being transmitted in or as an email message, in or as a text message, or in or as a chat message in a chat room which can be created and/or hosted by the central processing computer 11 and which can be dedicated to hosting communications between the user or individual and the owner of the respective asset. At step 1104, the user or individual can also initiate a video conference call, or an audio call, with the owner of the respective asset, with such video conference call, or audio call, taking place with and using the user communication device 20 used by the user or individual and a counterparty communication device 30 used by the owner of the respective asset. At and during step 1104, the user or individual can seek to obtain information regarding the state or condition of the respective asset and confirm any representation(s) and/or warranty or warranties which are being made by the owner and/or which are sought to be provided to the user or individual. In a preferred embodiment, assurances and/or representations and/or warranties regarding the respective asset, and/or any further assurances, representations, and/or warranties, can also be obtained from the owner of the respective asset and can be recorded and stored by and/or in the central processing computer 11.

In a preferred, the central processing computer 11, at step 1104, can create and store a transaction matter record for the respective asset and can record and store, in the transaction matter record, and in the database 11H, any and/or all messages transmitted between the user or individual and the owner of the respective asset as well as any and/or all video conference call(s) and/or audio call(s) which transpired between the user or individual and the owner of the respective asset. In this regard, the apparatus 100 can record and store any and/or all communications, including any questions and answers regarding the respective asset, which occurred or transpired between the user or individual and the owner of the respective asset, and/or any information regarding a representation(s) made with regards to the respective asset. Any assurances and/or representations and/or warranties regarding the respective asset, which were obtained from the owner of the respective asset, can be recorded and stored by and/or in the central processing computer 11.

At step 1104, the user or individual can also transmit or submit a price offer to purchase the respective asset which can be conditioned on or subject to specified or dictated contingencies as well as being conditioned on a subsequent written agreement being signed by both parties. At step 1104, the owner of the respective asset can indicate that the price offered is accepted, is rejected, or the owner can transmit a counteroffer. At step 1104, the parties can negotiate until a deal is reached or until negotiations are broken off. If an offer is accepted for the respective asset, so that parties can work towards entering into contractual negotiations and working towards closing on a transaction involving the respective asset, the user or individual, or the owner, can so notate the same, and the parties can thereafter engage in the process of entering into a contract for the sale of the respective asset and close on the same.

At step 1104, the central processing computer 11 can store information regarding any and/or all communications, including information regarding any and/or all offers, rejections, or counteroffers, made by the parties and/or whether or not the parties have agreed on price and are entering into contractual negotiations, in the transaction matter record, and in the database 11H, for the respective asset. At step 1104, the transaction matter record and/or any information regarding the respective asset, and/or any communications relating thereto, can be stored in the database 11H of the central processing computer 11, and the transaction matter record and/or any information regarding the respective asset, and/or any communications relating thereto, and/or any information regarding the same, or related to the same, and/or any information or any link to information regarding or related to the same, can be stored in the distributed ledger/Blockchain technology system 12, so as to secure information regarding the transaction. In this regard, in a preferred embodiment, at step 1104, any information regarding any transaction involving the respective asset can be stored in or at a centralized location, in the database 11H of the central processing computer 11, and in the distributed ledger/Blockchain technology system 12, so as to secure the information regarding the same and any transaction(s) involving the same. Thereafter, the operation of the apparatus 100 will cease at step 1105.

In the above-described manner, the apparatus 100 of the present invention provides for an improved technical solution in systems and practices involving and/or relating to the offering of real estate assets and/or real property assets for sale which provides for enhanced information transparency and which allows prospective buyers or purchasers to have direct access to sellers of real estate assets and/or real property assets so that information can be obtained and price offers can be conveyed directly and without delay.

In another preferred embodiment, the apparatus 100 and methods of the embodiment, of FIG. 11 can be utilized in a same, a similar, and/or an analogous, manner in order to rent, lease, or purchase an option to purchase, rent, or lease, any real estate asset and/or real property asset. In another preferred embodiment, the real estate asset and/or real property asset, or an option to purchase the same, or any specified rental or rental period of or for the same, or any specified lease or lease period of or for the same, or any option for the same, can also be represented by a non-fungible token (NFT).

In another preferred embodiment, the apparatus 100 and methods of the embodiments of FIG. 11 can also be utilized in a same, a similar, and/or an analogous, manner in order sell non-fungible tokens (NFTs) for any real estate asset(s) and/or real property asset(s), and/or any rental(s), lease(s), or option(s), relating thereto.

In a preferred embodiment, it is envisioned that the owner or other authorized individual can list or register a high value asset(s), a unique asset(s), a digital art asset(s), and/or a digital memorabilia asset(s), and/or any non-fungible token(s) of or for the same, and/or any non-fungible token(s) associated with and/or related to the same, and/or any non-fungible token(s) (also herein referred to as “asset” or “assets”), by providing a name or identifying information for the same, a description of the same, a price for the same, a history of or for the same or a history of a transaction(s) involving the same, historical information regarding the same, information regarding the creation or inception of the same, a picture(s), photograph(s), video recording(s), video presentation(s), commercial(s), infomercial(s), a certificate of title of or for the same, a certificate of authenticity of or for the same, and/or any other information regarding the same, contact information for the owner or authorized individual, or a broker, agent, attorney, or representative, of the owner or authorized individual, such as, not limited to, name, address, telephone number, cellular telephone number, email address, text number, and/or video conferencing information, and/or any scheduling and/or availability information for scheduling a call or video conference call with the owner or authorized individual or with his, her, or its, broker, agent, attorney, or representative.

In a preferred embodiment, the owner or other authorized individual can also provide information regarding, and/or links to information regarding, any digital assets/records storage computer(s) 60, any governmental entity computer(s) 70, any financial institution computer(s) 80, and/or any official information source computer(s) 90, which may contain and/or store any information related to or regarding the asset being listed or registered which might be of interest to, or which might be needed by, any prospective buyer, purchaser, or user of the apparatus 100.

In a preferred embodiment, once the respective asset or assets, has/have been listed or registered with the central processing computer 11, such will be available for sale, for transfer, for leasing, for renting, for licensing, or for selling an option thereto or therefor or for optioning in any way, with the exchange or clearinghouse provided by the apparatus 100 of the present invention.

In another preferred embodiment, the apparatus 100 and methods of the present invention can be utilized in the sale of any high value asset(s), unique asset(s), digital art asset(s), and/or digital memorabilia asset(s), and/or any non-fungible token(s) of or for the same, or any assets relating thereto for derived therefrom. In another preferred embodiment, the apparatus 100 and methods of the present invention can also be utilized in the sale, rental, leasing, or licensing, or optioning, of any high value asset(s), unique asset(s), digital art asset(s), and/or digital memorabilia asset(s), and/or any non-fungible token(s) of or for the same, and/or any non-fungible token (NFT) of, corresponding to, or relating to, the same.

In a preferred embodiment, a prospective purchaser, renter, lessee, licenses, or optionee (defined herein a person who purchases or acquires an option), can utilize the apparatus 100 of the present invention in order to search for and to locate an asset that he or she is interested in purchasing, renting, leasing, licensing, or optioning. In a preferred embodiment, a prospective purchaser, renter, lessee, licensee, or optionee, can utilize the apparatus 100 of the present invention in order to search for and to locate a non-fungible token of, for, or representing, the high value asset(s), unique asset(s), digital art asset(s), and/or digital memorabilia asset(s), that he or she is interested in purchasing, renting, leasing, licensing, or optioning. The prospective purchaser, renter, lessee, licensee, or optionee, can identify or locate, via searching available listings, one or more high value asset(s), unique asset(s), digital art asset(s), and/or digital memorabilia asset(s), and obtain any information regarding any one or more of the same from any digital assets/records storage computer(s) 60, any governmental entity computer(s) 70, any financial institution computer(s) 80, and/or any official information source computer(s) 90, which may contain and/or store any information related to or regarding the same, and, if interested, can communicate an offer directly to an owner of an asset in which the prospective purchaser, renter, lessee, licensee, or optionee, is interested. Thereafter, a record regarding any transaction involving or relating to the asset can be stored in both the database 11H of the central processing computer 11 and in the distributed ledger/Blockchain technology system 12 of the central processing computer and distributed ledger and Blockchain technology system 10.

In this regard, any information regarding any transaction involving the high value asset(s), unique asset(s), digital art asset(s), and/or digital memorabilia asset(s), can be stored in or at a centralized location, in the database 11H of the central processing computer 11, and in the distributed ledger/Blockchain technology system 12, so as to secure information regarding the same and any transaction(s) involving the same.

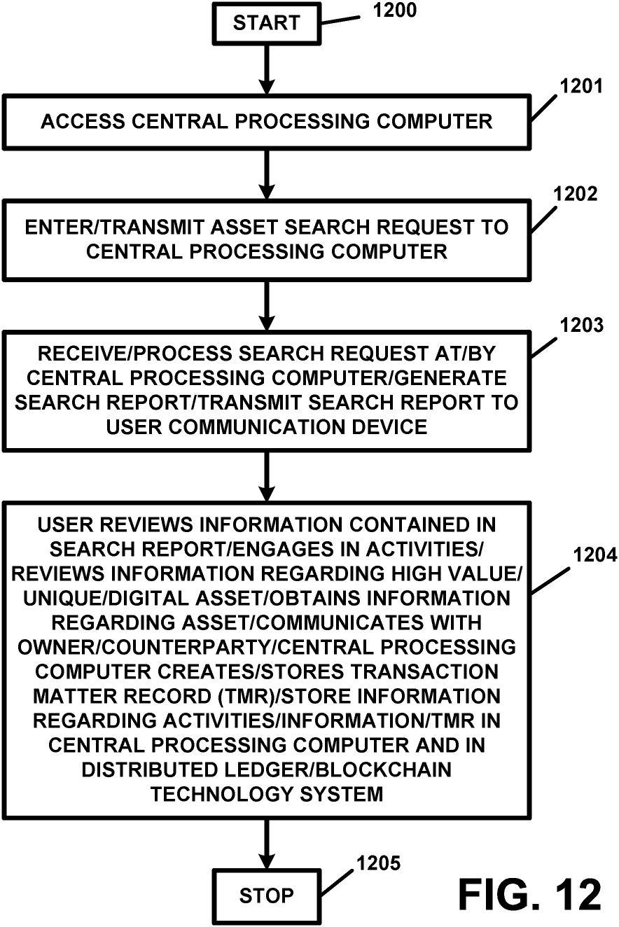

FIG. 12 illustrates another preferred embodiment method of utilizing the apparatus 100 of the present invention, in flow diagram form. For illustrative purposes, the embodiment of FIG. 12 will be described in connection with a user or individual seeking to purchase a high value asset. It should be noted, however, that the embodiment of FIG. 12 can also be utilized in connection with the purchase of any unique asset(s), any digital art asset(s), and/or any digital memorabilia asset(s). It should also be noted that the embodiment of FIG. 12 can also be utilized in a same, a similar, and/or an analogous, manner in connection with a, renting, leasing, licensing, or optioning, of any high value asset(s), any unique asset(s), any digital art asset(s), and/or any digital memorabilia asset(s).

With reference to FIG. 12, the operation of the apparatus 100 commences at step 1200. At step 1201, the user or individual can utilize his or her user communication device 20 in order to access the central processing computer 11. At step 1202, the user can enter, into the user communication device 20, a search request containing search information regarding a high value asset in which he or she is interested. In a preferred embodiment, the search request or search information can include any information or criteria used by a prospective purchaser to locate or to identify any such high value asset. At step 1202, the user communication device 20 will transmit the search request containing the search information to the central processing computer 11.

At step 1203, the central processing computer 11 will receive and process the search request and search information contained therein and will generate a search report containing information regarding and/or identifying one or more high value assets which meet any parameters of or contained in, or which are responsive to, the search request and/or any search information contained therein. At step 1203, the central processing computer 11 will transmit the search report to the user communication device 20. At step 1203, the user communication device 20 will receive the search report.

At step 1204, the user or individual can review the information contained in the search report. At step 1204, the user or individual can, for any high value asset (the “respective asset”) contained in or identified in the search report, access any information provided in the listing of the respective asset or access any information provided at the time of the registration of the respective asset with the central processing computer 11. At step 1204, the user or individual can also access any information regarding the respective asset which might be stored at and/or available at or from any of the herein-described digital assets/records storage computer(s) 60, any governmental entity computer(s) 70, any financial institution computer(s) 80, and/or any official information source computer(s) 90. At step 1204, the user can obtain a copy of a certificate of title to or for the respective asset and/or a certificate of authenticity of or for the respective asset. In this regard, at step 1204, the user or individual can obtain as much available information as needed or desired regarding the respective asset.

At step 1204, the user or individual can also send messages with requests for information to the owner of the respective asset, with such messages being transmitted in or as an email message, in or as a text message, or in or as a chat message in a chat room which can be created and/or hosted by the central processing computer 11 and which can be dedicated to hosting communications between the user or individual and the owner of the respective asset. At step 1204, the user or individual can also initiate a video conference call, or an audio call, with the owner of the respective asset, with such video conference call, or audio call, taking place with and using the user communication device 20 used by the user or individual and a counterparty communication device 30 used by the owner of the respective asset. In a preferred embodiment, the user or individual can, at and during step 1204, seek any confirmations regarding the authenticity or genuineness of the respective asset, and/or seek to confirm that any and/or all information in any certificate of title and/or any certificate of authenticity for the respective asset is true and correct. In a preferred embodiment, further assurances and/or representations and/or warranties regarding the respective asset can also be obtained from the owner of the respective asset and recorded and can be stored by and/or in the central processing computer 11.

In a preferred, the central processing computer 11, at step 1204, can create and store a transaction matter record for the respective asset and can record and store, in the transaction matter record, and in the database 11H, any and/or all messages transmitted between the user or individual and the owner of the respective asset as well as any and/or all video conference call(s) and/or audio call(s) which transpired between the user or individual and the owner of the respective asset. In this regard, the apparatus 100 can record and store any and/or all communications, including any questions and answers regarding the respective asset, which occurred or transpired between the user or individual and the owner of the respective asset, and/or any information regarding a representation(s) made with regards to the respective asset

At step 1204, the user or individual can also transmit or submit a price offer to purchase the respective asset which can be conditioned on or subject to specified or dictated contingencies as well as being conditioned on a subsequent written agreement being signed by both parties. At step 1204, the owner of the respective asset can indicate that the price offered is accepted, is rejected, or the owner can transmit a counteroffer. At step 1204, the parties can negotiate until a deal is reached or until negotiations are broken off. If an offer is accepted for the respective asset, so that parties can work towards entering into contractual negotiations and working towards closing on a transaction involving the respective asset, the user or individual, or the owner, can so notate the same, and the parties can thereafter engage in the process of entering into a contract for the sale of the respective asset and close on the same.

At step 1204, the central processing computer 11 can store information regarding any and/or all communications, including information regarding any and/or all offers, rejections, or counteroffers, made by the parties and/or whether or not the parties have agreed on price and are entering into contractual negotiations, in the transaction matter record, and in the database 11H, for the respective asset. At step 1204, the transaction matter record and/or any information regarding the respective asset, and/or any communications relating thereto, can be stored in the database 11H of the central processing computer 11, and the transaction matter record and/or any information regarding the respective asset, and/or any communications relating thereto, and/or any information regarding the same, or related to the same, and/or any information or any link to information regarding or related to the same, can be stored in the distributed ledger/Blockchain technology system 12, so as to secure information regarding the transaction. In this regard, in a preferred embodiment, at step 1204, any information regarding any transaction involving the respective asset can be stored in or at a centralized location, in the database 11H of the central processing computer 11, and in the distributed ledger/Blockchain technology system 12, so as to secure the information regarding the same and any transaction(s) involving the same. Thereafter, the operation of the apparatus 100 will cease at step 1205.

In another preferred embodiment, the apparatus 100 of FIG. 12 can be utilized in a same, a similar, and/or an analogous, manner in connection with the sale of any high value asset(s), any unique asset(s), any digital art asset(s), and/or any digital memorabilia asset(s), and/or any non-fungible token(s) of or for the same, or any assets relating thereto for derived therefrom. In another preferred embodiment, the apparatus 100 of FIG. 12 can be utilized in a same, a similar, and/or an analogous, manner, in connection with the rental, leasing, or licensing, or optioning, of any high value asset(s), unique asset(s), digital art asset(s), and/or digital memorabilia asset(s), and/or any non-fungible token(s) of or for the same, and/or any non-fungible token (NFT) of, corresponding to, or relating to, the same.

In the above-described manner, the apparatus 100 of FIG. 12 provides for an improved technical solution in systems and practices involving and/or relating to the offering of high value asset(s), unique asset(s), digital art asset(s), and/or digital memorabilia asset(s), and/or any non-fungible token(s) of or for the same, or any assets relating thereto for derived therefrom. Further, the apparatus 100 of FIG. 12 provides for enhanced information transparency and allows prospective buyers or purchasers to have direct access to sellers of high value asset(s), unique asset(s), digital art asset(s), and/or digital memorabilia asset(s), and/or any non-fungible token(s) of or for the same, or any assets relating thereto for derived therefrom, so that information can be obtained and price offers can be conveyed directly and without delay.

In another preferred embodiment, the apparatus 100 and methods of the embodiment, of FIG. 12 can also be utilized in a same, a similar, and/or an analogous, manner in order to rent, lease, license, or option, or purchase an option for any high value asset(s), unique asset(s), digital art asset(s), and/or digital memorabilia asset(s), and/or any non-fungible token(s) of or for the same.

In another preferred embodiment, the high value asset(s), unique asset(s), digital art asset(s), and/or digital memorabilia asset(s), or an option to purchase the same, or any specified rental or rental period of or for the same, or any specified lease or lease period of or for the same, or any specified license for the same, or any option for the same, can also be represented by a non-fungible token (NFT).

In another preferred embodiment, the apparatus 100 and methods of the embodiments of FIG. 12 can also be utilized in a same, a similar, and/or an analogous, manner in order sell non-fungible tokens (NFTs) for any high value asset(s), unique asset(s), digital art asset(s), and/or digital memorabilia asset(s), and/or any rental, lease, license, or option, relating thereto.

In another preferred embodiment, the apparatus 100 and methods of the present invention can be utilized in the sale or licensing of intellectual property assets which be, and which can include, but which is not limited to, any types or kinds of patents, trademarks, trade secrets, copyrights, franchises, franchise rights, media rights, publicity rights, and/or any ownership interest(s) thereto or therein, any partial ownership interest(s) thereto or therein, and/or any licenses, exclusive licenses, non-exclusive licenses, defined field of use licenses, exclusive defined field of use licenses, non-exclusive defined field of use license, to or for the same, and/or any options to purchase any of the same, and/or any options to purchase any of the herein-described patents, trademarks, trade secrets, copyrights, franchises, franchise rights, media rights, publicity rights, any licenses for the same, and/or any ownership interest(s) thereto or therein, or any partial ownership interest(s) thereto or therein, and/or any non-fungible token(s) of or for the same, or any assets relating thereto for derived therefrom (hereinafter referred to as an “intellectual property asset” or as “intellectual property assets”).

In a preferred embodiment, a prospective purchaser, licensee, or optionee, can utilize the apparatus 100 of the present invention in order to search for and to locate an asset he or she is interested in purchasing, licensing, or optioning. In a preferred embodiment, a prospective purchaser, licensee, or optionee, can also utilize the apparatus 100 of the present invention in order to search for and to locate a non-fungible token of, for, or representing, the asset that he or she is interested in purchasing, licensing, or optioning. The prospective purchaser, licensee, or optionee, can identify or locate, via searching available listings, one or more intellectual property assets, and obtain any information regarding any one or more of the same from any digital assets/records storage computer(s) 60, any governmental entity computer(s) 70, any financial institution computer(s) 80, and/or any official information source computer(s) 90, which may contain and/or store any information related to or regarding the same, and, if interested, can communicate an offer directly to an owner of an intellectual property asset in which the prospective purchaser, licensee, or optionee, is interested. Thereafter, a record regarding any transaction involving or relating to the intellectual property asset can be stored in both the database 11H of the central processing computer 11 and in the distributed ledger/Blockchain technology system 12 of the central processing computer and distributed ledger and Blockchain technology system 10.

In this regard, any information regarding any transaction involving the intellectual property asset can be stored in or at a centralized location, in the database 11H of the central processing computer 11, and in the distributed ledger/Blockchain technology system 12, so as to secure information regarding the same and any transaction(s) involving the same.

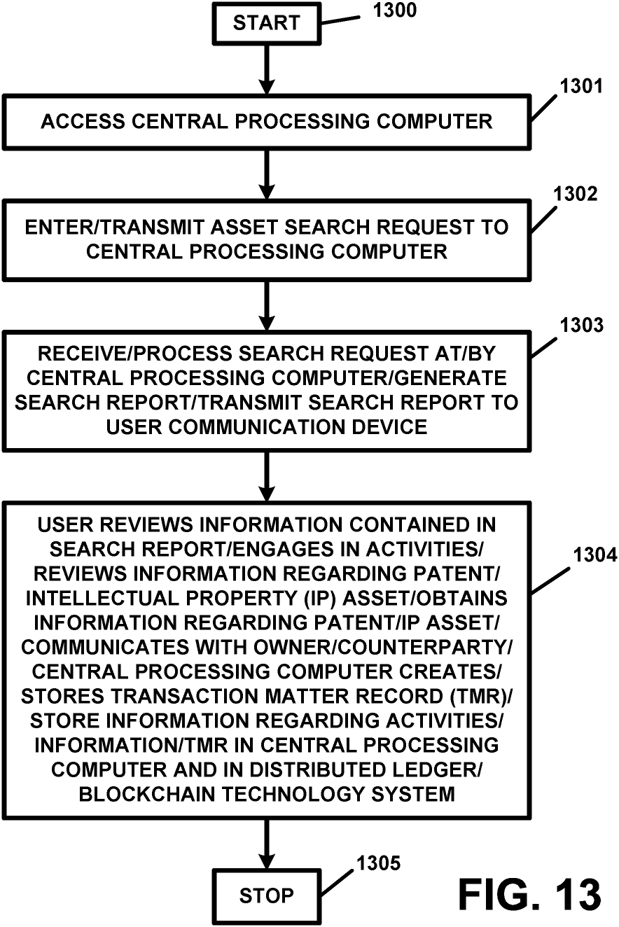

FIG. 13 illustrates another preferred embodiment method of utilizing the apparatus 100 of the present invention, in flow diagram form. For illustrative purposes, the embodiment of FIG. 13 will be described in connection with a user or individual seeking to purchase a patent asset. It should be noted, however, that the embodiment of FIG. 12 can also be utilized in connection with the purchase of any of the herein-described intellectual property assets and/or any non-fungible tokens (NFTs) of or associated therewith. It should also be noted that the embodiment of FIG. 13 can also be utilized in a same, a similar, and/or an analogous, manner in connection with a licensing, or optioning, of any of the intellectual property assets and/or any non-fungible tokens (NFTs) of or associated therewith.

With reference to FIG. 13, the operation of the apparatus 100 commences at step 1300. At step 1301, the user or individual can utilize his or her user communication device 20 in order to access the central processing computer 11. At step 1302, the user can enter, into the user communication device 20, a search request containing search information regarding a patent asset or patent assets in which he or she is interested. In a preferred embodiment, the search request or search information can include any information or criteria used by a prospective purchaser to locate or to identify any such patent asset. At step 1302, the user communication device 20 will transmit the search request containing the search information to the central processing computer 11.

At step 1303, the central processing computer 11 will receive and process the search request and search information contained therein and will generate a search report containing information regarding and/or identifying one or more patent assets which meet any parameters of or contained in, or which are responsive to, the search request and/or any search information contained therein. At step 1303, the central processing computer 11 will transmit the search report to the user communication device 20. At step 1303, the user communication device 20 will receive the search report.

At step 1304, the user or individual can review the information contained in the search report. At step 1304, the user or individual can, for any patent asset (the “respective patent asset”) contained in or identified in the search report, access any information provided in the listing of the respective patent asset or access any information provided at the time of the registration of the respective patent asset with the central processing computer 11. At step 1304, the user or individual can also access any information regarding the respective patent asset which might be stored at and/or available at or from any of the herein-described digital assets/records storage computer(s) 60, any governmental entity computer(s) 70, any financial institution computer(s) 80, and/or any official information source computer(s) 90. At step 1304, the user can obtain a copy of a certificate of title to or for the respective patent asset and/or a certificate of authenticity of or for the respective patent asset. In this regard, at step 1304, the user or individual can obtain as much available information as needed or desired regarding the respective patent asset.

At step 1304, the user or individual can also send messages with requests for information to the owner of the respective patent asset, with such messages being transmitted in or as an email message, in or as a text message, or in or as a chat message in a chat room which can be created and/or hosted by the central processing computer 11 and which can be dedicated to hosting communications between the user or individual and the owner of the respective patent asset. At step 1304, the user or individual can also initiate a video conference call, or an audio call, with the owner of the respective patent asset, with such video conference call, or audio call, taking place with and using the user communication device 20 used by the user or individual and a counterparty communication device 30 used by the owner of the respective patent asset. In a preferred embodiment, the user or individual can, at and during step 1304, seek any confirmations regarding the authenticity or genuineness of the respective asset, and/or seek to confirm that any and/or all information in any certificate of title and/or any certificate of authenticity for the respective patent asset is true and correct. In a preferred embodiment, further assurances and/or representations and/or warranties regarding the respective patent asset can also be obtained from the owner of the respective patent asset and can be recorded and stored by and/or in the central processing computer 11.

In a preferred, the central processing computer 11, at step 1304, can create and store a transaction matter record for the respective patent asset and can record and store, in the transaction matter record, and in the database 11H, any and/or all messages transmitted between the user or individual and the owner of the respective patent asset as well as any and/or all video conference call(s) and/or audio call(s) which transpired between the user or individual and the owner of the respective patent asset. In this regard, the apparatus 100 can record and store any and/or all communications, including any questions and answers regarding the respective patent asset, which occurred or transpired between the user or individual and the owner of the respective patent asset, and/or any information regarding a representation(s) made with regards to the respective patent asset

At step 1304, the user or individual can also transmit or submit a price offer to purchase the respective patent asset which can be conditioned on or subject to specified or dictated contingencies as well as being conditioned on a subsequent written agreement being signed by both parties. At step 1304, the owner of the respective patent asset can indicate that the price offered is accepted, is rejected, or the owner can transmit a counteroffer. At step 1304, the parties can negotiate until a deal is reached or until negotiations are broken off. If an offer is accepted for the respective patent asset, so that parties can work towards entering into contractual negotiations and working towards closing on a transaction involving the respective patent asset, the user or individual, or the owner, can so notate the same, and the parties can thereafter engage in the process of entering into a contract for the sale of the respective patent asset and close on the same.

At step 1304, the central processing computer 11 can store information regarding any and/or all communications, including information regarding any and/or all offers, rejections, or counteroffers, made by the parties and/or whether or not the parties have agreed on price and are entering into contractual negotiations, in the transaction matter record, and in the database 11H, for the respective patent asset. At step 1304, the transaction matter record and/or any information regarding the respective patent asset, and/or any communications relating thereto, can be stored in the database 11H of the central processing computer 11, and the transaction matter record and/or any information regarding the respective patent asset, and/or any communications relating thereto, and/or any information regarding the same, or related to the same, and/or any information or any link to information regarding or related to the same, can be stored in the distributed ledger/Blockchain technology system 12, so as to secure information regarding the transaction. In this regard, in a preferred embodiment, at step 1304, any information regarding any transaction involving the respective patent asset can be stored in or at a centralized location, in the database 11H of the central processing computer 11, and in the distributed ledger/Blockchain technology system 12, so as to secure the information regarding the same and any transaction(s) involving the same. Thereafter, the operation of the apparatus 100 will cease at step 1305.

Although described in connection with the sale of a patent asset, the embodiment of the apparatus 100 of FIG. 13 can be utilized in a same, a similar, and/or an analogous, manner in connection with the sale of any types or kinds of patents, trademarks, trade secrets, copyrights, franchises, franchise rights, media rights, publicity rights, and/or any ownership interest(s) thereto or therein, any partial ownership interest(s) thereto or therein, and/or any licenses, exclusive licenses, non-exclusive licenses, defined field of use licenses, exclusive defined field of use licenses, non-exclusive defined field of use license, to or for the same, and/or any options to purchase any of the same, and/or any options to purchase any of the herein-described patents, trademarks, trade secrets, copyrights, franchises, franchise rights, media rights, publicity rights, any licenses for the same, and/or any ownership interest(s) thereto or therein, or any partial ownership interest(s) thereto or therein, and/or any non-fungible token(s) of or for the same.

In this regard, the apparatus 100 of FIG. 13 can be utilized in a same, a similar, and/or an analogous, manner in connection with the sale of any intellectual property asset or intellectual property assets, and/or any non-fungible token(s) of or for the same, or any assets relating thereto for derived therefrom.

In the above-described manner, the apparatus 100 of FIG. 13 provides for an improved technical solution in systems and practices involving and/or relating to the offering of intellectual property assets and/or any non-fungible token(s) of or for the same, or any assets relating thereto for derived therefrom.

Further, the apparatus 100 of FIG. 13 provides for enhanced information transparency and allows prospective buyers or purchasers to have direct access to sellers of intellectual property assets and/or any non-fungible token(s) of or for the same, or any assets relating thereto for derived therefrom, so that information can be obtained and price offers can be conveyed directly and without delay.

In another preferred embodiment, the apparatus 100 and methods of the embodiment, of FIG. 13 can also be utilized in a same, a similar, and/or an analogous, manner in order to license, option, or purchase an option for any intellectual property assets and/or any non-fungible token(s) of or for the same. In another preferred embodiment, the intellectual property asset(s), or an option to purchase or to lease the same, can also be represented by a non-fungible token (NFT). In another preferred embodiment, the apparatus 100 and methods of the embodiments of FIG. 13 can also be utilized in a same, a similar, and/or an analogous, manner in order sell non-fungible tokens (NFTs) for any intellectual property asset(s), and/or any license, or option, relating thereto.

In another preferred embodiment, the apparatus 100 and methods of the present invention can be utilized in the sale of any non-fungible token (NFT). In a preferred embodiment, a non-fungible token (NFT) can be used to represent any of the real estate assets, high value assets, unique assets, intellectual property assets, digital art and/or digital memorabilia assets, and/or non-fungible tokens, and/or services, described herein, and/or a non-fungible token (NFT) can be used to represent any other asset, item, entity, or service. In another preferred embodiment, the apparatus 100 and methods of the present invention can also be utilized in the sale, rental, leasing, or licensing, or optioning, of any non-fungible token (NFT).

In a preferred embodiment, a prospective purchaser, renter, lessee, licenses, or optionee, can utilize the apparatus 100 of the present invention in order to search for and to locate a non-fungible token (NFT) asset that he or she is interested in purchasing, renting, leasing, licensing, or optioning. The prospective purchaser, renter, lessee, licensee, or optionee, can identify or locate, via searching available listings, one or more non-fungible token (NFT) assets and obtain any information regarding any one or more of the same from any digital assets/records storage computer(s) 60, any governmental entity computer(s) 70, any financial institution computer(s) 80, and/or any official information source computer(s) 90, which may contain and/or store any information related to or regarding the same, and, if interested, can communicate an offer directly to an owner of a non-fungible token (NFT) asset in which the prospective purchaser, renter, lessee, licensee, or optionee, is interested. Thereafter, a record regarding any transaction involving or relating to the non-fungible token (NFT) asset can be stored in both the database 11H of the central processing computer 11 and in the distributed ledger/Blockchain technology system 12 of the central processing computer and distributed ledger and Blockchain technology system 10.

In this regard, any information regarding any transaction involving the non-fungible token (NFT) asset can be stored in or at a centralized location, in the database 11H of the central processing computer 11, and in the distributed ledger/Blockchain technology system 12, so as to secure information regarding the same and any transaction(s) involving the same.

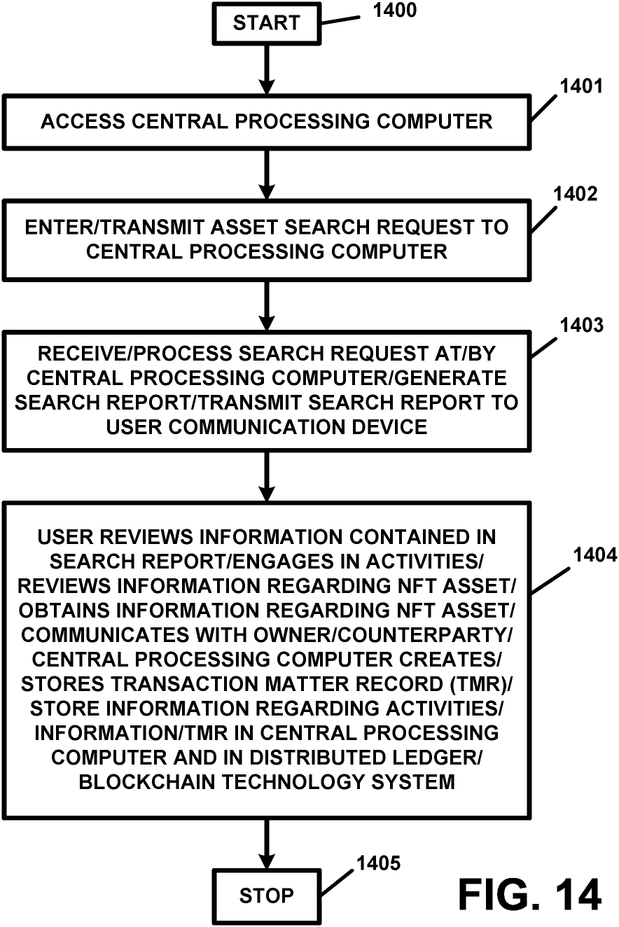

FIG. 14 illustrates another preferred embodiment method of utilizing the apparatus 100 of the present invention, in flow diagram form. The embodiment of FIG. 14 will be described in connection with a user or individual seeking to purchase a non-fungible token (NFT) or a non-fungible (NFT) token asset which can represent any asset. It should also be noted that the embodiment of FIG. 14 can also be utilized in a same, a similar, and/or an analogous, manner in connection with a, renting, leasing, licensing, or optioning, of any non-fungible token (NFT) or any non-fungible (NFT) token asset.

With reference to FIG. 14, the operation of the apparatus 100 commences at step 1400. At step 1401, the user or individual can utilize his or her user communication device 20 in order to access the central processing computer 11. At step 1402, the user can enter, into the user communication device 20, a search request containing search information regarding a non-fungible token (NFT) or a non-fungible (NFT) token asset in which he or she is interested. In a preferred embodiment, the search request or search information can include any information or criteria used by a prospective purchaser to locate or to identify any such non-fungible token (NFT) or a non-fungible (NFT) token asset. At step 1402, the user communication device 20 will transmit the search request containing the search information to the central processing computer 11.

At step 1403, the central processing computer 11 will receive and process the search request and search information contained therein and will generate a search report containing information regarding and/or identifying one or more non-fungible tokens (NFTs) or non-fungible (NFT) token assets which meet any parameters of or contained in, or which are in response to, the search request and/or any search information contained therein. At step 1403, the central processing computer 11 will transmit the search report to the user communication device 20. At step 1403, the user communication device 20 will receive the search report.

At step 1404, the user or individual can review the information contained in the search report. At step 1404, the user or individual can, for any non-fungible token (NFT) or a non-fungible (NFT) token asset (hereinafter “NFT asset”) contained in or identified in the search report, access any information provided in the listing of the respective NFT asset or access any information provided at the time of the registration of the respective NFT asset with the central processing computer 11. At step 1404, the user or individual can also access any information regarding the respective NFT asset which might be stored at and/or available at or from any of the herein-described digital assets/records storage computer(s) 60, any governmental entity computer(s) 70, any financial institution computer(s) 80, and/or any official information source computer(s) 90. At step 1404, the user can obtain a copy of a certificate of title to or for the respective NFT asset and/or a certificate of authenticity of or for the respective NFT asset. In this regard, at step 1404, the user or individual can obtain as much available information as needed or desired regarding the respective NFT asset.

At step 1404, the user or individual can also send messages with requests for information to the owner of the respective NFT asset, with such messages being transmitted in or as an email message, in or as a text message, or in or as a chat message in a chat room which can be created and/or hosted by the central processing computer 11 and which can be dedicated to hosting communications between the user or individual and the owner of the respective NFT asset. At step 1404, the user or individual can also initiate a video conference call, or an audio call, with the owner of the respective NFT asset, with such video conference call, or audio call, taking place with and using the user communication device 20 used by the user or individual and a counterparty communication device 30 used by the owner of the respective NFT asset. In a preferred embodiment, the user or individual can, at and during step 1404, seek any confirmations regarding the authenticity or genuineness of the respective NFT asset, and/or seek to confirm that any and/or all information in any certificate of title and/or any certificate of authenticity for the respective NFT asset is true and correct. In a preferred embodiment, further assurances and/or representations and/or warranties regarding the respective asset can also be obtained from the owner of the respective asset and can be recorded and stored by and/or in the central processing computer 11.

In a preferred, the central processing computer 11, at step 1404, can create and store a transaction matter record for the respective NFT asset and can record and store, in the transaction matter record, and in the database 11H, any and/or all messages transmitted between the user or individual and the owner of the respective NFT asset as well as any and/or all video conference call(s) and/or audio call(s) which transpired between the user or individual and the owner of the respective NFT asset. In this regard, the apparatus 100 can record and store any and/or all communications, including any questions and answers regarding the respective NFT asset, which occurred or transpired between the user or individual and the owner of the respective NFT asset, and/or any information regarding a representation(s) made with regards to the respective NFT asset

At step 1404, the user or individual can also transmit or submit a price offer to purchase the respective NFT asset which can be conditioned on or subject to specified or dictated contingencies as well as being conditioned on a subsequent written agreement being signed by both parties. At step 1404, the owner of the respective NFT asset can indicate that the price offered is accepted, is rejected, or the owner can transmit a counteroffer. At step 1404, the parties can negotiate until a deal is reached or until negotiations are broken off. If an offer is accepted for the respective NFT asset, so that parties can work towards entering into contractual negotiations and working towards closing on a transaction involving the respective NFT asset, the user or individual, or the owner, can so notate the same, and the parties can thereafter engage in the process of entering into a contract for the sale of the respective NFT asset and close on the same.

At step 1404, the central processing computer 11 can store information regarding any and/or all communications, including information regarding any and/or all offers, rejections, or counteroffers, made by the parties and/or whether or not the parties have agreed on price and are entering into contractual negotiations, in the transaction matter record, and in the database 11H, for the respective NFT asset. At step 1404, the transaction matter record and/or any information regarding the respective NFT asset, and/or any communications relating thereto, can be stored in the database 11H of the central processing computer 11, and the transaction matter record and/or any information regarding the respective NFT asset, and/or any communications relating thereto, and/or any information regarding the same, or related to the same, and/or any information or any link to information regarding or related to the same, can be stored in the distributed ledger/Blockchain technology system 12, so as to secure information regarding the transaction. Thereafter, the operation of the apparatus 100 will cease at step 1405.

Although the apparatus 100 of the embodiment of FIG. 14 is described as being used to sell a non-fungible token (NFT) or any non-fungible token (NFT) asset, the apparatus 100 of the embodiment of FIG. 14 can also be utilized, in a same, a similar, and/or an analogous, manner in order to license or to option any non-fungible token (NFT) or any non-fungible token (NFT) asset.

As described herein, the apparatus 100 and methods of the present invention provides for a number of technological solutions and for a number of improvements to existing technologies and solves numerous problems associated with, and experienced by individuals in, conducting transactions and/or commerce involving or relating to real estate assets, real property assets, high value assets, unique assets, intellectual property assets, digital art and/or digital memorabilia assets, and/or non-fungible tokens, and/or services.

As described herein, the apparatus 100 and methods of the present invention provides for a number of technological solutions and for a number of improvements to existing technologies utilized in transactions and commerce involving or relating to real estate assets, real property assets, high value assets, unique assets, intellectual property assets, digital art and/or digital memorabilia assets, and/or non-fungible tokens, and/or services, by providing an apparatus and methods for allowing users or individuals to communicate with, and to obtain information from, owners seeking to sell the same, as well as from public records, and to record information regarding the transaction or activity in both a centralized location, in the central processing computer 11 and/or in the database 11H of the same, and in a distributed ledger and blockchain technology system, in the distributed ledger/Blockchain technology system 12.

In the above-described manner, the apparatus 100 and methods of the present invention can record and store, in a distributed ledger and blockchain technology system, immutable records of information which can be utilized to protect purchasers of any of the herein-described real estate assets, real property assets, high value assets, unique assets, intellectual property assets, digital art and/or digital memorabilia assets, and/or non-fungible tokens, and/or services, and/or any other assets, from and/or against fraud and/or misrepresentation.

In the above-described manner, the apparatus 100 and methods of the present invention can also provide purchasers of any of the herein-described real estate assets, real property assets, high value assets, unique assets, intellectual property assets, digital art and/or digital memorabilia assets, and/or non-fungible tokens, and/or services, and/or any other assets, with recourse against individuals who or which perpetrate, or attempt to perpetrate, fraud by selling, or by attempting to sell, assets and/or services which are fraudulent, counterfeit, or non-existent, and/or which are not genuine or not authentic.

It is important to note, and it is to be understood, that the respective databases 11H, 20H, 30H, 40H, 50H, 60H, 70H, 80H, and/or 90H, can contain and/or include any data and/or information, reports, and/or messages, which are described herein, or otherwise, as being input into, received by, processed by, generated by, and/or transmitted from and/or to, each of the herein-described central procession computer(s) 11, user communication device(s) 20, counterparty communication device(s) 30, broker/agent communication device(s) 40, service provider communication device(s) 50, the digital assets/records storage computer(s) 60, the governmental entity computer(s) 70, the financial institution computer(s) 80, and/or the official information source computer(s) 90.

Any type of Blockchain technology can be utilized in connection with the present invention. For example, the present invention can utilize a distributed ledger(s) along with any Blockchain technology or technologies, Bitcoin Blockchain technology or technologies, Ethereum Blockchain technology or technologies, Bitcoin Cash Blockchain technology or technologies, Litecoin Blockchain technology or technologies, Privacy Coin Bitcoin technology or technologies, and/or any other suitable Blockchain technology or technologies, and/or Smart contracts and/or Smart contract technology or technologies and/or decentralized autonomous organizations (DAOs), decentralized autonomous organizations (DAOs) technology or technologies, and/or any combination of same.

The present invention can also be utilized with any suitable cryptocurrency, such as, but not limited to, Bitcoin, Bitcoin Cash, Ethereum, Ripple, Dash, Monero, Zcash, Digibyte, Litecoin, any privacy coins, any alt coins, and/or any other cryptocurrency and/or privacy coin cryptocurrency. In this regard, any of the embodiments described herein can be performed with or utilizing any currency or any cryptocurrency. Further, any of the accounts described herein, and any of the transactions on or which can involve any of the accounts described herein can also involve or utilize any currency or cryptocurrency.

Applicant incorporates by reference herein the subject matter and teachings of “Blockchain Technology Explained” by Alan T. Norman, “Blockchain” by Abraham K. White, “Blockchain - A Practical Guide To Developing Business, Law, And Technology Solutions” by Joseph J. Bambara and Paul R. Allen, and “Blockchain - Ultimate Guide To Understanding Blockchain, Bitcoin, Cryptocurrencies, Smart Contracts And The Future of Money” by Mark Gates, in their entirety, for all of their respective subject matter and teachings regarding distributed ledger technology and/or technologies, Blockchain technology and/or technologies, Bitcoin technology and/or technologies, Bitcoin Blockchain technology and/or technologies, Ethereum technology and/or technologies, Ethereum Blockchain technology and/or technologies, cryptocurrencies, cryptocurrency technology and/or technologies, and/or smart contract technology and/or technologies, and/or decentralized autonomous organizations (DAOs) technologies, and/or peer-to-peer technology and/or technologies, and/or any other technology or technologies related thereto or which can be utilized in conjunction distributed ledgers, Blockchain technologies, Smart contracts, decentralized autonomous organizations (DAOs), and/or cryptocurrencies.

In any and/or all of the embodiments described herein, the user or individual can, at any time, access the central processing computer 11, the distributed ledger/Blockchain technology system 12 of the central processing computer and distributed ledger and Blockchain technology system 10, and/or any of the herein-described digital assets/records storage computer(s) 60, any governmental entity computer(s) 70, any financial institution computer(s) 80, and/or any official information source computer(s) 90, and can request access to, and can be provided, via his or her user communication device 20, with and/or with access to, any information regarding any of the herein-described real estate assets, real property assets, high value assets, unique assets, intellectual property assets, digital art and/or digital memorabilia assets, and/or non-fungible tokens, and/or services, as well as any transaction matter record regarding the same, and/or any communications recorded therein.

In another preferred embodiment, the user or individual can access the central processing computer 11 and can obtain, and can be provided with, via his or her user communication device 20, any written transcript of or in a transaction matter record and/or a translation of any written transcript from one language to another. In another preferred embodiment, the user or individual can access the central processing computer 11 and can request, and can be provided with, a written transcript of any call or video conference call. In another preferred embodiment, any written transcript can also be digitally signed by any one who participated in the call or the videoconference call.

As described herein, the apparatus 100 and methods of the present invention provides for a number of technological solutions and for a number of improvements to existing technologies and solves numerous problems associated with, and experienced by individuals in, conducting transactions and/or commerce on-line and/or on and/or over the Internet and/or the World Wide Web involving or relating to transactions and/or commerce in or involving any of the herein-described real estate assets, real property assets, high value assets, unique assets, intellectual property assets, digital art and/or digital memorabilia assets, and/or non-fungible tokens, and/or services.

While the present invention has been described and illustrated in various preferred and alternate embodiments, such descriptions are merely illustrative of the present invention and are not to be construed to be limitations thereof. In this regard, the present invention encompasses all modifications, variations, and/or alternate, embodiments, with the scope of the present invention being limited only by the claims which follow.

What is claimed is:

1. An apparatus, comprising:
a central processing computer, wherein the central processing computer is specially programmed to provide, and provides, an exchange or a clearinghouse for a selling, renting, leasing, licensing, or optioning, one or more assets, wherein the central processing computer further comprises:
a processor;
a database, wherein the database stores information regarding the one or more assets; and
a transmitter, and
a distributed ledger and blockchain technology system,
wherein the central processing computer receives a search request transmitted from a user communication device, wherein the search request contains information regarding a search for an asset of the one or more assets, wherein the central processing computer processes information contained in the search request and generates a search report containing information regarding the asset, wherein the central processing computer transmits the search report to the user communication device, wherein the central processing computer processes information to allow a user or the user communication device to obtain information regarding the asset from an external computer, allows the user to communicate, via the user communication device, with a counterparty communication device of an owner of the asset or a counterparty via a chat room or via a video conference, and further wherein the central processing computer creates a transaction matter record for or associated with the asset, records activity in the chat room or records a video recording of the video conference, and further wherein the apparatus stores information regarding the asset, information regarding a communication between the user and the owner or counterparty, or information regarding the information recorded in the chat room or information regarding the video recording, in the database and in the distributed ledger and blockchain technology system.

2. The apparatus of claim 1, wherein the asset is a real estate asset or a real property asset.

3. The apparatus of claim 1, wherein the asset is a rental or a lease of a real estate asset or a real property asset.

4. The apparatus of claim 1, wherein the asset is a non-fungible token of or for the real estate asset.

5. The apparatus of claim 1, wherein the asset is a high value asset or a unique asset.

6. The apparatus of claim 1, wherein the asset is digital art.

7. The apparatus of claim 1, wherein the asset is digital memorabilia.

8. The apparatus of claim 1, wherein the asset is a non-fungible token.

9. The apparatus of claim 1, wherein the asset is an intellectual property asset.

10. The apparatus of claim 1, wherein the asset is a rental.

11. The apparatus of claim 1, wherein the asset is a lease.

12. The apparatus of claim 1, wherein the asset is an option.

13. The apparatus of claim 1, wherein the external computer is a digital assets record storage computer.

14. The apparatus of claim 1, wherein the external computer is a governmental entity computer.

15. The apparatus of claim 1, wherein the external computer is an official information source computer.

16. The apparatus of claim 1, wherein the external computer is a financial institution computer.

17. The apparatus of claim 1, wherein the information regarding the communication between the user and the owner or counterparty includes an offer price to purchase, to rent, to lease, or to license, the asset.

18. The apparatus of claim 1, wherein the information regarding the communication between the user and the owner or counterparty includes a warranty or a representation regarding the asset.

19. The apparatus of claim 9, wherein the intellectual property asset is a patent, a trademark, a copyright, or a trade secret.

20. The apparatus of claim 2, wherein the real estate asset or the real property asset is a residential home.
